(19) United States
(12) Patent Application Publication
(10) Pub. No.: US 2013/0185622 A1
(43) Pub. Date: Jul. 18, 2013

(54) METHODS AND SYSTEMS FOR HANDLING ANNOTATIONS AND USING CALCULATION OF ADDRESSES IN TREE-BASED STRUCTURES

(71) Applicant: SCRIBLE, INC., San Mateo, CA (US)

(72) Inventors: Tyler William Odean, San Francisco, CA (US); Andrew Joseph Delpha, Dallas, TX (US); Victor Manu Karkar, San Mateo, CA (US)

(73) Assignee: SCRIBLE, INC., San Mateo, CA (US)

(21) Appl. No.: 13/728,318

(22) Filed: Dec. 27, 2012

Related U.S. Application Data
(63) Continuation of application No. 12/484,556, filed on Jun. 15, 2009, now abandoned.
(60) Provisional application No. 61/061,398, filed on Jun. 13, 2008.
(60) Provisional application No. 61/061,301, filed on Jun. 13, 2008.

(51) Int. Cl. G06F 17/24

(52) U.S. Cl. CPC G06F 17/241
USPC 715/230; 715/234

(57) ABSTRACT

This application relates to calculating addresses of modifications to tree-based structures and storing some of the addresses in a manner that allows the modifications to be applied, sustained, modified, and removed independently from one another. In some embodiments, the tree-based structures may define documents, including web documents, and the modifications may include annotations. In some embodiments, the addresses may include locations of the annotations within the documents. Methods and systems disclosed herein also include improved methods and systems for handling annotations. Some such methods and systems operate in connection with handling addresses associated with tree-based structures, while others can function independently of tree-based structures. Related user interfaces, applications, and computer program products are disclosed.

### CROSS REFERENCE TO RELATED APPLICATIONS

This application claims priority to U.S. Provisional Patent Application No. 61/061,398, filed Jun. 13, 2008; and U.S. Provisional Patent Application No. 61/061,301, filed Jun. 13, 2008. The entire disclosures of such applications are hereby incorporated by reference.

### BACKGROUND OF THE INVENTION

### Field of the Invention

This invention relates to the field of information technology, and more particularly to methods for handling annotations and otherwise using calculation of addresses related to tree-based structures.

Annotation of information is a valuable tool used in many fields, including publishing, research, law, and computer science, among many others. While tools exist for annotating documents and other items, problems persist with existing techniques for annotation, in particular in contexts such as web publishing. For example, it can be difficult to handle overlapping annotations, to restore annotations after they are affected by subsequent annotations, to maintain references of annotations during modifications of documents, and the like. There remains a need for improved methods and systems for handling annotations.

In contexts related to annotation of documents and in many other contexts, such as computer programming, computer-aided design, product development, research, maintenance of organizational information, information science, and many others, a tree-based structure may be employed to represent information. The tree-based structure may be altered to reflect modifications to the information. Similarly, the tree-based structure may be altered as one or more of the modifications to the information are removed.

Altering a tree-based structure may be done with reference to an address into the tree-based structure. For example, an address may provide a modification's start and/or end location in the tree-based structure.

Due to successive alterations to the tree-based structure, a modification's representation in the tree-based structure may change over time. A result of this is the address at which a modification is applied may not be the address from which the modification could later be removed. Another challenge associated with alterations of tree-based structures is that a modification's representation may encompass varying numbers of nodes and/or sub-trees within the tree-based structure.

There remains a need for calculating addresses of modifications to tree-based structures and storing the addresses in a manner that allows the modifications to be applied, sustained, and removed independently from one another. One domain in which such a need persists is in the annotation of documents that are stored and manipulated based on tree-based data structures, such as HTML-based documents used widely in online publishing, word processing documents used widely in desktop publishing and other document types in other applications.

### SUMMARY OF THE INVENTION

Methods and systems disclosed herein include improved methods and systems for handling annotations, including handling of annotations of documents, such as web documents. Embodiments disclosed herein include methods and systems for handling overlapping annotations, for handling a series of annotations independently (such as to facilitate removing or undoing one annotation without impacting another), for handling independent annotations of different parties, and for applying and maintaining legends on web documents. Some such methods and systems operate in connection with handling addresses associated with tree-based structures, while others can function independently of tree-based structures.

Methods and systems disclosed herein also include methods and systems for calculating addresses of modifications to tree-based structures and storing the addresses in a manner that allows the modifications to be applied, sustained, modified, and removed independently from one another. In some embodiments, the tree-based structures may define documents, the modifications may be annotations, and the addresses may specify locations of the annotations within the documents. It should be understood that annotations, as used herein, should be understood to encompass any of a wide variety of notes, edits, markings, highlighting elements, or the like, used to mark a document, image, or other item, such as insertion of footnotes, endnotes, comments, highlighting, color changes, font changes, underlining, strikethroughs, bolding of text, italics, deletions, insertions, encircling, pointers, arrows, links and many others. Tree-based structures may be used in many other contexts, as noted above, and embodiments of the methods and systems disclosed herein may be used to track and handle modifications to tree-based structures used in connection with items other than documents.

All methods disclosed herein may be embodied by a computer program product stored on a physical storage medium in a computer-readable physical storage format that, when executing on a processor, performs the steps of the method. Alternatively, the methods disclosed herein may be embodied by a machine readable medium having stored program instructions that when executing on a processor may perforin the steps of the method.

In one aspect, a method of maintaining a node in a tree-based structure that is disclosed herein includes taking a tree-based structure corresponding to a document object model of a web document, the tree-based structure having a plurality of nodes, at least one of the nodes having associated therewith a plurality of characters; allowing a user to make an annotation to the web document; storing an address of the annotation, the address corresponding to a tree-based structure, the tree-based structure corresponding to the document without annotations; and using the address to maintain a node in a tree-based structure, the tree-based structure corresponding to the document with annotations. The annotation may be retained during a plurality of annotations to the web document. The address may be used to allow deletion of one annotation without disturbing another annotation. The annotation may be by a plurality of users. The annotation may be tracked by user identification. Maintaining the node may include inserting the node. Maintaining the node may include removing the node. The tree-based structure corresponding to the document with annotations may be an HTML structure using a document object model suitable for allowing display of a document in a web browser.

In one aspect, a method of determining an original address that is disclosed herein includes taking a tree-based structure capable of defining a document; allowing annotation of the tree-based structure, the annotation corresponding to a desired marking of the document, the annotation resulting in insertion of starting and ending tags in the tree-based structure; determining the node address of a node associated with a plurality of characters that are framed by starting and ending tags; determining the character address of at least one character in text framed by starting and ending tags; and determining, taking into account the insertion of the tags into the tree structure, an original address of the at least one character, the original address being the node and character location in the tree structure that would exist but for the insertion of the tags; and storing the original address. The original address may be used to allow a change of the annotation without disturbing other annotations to the document. The document may contain a plurality of annotations, each by at least one of a plurality of users. The plurality of annotations may be tracked by user identification. The tree-based structure capable of defining the document may be an HTML structure using a document object model suitable for allowing display of a document in a web browser.

In one aspect, a method of maintaining a tree-based structure that is disclosed herein includes taking a tree-based structure capable of defining a document; allowing an annotation to the document, the annotation corresponding to a modification of the tree-based structure; storing an address of the annotation, the address corresponding to a tree-based structure capable of defining the document without annotations; establishing a dominance rule whereby at least one type of annotation dominates another type of annotation; and using the address and the dominance rule to maintain a tree-based structure capable of defining the document with annotations. The dominance rule may be based on the sequence of annotations. The dominance rule may be based on the user. The dominance rule may be based on the status of a user within a hierarchy. The hierarchy may be a corporate hierarchy.

In one aspect, a method of tracking changes to annotations that is disclosed herein includes taking a tree-based structure capable of defining a document; allowing a plurality of users to make annotations to the document, each of the annotations corresponding to a desired marking of the document; storing a plurality of addresses, each of the addresses corresponding to at least one of the annotations, the annotations corresponding to a tree-based structure, the tree-based structure capable of defining the document without annotations; using the addresses to maintain a tree-based structure capable of defining the document with the annotations; and tracking changes to the annotations. Each of the addresses may be used to allow a change of an annotation without disturbing other annotations to the document. The annotations may be tracked by user identification. The tree-based structure may contain tags based upon the addresses. The tree-based structure may be an HTML structure using a document object model suitable for allowing display of the document in a web browser. At least one of the changes may include removing at least one of the annotations.

In one aspect, a computer program product, disclosed herein, for maintaining a node in a tree-based structure stored on a physical storage medium in a computer-readable physical storage format includes programming that takes a tree-based structure corresponding to a document object model of a web document, the tree-based structure having a plurality of nodes, at least one of the nodes having associated therewith a plurality of characters; programming that allows a user to make an annotation to the web document; programming that stores an address of the annotation, the address corresponding to a tree-based structure, the tree-based structure corresponding to the document without annotations; and programming that uses the address to maintain a node in a tree-based structure, the tree-based structure corresponding to the document with annotations. The annotation may be retained during a plurality of annotations to the web document. The address may be used to allow deletion of one annotation without disturbing another annotation. The annotation may be by a plurality of users. The annotation may be tracked by user identification. Maintaining the node may include inserting the node. Maintaining the node may include removing the node. The tree-based structure corresponding to the document with annotations may be an HTML structure using a document object model suitable for allowing display of a document in a web browser.

In one aspect, a computer program product, disclosed herein, for determining an original address stored on a physical storage medium in a computer-readable physical storage format includes programming that takes a tree-based structure capable of defining a document; programming that allows annotation of the tree-based structure, the annotation corresponding to a desired marking of the document, the annotation resulting in insertion of starting and ending tags in the tree-based structure; programming that determines the node address of a node associated with a plurality of characters that are framed by starting and ending tags; programming that determines the character address of at least one character in text framed by starting and ending tags; and programming that determines, taking into account the insertion of the tags into the tree structure, an original address of the at least one character, the original address being the node and character location in the tree structure that would exist but for the insertion of the tags; and programming that stores the original address. The original address may be used to allow a change of the annotation without disturbing other annotations to the document. The document may contain a plurality of annotations, each by at least one of a plurality of users. The plurality of annotations may be tracked by user identification. The tree-based structure capable of defining the document may be an HTML structure using a document object model suitable for allowing display of a document in a web browser.

In one aspect, a computer program product, disclosed herein, for building an original address based upon a modified address includes programming that receives a modified address; programming that finds a modified target node corresponding to the modified address; programming that finds an ancestor of the modified target node, the ancestor being a first original ancestor of the target node; programming that determines an original text offset; programming that finds an original identifiable node; programming that determines an original path array; and programming that builds an original address, the original address comprising an identifier for the original identifiable node, the original path array, and the original text offset. The computer program product may further comprise programming that uses the original address to allow a change of a first annotation without disturbing a second annotation, both the first annotation and the second annotation being to a document. The document may contain a plurality of annotations, each by at least one of a plurality of users. The plurality of annotations may be tracked by user identification. Both the original address and the modified address may be to a tree-based structure capable of defining a document. The tree-based structure capable of defining the document may be an HTML structure using a document object model suitable for allowing display of a document in a web browser.

In one aspect, a computer program product, disclosed herein, for building a modified address based upon an original address includes programming that receives an original address; programming that finds a start of an original target node based upon the original address; programming that determines a modified text offset; programming that finds a modified identifiable node; programming that determines a modified path array; and programming that builds a modified address, the modified address comprising an identifier for the modified identifiable node, the modified path array, and the modified text offset. The computer program product of building a modified address based upon an original address may include programming that uses the original address to allow a change of a first annotation without disturbing a second annotation, both the first and the second annotation to a document. The document may contain a plurality of annotations, each by at least one of a plurality of users. The plurality of annotations may be tracked by user identification. Both the original address and the modified address may be to a tree-based structure capable of defining a document. The tree-based structure capable of defining the document may be an HTML structure using a document object model suitable for allowing display of a document in a web browser.

In one aspect, a computer program product, disclosed herein, for maintaining a tree-based structure stored on a physical storage medium in a computer-readable physical storage format includes programming that takes a tree-based structure capable of defining a document; programming that allows an annotation to the document, the annotation corresponding to a modification of the tree-based structure; programming that stores an address of the annotation, the address corresponding to a tree-based structure capable of defining the document without annotations; programming that establishes a dominance rule whereby at least one type of annotation dominates another type of annotation; and programming that uses the address and the dominance rule to maintain a tree-based structure capable of defining the document with annotations. The dominance rule may be based on the sequence of annotations. The dominance rule may be based on the user. The dominance rule may be based on the status of a user within a hierarchy. The hierarchy may be a corporate hierarchy.

In one aspect, a computer program product, disclosed herein, for tracking changes to annotations stored on a physical storage medium in a computer-readable physical storage format includes programming that takes a tree-based structure capable of defining a document; programming that allows a plurality of users to make annotations to the document, each of the annotations corresponding to a desired marking of the document; programming that stores a plurality of addresses, each of the addresses corresponding to at least one of the annotations, the annotations corresponding to a tree-based structure, the tree-based structure capable of defining the document without annotations; programming that uses the addresses to maintain a tree-based structure capable of defining the document with the annotations; and programming that tracks changes to the annotations. Each of the addresses may be used to allow a change of an annotation without disturbing other annotations to the document. The annotations may be tracked by user identification. The tree-based structure may contain tags based upon the addresses. The tree-based structure may be an HTML structure using a document object model suitable for allowing display of the document in a web browser. At least one of the changes may include removing at least one of the annotations.

In embodiments, the present invention provides methods and systems for building an original address. The original address may be built based upon a modified address. The original address may be in the form of an unmodified tree-based structure, and a modified address may be a modified version of the original unmodified tree-based structure.

In embodiments, methods and system for determining an original address may be provided. The original address may be based upon a modified address. The original address may be in the form of an unmodified tree-based structure, and a modified address may be a modified version of the original unmodified tree-based structure.

The tree-based structure may define a document. In embodiments, the modifications to the tree-based structure may include application, removal or changing of annotations applied to the document. In embodiments, the modified version of the tree-based structure may be an annotated version of the document. In embodiments, the methods and systems may include using the original address to allow modifications to the tree-based structure without any particular modification disturbing another modification.

In an aspect of the invention, a system and method may include determining an original address based upon a modified address, an original address being into an original, unmodified tree-based structure and a modified address being into a modified version of the original tree-based structure. The tree-based structure may define a document, modifications to the tree-based structure include at least one of application, removal and changing of annotations applied to the document, and the modified version of the tree-based structure is an annotated version of the document. The system and method may further include using the original address to allow modifications to the tree-based structure without any particular modification disturbing another modification.

In an aspect of the invention, a machine readable medium having stored program instructions for determining an original address based upon a modified address is provided. The machine readable medium when executed on a processor may perform steps which may include taking an address of an item in a tree-based structure that has been at least once modified, finding a target node corresponding to the item address in the at least once modified tree-based structure, finding an ancestor of the target node, the ancestor being a first original ancestor of the target node, determining in the at least once modified tree-based structure a text offset to the item from the start of the first node that was a part of the same node as the target node in the unmodified tree-based structure, finding a first identifiable ancestor of the target node in the at least once modified tree-based structure that also exists in the unmodified tree-based structure and determining a path in the unmodified tree-based structure from it to the target node in the unmodified tree-based structure, and determining an address of the item in the ancestor tree-based structure. The first identifiable ancestor of the target node may be in an original tree-based structure before modification. The address of the item in the ancestor tree-based structure may include an identifier for the first identifiable ancestor, a path array in the ancestor tree-based structure, and a text offset in the ancestor tree-based structure. The tree-based structure may define a document, modifications to the tree-based structure include application, removal or changing of annotations applied to the document, and the modified version of the tree-based structure is an annotated version of the document. The instructions may further include using the original address to allow modifications to the tree-based structure without any particular modification disturbing another modification. A user may provide the annotation. The address may be used to allow a change of the annotation without disturbing other annotations to the document. The document with annotations may contain a plurality of annotations, each by at least one of a plurality of users. The plurality of annotations may be tracked by user identification. The tree-based structure capable of defining the document with annotations may contain a tag based upon the address. The tree-based structure capable of defining the document may be an HTML structure using a document object model suitable for allowing display of a document in a web browser. The tree-based structure capable of defining the document with annotations may be an HTML structure using a document object model suitable for allowing display of a document in a web browser.

In an aspect of the invention, a machine readable medium having stored program instructions for determining an original address based upon a modified address is provided. The machine readable medium when executed on a processor may perform steps which may include taking an address of an item in an unmodified tree-based structure, finding in a modified tree-based structure the start of a first node that was a part of the same node as the target node in the modified tree-based structure, determining a text offset of the modified target node in the unmodified tree-based structure, finding in a modified tree-based structure a first identifiable node that is an ancestor of the modified target node and determining a corresponding path array, and determining a modified address associated with the modified target node in the modified tree-based structure. The modified address may include an identifier, a path array, and a text offset for the item in the modified tree-based structure. The tree-based structure may define a document, modifications to the tree-based structure include at least one of application, removal and changing of annotations to the document and the modified version of the tree-based structure is an annotated version of the document. The medium may further include using the original address to allow modifications to the tree-based structure without any particular modification disturbing another modification. The medium may further include also using the modified address in addition to the original address to allow modifications to the tree-based structure without any particular modification disturbing another modification. The medium may further include associating addresses of the target node in the unmodified tree-based structure and modified tree-based structure, wherein each address includes an identifier, a path array and a text offset. The medium may further include using the association of addresses to support handling of methods that involve modifications to the tree-based structure. The tree-based structure may define a document, modifications to the tree-based structure include at least one of application, removal and changing of annotations to the document and the modified version of the tree-based structure is an annotated version of the document. The document may contain a plurality of annotations, each by at least one of a plurality of users. The plurality of annotations may be tracked by user identification. The tree-based structure capable of defining the document may be an HTML structure using a document object model suitable for allowing display of a document in a web browser.

In an aspect of the invention, a system and method may include building a modified address based upon an original address, an original address being into an original, unmodified tree-based structure and a modified address being into a modified version of the original tree-based structure. The tree-based structure may define a document, modifications to the tree-based structure include at least one of application, removal and changing of annotations to the document and the modified version of the tree-based structure is an annotated version of the document. The system and method may further include using the original address to allow modifications to the tree-based structure without any particular modification disturbing another modification. The system and method may further include associating addresses of the item in the original tree-based structure and modified tree-based structure, wherein each address includes an identifier, a path array and a text offset.

In an aspect of the invention, a system and method may include determining a modified address based upon an original address, an original address being into an original, unmodified tree-based structure and a modified address being into a modified version of the original tree-based structure. The tree-based structure may define a document, modifications to the tree-based structure include at least one of application, removal and changing of annotations to the document and the modified version of the tree-based structure is an annotated version of the document. The system and method may further include using the original address to allow modifications to the tree-based structure without any particular modification disturbing another modification. The system and method may further include associating addresses of the item in the original tree-based structure and modified tree-based structure, wherein each address includes an identifier, a path array and a text offset.

In an aspect of the invention, a machine readable medium having stored program instructions for maintaining a tree-based structure is provided. The machine readable medium when executed on a processor may perform steps which may include taking a tree-based structure, allowing a modification to the tree-based structure, storing an address of the modification, the address corresponding to a tree-based structure without modifications, and using the address to maintain a node of a tree-based structure with modifications. The address may be used to allow the application, removal or change of the modification to the tree-based structure without disturbing another modification to the tree-based structure. The tree-based structure may be capable of defining a document and the modification to the tree-based structure is an annotation to the document. The address may be used to allow the application, removal or change of the annotation to the document without disturbing another annotation to the document. The tree-based structure capable of defining a document may be the document object model of a web document and the modification to the tree-based structure is an annotation to the web document. The address may be used to allow the application, removal or change of the annotation to the web document without disturbing another annotation to the web document. Maintaining the tree-based structure may include maintaining a node in the tree-based structure. Maintaining the node may include addressing the modification to the node or connecting the annotation to an HTML or other element of the web document.

In an aspect of the invention, a machine readable medium having stored program instructions for maintaining a tree-based structure is provided. The machine readable medium when executed on a processor may perform steps which may include taking a tree-based structure, allowing a modification to the tree-based structure, storing an address of the modification, the address corresponding to a tree-based structure without modifications, and using the address to maintain a tree-based structure with modifications, wherein maintaining a node of the tree-based structure includes addressing the modification to the node or connecting the modification to an HTML or other element of a web document, and wherein the addressing is to the entire node rather than one or more items within it and the connecting is to an entire HTML or other element rather than one or more of its characters. The tree-based structure may be capable of defining a document and the modification to the tree-based structure is an annotation to the document.

In an aspect of the invention, a machine readable medium having stored program instructions for determining an original address is provided. The machine readable medium when executed on a processor may perform steps which may include taking a tree-based structure, allowing a modification to the tree-based structure, determining the node address of a node associated with the modification, determining the item address of at least one item associated with the node, and determining an original address of at least one item associated with the node, the original address being the node and item location in the tree structure that would exist but for any modifications to the tree-based structure. The tree-based structure may be capable of defining a document, the modification to the tree-based structure is an annotation to the document, and the item is a character in the document. The original address may include the node address only. The tree-based structure may be capable of defining a document and the modification to the tree-based structure is an annotation to the document.

In an aspect of the invention, a machine readable medium having stored program instructions for maintaining a tree-based structure is provided. The machine readable medium when executed on a processor may perform steps which may include taking a tree-based structure capable of defining a document, allowing an annotation to the document, the annotation corresponding to a modification of the tree-based structure, storing an address of the annotation, the address corresponding to a tree-based structure capable of defining the document without annotations, establishing a dominance rule whereby at least one type of annotation dominates another type of annotation, and using the address and the dominance rule to maintain a tree-based structure capable of defining the document with annotations. The tree-based structure may be capable of defining a document and the modification to the tree-based structure is an annotation to the document.

In an aspect of the invention, a machine readable medium having stored program instructions for allowing a plurality of overlapping annotations in a user interface is provided. The machine readable medium when executed on a processor may perform steps which may include taking a tree-based structure capable of defining a document, providing a user interface for allowing a user to make an annotation to the document, storing an address of the annotation, the address corresponding to a tree-based structure capable of defining the document without annotations, and allowing, in the user interface, a plurality of overlapping annotations for the document. The tree-based structure may be capable of defining a document and a modification to the tree-based structure is an annotation to the document. The address may be used to allow a change of the annotation without disturbing other annotations to the document. The document may contain a plurality of annotations, each by at least one of a plurality of users. The plurality of annotations may be tracked by user identification. The tree-based structure may contain a tag based upon the address. The tree-based structure may be an HTML structure using a document object model suitable for allowing display of a document in a web browser.

In an aspect of the invention, a machine readable medium having stored program instructions for allowing a plurality of overlapping annotations in a user interface is provided. The machine readable medium when executed on a processor may perform steps which may include taking a tree-based structure capable of defining a document, providing a user interface for allowing a user to make an annotation to the document, storing an address of the annotation, the address corresponding to a tree-based structure capable of defining the document without annotations, and processing, in the user interface, a plurality of overlapping annotations for the document. Processing the new annotation may include processing in accordance with at least one rule. The at least one rule may relate to the new annotation overlapping the beginning of an existing annotation, and processing may include removing the existing annotation and changing an end address of the new annotation to be the end address of the existing annotation or resetting a start address of the existing annotation to a start address of the new annotation. The at least one rule may relate to the new annotation overlapping the end of an existing annotation. Processing may include removing the existing annotation and changing a start address of the new annotation to be a start address of the existing annotation or changing an end address of the existing annotation to be an end address of the new annotation. The at least one rule may relate to the new annotation falling completely within an existing annotation. Processing may include discarding the new annotation and further processing to place the new annotation stops. The at least one rule may relate to the new annotation completely surrounding an existing annotation. Processing may include removing the existing annotation or changing a start and an end address of the existing annotation to be the start and end address of the new annotation, respectively, and the new annotation is discarded. The at least one rule may prioritize one type of annotation over another type of annotation. The at least one rule may prioritize one user's annotation over another user's annotation. The address may be used to allow a change of the annotation without disturbing other annotations to the document. The document may contain a plurality of annotations, each by at least one of a plurality of users. The plurality of annotations may be tracked by user identification. The tree-based structure may contain a tag based upon the address. The tree-based structure may be an HTML structure using a document object model suitable for allowing display of a document in a web browser.

The at least one rule may prioritize the new annotation over an existing annotation in the case of a conflict. The at least one rule may relate to the new annotation overlapping the beginning of an existing annotation. Processing may include trimming the existing annotation by setting its start address to an end address of the new annotation. The at least one rule may relate to the new annotation overlapping the end of an existing annotation. Processing may include trimming the existing annotation by setting its end address to a start address of the new annotation. The at least one rule may relate to the new annotation falling completely within an existing annotation. Processing may include splitting the existing annotation into at least two annotations, with the new annotation appearing in between the split existing annotation pieces. The at least one rule may relate to the new annotation completely surrounding an existing annotation. Processing may include removing the existing annotation.

In an aspect of the invention, a system and method may include maintaining at least one of a label, a tag and a description in connection with at least one of a particular annotation type and a property-based variation of an annotation type, wherein the annotation type is associated with a modification to a tree-based structure defining a document. Maintaining the at least one label, tag or description includes at least one of creating, assigning, editing, deleting and removing it. Maintaining the at least one label, tag or description includes storing it at least one of remotely and locally. Maintaining the at least one label, tag or description includes dynamically tracking it as other labels, tags or descriptions are applied to other annotation types or property-based variations of annotation types. The method may be applied to a combination of multiple annotation types or property-based variations of annotation types. More than one label, tag or description may be maintained in connection with a particular annotation type or property-based variation of an annotation type.

In an aspect of the invention, a system and method may include maintaining a legend of at least one of a label, a tag or a description in connection with one or more annotation types or property-based variations of annotation types, wherein the one or more annotations are one or more modifications to a tree-based structure defining a document. Maintaining the legend may include instantiating, creating, editing, deleting or removing it. Maintaining the legend may include dynamically updating and displaying it and its contents. Maintaining the legend may include optionally hiding and showing it. Maintaining the legend may include storing it remotely or locally. At least one of instantiating, creating, deleting, removing or optionally hiding and showing the legend may be via a user interface that is part of at least one of a web browser, a web browser extension, a plug-in, an add-on, a bookmark, or a bookmarklet. At least one of instantiating, creating, deleting, removing or optionally hiding and showing the legend may be via a script.

In an aspect of the invention, a system and method may include displaying at least one of a label, a tag or a description associated with an annotation upon mouseover of the annotation, wherein the annotation is a modification to a tree-based structure defining a document.

In an aspect of the invention, a system and method may include pre-defining a scheme of at least one of a label, a tag or a description in connection with at least one type of annotation or at least one property-based variation of a type of annotation, wherein the annotation is a modification to a tree-based structure defining a document. The scheme may be part of a legend or key. A user may save the scheme for later use. A user may share the scheme with other users. A user may define the scheme for a group or users.

In an aspect of the invention, a system and method may include manipulating a particular instance of annotated content based on a label, tag or description associated with the type of annotation or property-based variation of the type of annotation, wherein the annotation is a modification to a tree-based structure defining a document. The system and method may be applied to multiple instances of annotated content all having the same label, tag or description. Manipulating the annotated content may include exporting it from or importing it into a document. The system and method may be applied to multiple instances of annotated content all having the same label, tag or description.

In an aspect of the invention, a system and method may include formulating a query for documents or filtering document search results based on at least one of a label, a tag or a description associated with at least one type of annotation or property-based variation of annotation type applied to content in the queried or searched documents, wherein the annotation is a modification to a tree-based structure defining a document.

In an aspect of the invention, a system and method may include formulating a query for documents or filtering document search results based on at least one of a label, tag or description associated with at least one annotation present in a queried or searched document, wherein the annotation is a modification to a tree-based structure defining a document.

In an aspect of the invention, a system and method may include building an original address based upon a modified address, an original address being into an original, unmodified tree-based structure and a modified address being into a modified version of the original tree-based structure. The tree-based structure may define a document, modifications to the tree-based structure include at least one of application, removal and changing of annotations applied to the document, and the modified version of the tree-based structure is an annotated version of the document. The system and method may further include using the original address to allow modifications to the tree-based structure without any particular modification disturbing another modification.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless such understanding conflicts with the context in which such references are used, unless such understanding hinders the system and methods disclosed herein, or unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

The invention and the following detailed description of certain embodiments thereof may be understood by reference to the following figures:

FIG. 1 depicts a block diagram of a system for calculating addresses in tree-based structures.

FIG. 2 depicts a flowchart of a method of converting a modified address to an original address.

FIG. 3 depicts a flowchart of a step in the method of converting the modified address to the original address.

FIG. 4 depicts a flowchart of a step in the method of converting the modified address to the original address.

FIG. 5 depicts a flowchart of a step in the method of converting the modified address to the original address.

FIG. 6 depicts a flowchart of a step in the method of converting the modified address to the original address.

FIG. 7 depicts a flowchart of a step in the method of converting the modified address to the original address.

FIG. 8 depicts a flowchart of a method of determining a text length of a sub-tree of a tree-based structure.

FIG. 9 depicts a flowchart of a method of converting an original address to a modified address.

FIG. 10 depicts a flowchart of a step in the method of converting the original address to the modified address.

FIG. 11 depicts a flowchart of a step in the method of converting the original address to the modified address.

FIG. 12 depicts a flowchart of a step in the method of converting the original address to the modified address.

FIG. 13 depicts a flowchart of a step in the method of converting the original address to the modified address.

FIG. 14 depicts a block diagram of an example original tree-based structure.

FIG. 15 depicts a block diagram of an example modified tree-based structure.

FIGS. 16A and 16B depict flowcharts of methods of maintaining a tree-based structure.

FIG. 17A depicts a flowchart of a method of maintaining a node in a tree-based structure.

FIGS. 17B-17N depict embodiments of direct-to-node annotation placement.

FIG. 18 depicts a flowchart of a method of determining an original address.

FIG. 19 depicts a flowchart of a method of maintaining a tree-based structure based on an address and dominance rule.

FIG. 20A depicts a flowchart of a method of allowing a plurality of overlapping annotations in a user interface.

FIGS. 20B and 20C depict embodiments of merging of annotations.

FIGS. 20D and 20E depict embodiments of splitting of an annotation.

FIG. 21 depicts a flowchart of a method of tracking changes to annotations.

FIG. 22 depicts a document in a web browser and a related DOM.

FIG. 23 depicts a document in a web browser and a related DOM.

FIGS. 24A and 24B depict documents in a web browser and related DOMs.

FIG. 25 depicts a document in a web browser and a related DOM.

FIG. 26 depicts a document in a web browser and a related DOM.

FIG. 27 depicts a document in a web browser and a related DOM.

FIGS. 28A-28L depict embodiments of legend or key structures to organize and manage annotations.

### DETAILED DESCRIPTION OF THE PREFERRED EMBODIMENTS

A tree-based structure may be employed to represent information. The tree-based structure may be altered to reflect modifications to the information. Similarly, the tree-based structure may be altered as one or more of the modifications to the information are removed.

Some embodiments of the present invention may maintain such a tree-based structure and nodes therein in a manner that allows a modification to be added, sustained, modified, and removed, even as the tree-based structure is altered for the purpose of affecting other modifications. In certain preferred embodiments, different modifications may be independently added, sustained, modified and/or removed, and actions with respect to each such modification may be independently handled in the tree-based structure and nodes, such that actions with respect to one modification do not impact the handling of another modification.

Some embodiments of the present invention may calculate an address into a first tree-based structure from an address into a second-tree based structure, and vice versa. In some cases, the first tree-based structure may represent unmodified information and the second tree-based structure may represent modified information. In other cases the two tree-based structures may represent two different states of modified information, such as resulting from distinct modifications to the tree-based structure. Among many examples, modifications may correspond to annotation of a tree-based structure that defines a document, such as a structure based on a document type definition, an XML structure, an HTML structure, a dynamic HTML structure, or the like. Annotations may take many forms, such as insertion of notes, highlighting of text, changes in font, deletions, strikethroughs, underlining, multiple underlining, and many others, in each case optionally embodied by making a modification to a tree-based structure, such as by inserting characters, pointers, tags or other indicators at appropriate locations in the tree-based structure. It should be understood that methods of annotation are just one embodiment of the modifications, methods of calculating addresses of modifications, otherwise known as an addressing schema, are just one embodiment of the invention, and that the addressing schema is not limited to usefulness for annotation.

It will be appreciated that an original tree-based structure may alternatively be described as unmodified, unaltered, unannotated, unchanged, unmarked, untouched, unaffected, clean, new, and the like. An original tree-based structure may alternatively be referenced as a modified tree-based structure lacking all modifications, a modified tree-based structure prior to any applied modifications, and the like. All such structures may correspond to or be capable of defining a document without modifications, alterations, annotations, changes, markings, markups, or the like. All addresses, items, text, nodes, elements, and the like described as being original will be understood to be present in, associated with, or relative to an original tree-based structure even when such structure is described or referenced by the alternative methods described here.

It will be appreciated that a modified tree-based structure may alternatively be described as non-original, not original, altered, annotated, changed, marked, transformed, adapted, adjusted, amended, tweaked, converted, worked, corrected, fixed, qualified, revised, updated, and the like. A modified tree-based structure may alternatively be referenced as a modified original tree-based structure, an original tree-based structure with modifications, and the like. All such structures may correspond to or be capable of defining a document with one or more modifications, alterations, annotations, changes, markings, markups, or the like. All addresses, items, text, nodes, elements, and the like described as being modified will be understood to be present in, associated with or relative to a modified tree-based structure even when such structure is described or referenced by the alternative methods described here.

An original tree-based structure may exist prior to a modified tree-based structure in time, sequence or version. Similarly, a document corresponding to or capable of being defined by the original tree-based structure may exist prior to a document corresponding to or capable of being defined by the modified tree-based structure in time, sequence or version. In some contexts, an original tree-based structure may be considered an ancestor of a modified tree-based structure. Similarly, in some contexts, a document corresponding to or capable of being defined by the original tree-based structure may be considered an ancestor of a document corresponding to or capable of being defined by the modified tree-based structure.

An item, node or element in a tree-based structure may be referenced, located, positioned, found or identified by an original address or corresponding modified address, with the original address being relative to an original state or version of the tree-based structure and the modified address being relative to a modified state or version of the tree-based structure.

All of this and more will be understood from the following and related disclosures.

A tree-based structure may contain any number of nodes arranged as an n-ary tree. Thus, each of the nodes may have zero or one parent node and up to n child nodes. The child nodes may be arranged linearly and, thus, may be referenced by way of a one-dimensional index (a “child index”). In keeping with a convention of the art, any and all indexes described herein may be zero-based and so the first element in a linear data structure may have an index of zero.

If a node is the m^{th} child of a parent, then the node's previous sibling may be the m−1^{th} child of the parent. Similarly, if a node is the m^{th} child of a parent, then the node's next sibling may be the m+1^{th} child of the parent.

In some embodiments, any and all of the nodes may be addressable by name. This name may be referred to as an identifier. It will be seen hereinafter that, in practice, some nodes may have an identifier while other nodes do not.

Any and all of the nodes may be leaf nodes containing or referencing one or more items. The items may be arranged in any suitable manner within the nodes. For example and without limitation, the items may be arranged according to a suitable linear data structure, a suitable non-linear data structure, or the like. In some embodiments, the items may be arranged according to a list, an associative array, a graph, a tree, any and all combinations of the foregoing, or the like. It will be understood that a variety of embodiments of the nodes are possible.

Each of the items may be a primitive data type, a composite data type, or the like. For example and without limitation, each of the items may be a character, integer, string, double, float, or the like. Also for example and without limitation, each of the items may be a structure, bit field, union, or the like.

Generally speaking, a composite data type may employ an address space. Thus, the items contained or referenced by a composite data structure (that is, an instance of the composite data type) may be addressable within that data structure. For example, an item that is a string may contain a plurality of characters, each of which can be uniquely located within the string by way of an index. For another example, an item that is a structure may contain a plurality of data-type instances or references, each of which can be uniquely located within the structure by name. For still another example, an item that is a raster graphics image may contain a two-dimensional array of pixels, each of which can be uniquely located by way of a two-dimensional index. For still yet another example, an item that is a vector graphics image may contain a set of vectors that are addressable by way of a vector index, a start/stop location, a two-dimensional index into a raster graphics image defined by the vector graphics image, any and all combinations of the foregoing, or the like. It will be understood that a variety of embodiments of the composite data type and address space are possible.

In light of the foregoing, it will be understood that embodiments of the present invention are in no way limited to composite data types that are strings.

In the examples provided herein and elsewhere, the words “text” and “character” are provided in the spirit of pedagogy, to assist the reader in appreciating some concrete and tangible results produced by embodiments of the invention. In no way are these examples intended to limit embodiments of the invention to those involving text and characters. To wit, unless explicitly stated otherwise or clear from the context, “text” should be interpreted as an example of an item and “character” should be interpreted as an example of an item contained or referenced by a composite data structure. Thus, for example, “a position of a character of interest within a text node” may be interpreted as an example of a position of an item of interest contained or referenced by a composite data structure within a node.

Similarly, unless explicitly stated otherwise or clear from the context, an “array” should be interpreted as an example of a data structure, linear or otherwise, in which elements or items are addressable by way of a one-dimensional index. Thus, for example, a “children array” may be interpreted as an example of data structure, linear or otherwise, in which children are addressable by way of a one-dimensional index.

Finally, unless explicitly stated otherwise or clear from the context, the word “document” should be interpreted as an example of information. Thus, for example, “a web document” may be interpreted as an example of information available on the web, or web-based information, or the like.

In some embodiments, each original address 112 and modified address 104 may be encoded as a 3-tuple containing a first component including a first node's identifier (if any), a second component including a path (if any) from first the node to a second node, and a third component including an address of an item (if any) within the second node.

In some embodiments, if the 3-tuple includes a null value for the first node's identifier then the first node may be the root node or other directly accessible, established node of a tree-based structure.

In some embodiments, the path from the first node to the second node may be represented as an ordered set of child indexes. For example and without limitation, the path [0, 5, 2] may be interpreted as follows: the second node is the 3^{rd} child of the 6th child of the 1^{st} child of the first node. It will be understood that a variety of paths including any and all numbers of children are possible.

In any case, an address (104, 112) may identify a node's or item's location within a tree-based structure. The first, second, and third components of the address (104, 112) may be encoded in any and all suitable formats. In some embodiments, the suitable format of the third element may relate to the address space of a composite data structure within the second node. A number of examples of an address (104, 112) may be described hereinafter and still other examples will be appreciated. It will be understood that a variety of embodiments of the address (104, 112) are possible.

The original address 112 may correspond to a location in the original tree-based structure. For example and without limitation, the first and second elements of the original address 112 may correspond to a text node's location in the original tree-based structure and the third element of the original address 112 may correspond to a character location within the text node.

Similarly, the modified address 104 may correspond to a location in the modified tree-based structure 108. For example and without limitation, the first and second elements of the modified address 104 may correspond to a text node's location in the modified tree-based structure 108 and the third element of the modified address 104 may correspond to a character location within the text node.

In some embodiments, the location to which an address (104, 112) corresponds may be a start or stop point of an annotation or modification, an insertion or deletion point of an annotation or modification, or the like. It will be understood that a variety of other embodiments are possible.

In any case and without limitation, an annotation may include a highlight, boldface, italic, underline, comment box, image, sound, style, appearance, marking, link, any and all combinations of the foregoing, or the like as applied to text, links, images, graphics, lists, graphs, advertisements, icons, or other items. It will be understood that a variety of annotations are possible.

Any and all things (nodes, items, text, and so on) that are described as being “original” may be associated with or present in an original tree-based structure, which in turn may be considered “original” based on selection of a particular state of the tree-based structure as such (e.g., a first version of a tree-based structure representing a document, or the like). For example, an original node is a node that exists in the original tree data structure and original text is text that exists in the original tree data structure. Moreover, some of the things in a modified tree-based structure may be “original” when those things are also present in an original tree-based structure.

Any and all things (nodes, items, text, and so on) that are described as “modified” may be associated with or result from a modification or difference relative to the original tree-based structure.

Throughout this disclosure and elsewhere: A subscript ‘O’ may be appended to a term to indicate that the term relates to the original tree-based structure. A subscript ‘M’ may be appended to a term to indicate that the term relates to the modified tree-based structure 108.

Any and all things (nodes, items, text, and so on) that are described as being “generated” may be present in a modified tree-based structure while being absent from the unmodified or original tree-based structure. In some embodiments, things that are generated may result from alterations or modifications to a tree-based structure. In some embodiments, applying an annotation (e.g. a style or the like) to a portion of text within a single original text node may split that node and result in multiple generated nodes.

Nodes described as being “ignorable” may be generated nodes containing new text or other new content. In other words, ignorable nodes may only contain content that is not original. In some embodiments, ignorable nodes may be marked in some manner or otherwise remembered as being ignorable nodes as they are added to a tree-based structure. This may enable determination of whether a node is ignorable.

Nodes described as being “identifiable” may be nodes having a unique identifier. A root node or other directly accessible, established node may also be identifiable whether or not it has a unique identifier.

Throughout this disclosure and elsewhere, nodes with solid outlines and white backgrounds may be original nodes; nodes with dashed outlines or grey backgrounds may be modified nodes; and nodes with black backgrounds may be generated nodes.

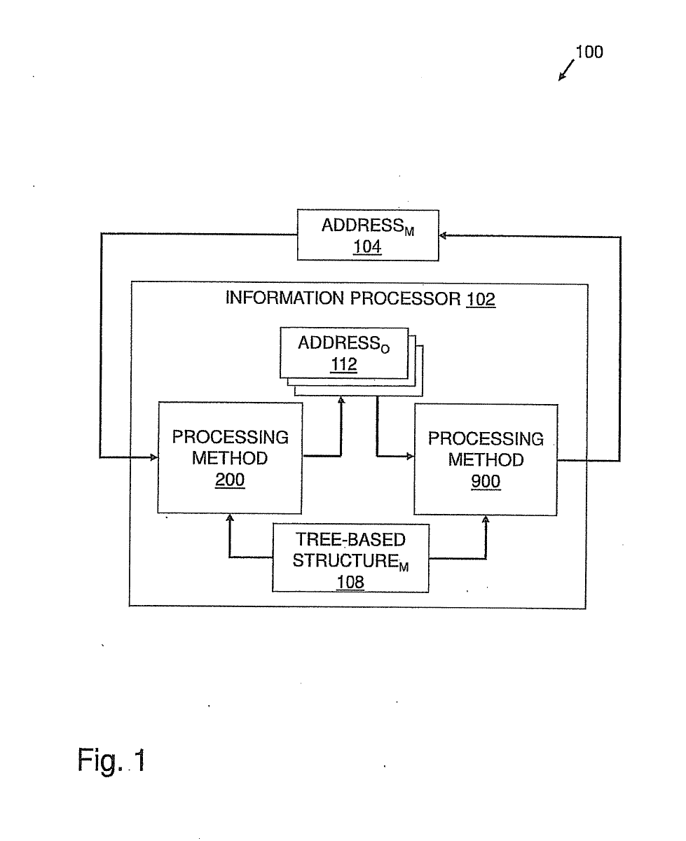

FIG. 1 depicts a block diagram of a system and method of calculating addresses in tree-based structures. The system and method 100 may include an information processor 102 which operates according to processing methods in connection with manipulation of a tree-based structure to produce a modified tree-based structure 108, such as in connection with handling of addresses, which may include one or more original addresses 112 and one or more modified addresses 104. A given modified address 104 may be consumed and/or produced by the information processor 102; that is, the information processor 102 may produce a modified address 104 by operating on a modified tree-based structure 108, or the information processor 102 may take a modified address 104 as an input, such as in connection with maintaining that modified address 104 in connection with a particular modification associated with a particular state of a modified tree-based structure 108. It should be noted that a modified address 104, as referred to in this disclosure, may be associated with a state of a modified tree-based structure 108 before or after any kind of modification (such as an immediate modification associated with completion of a particular step of a process implemented by the information processor 102 or a past modification that resulted in a modified address 104 being stored in relation to a modified tree-based structure 108). In certain preferred embodiments, the information processor 102 may operate in relation to original addresses 112 associated with a modified tree-based structure 108, such as employing various processing methods, such as processing method 200 and processing method 900. It should be noted that the terms “original address” 112 and “modified address” 104 are used herein by way of example, to illustrate creation and maintenance of distinct address-related state information about any modification to a modified tree-based structure 108.

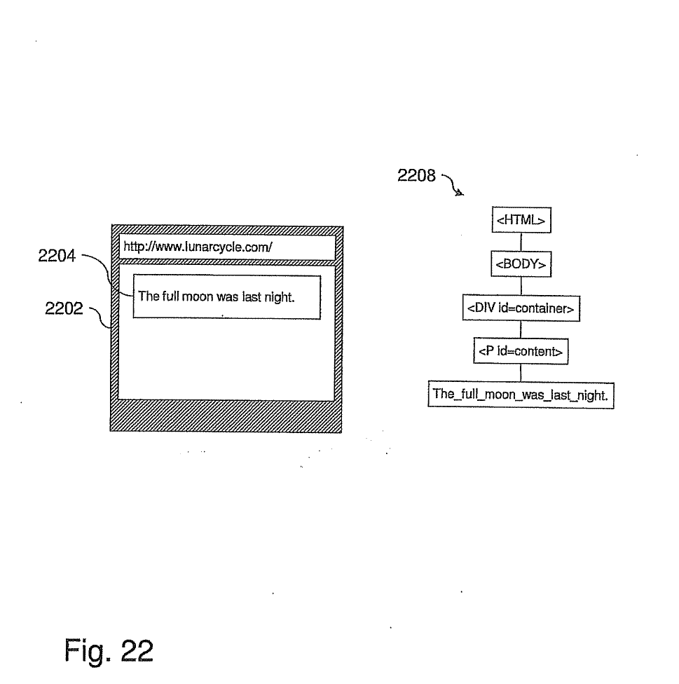

As shown, in some embodiments, the original tree-based structure (not depicted) itself may be notional (i.e., not retained) while the original address 112 may be instantiated, such as by being calculated, determined, built, created, tracked or stored in relation to a state of a modified tree-based structure 108. As will be seen hereinafter with reference to FIGS. 22-27 and elsewhere, in some embodiments, the original tree-based structure may be instantiated, and from this a modified tree-based structure 108 may be produced.

In some embodiments, the original tree-based structure (whether notional or otherwise) may include an XML document, a document object model (DOM), or the like. In some embodiments, the DOM may model an HTML document suitable for display in a web browser. It will be understood that a variety of embodiments of the original tree-based structure are possible.

An item within the modified tree-based structure 108 may be uniquely located by way of the modified address 104. Likewise, the original address 112 may uniquely locate an item within an original tree-based structure.

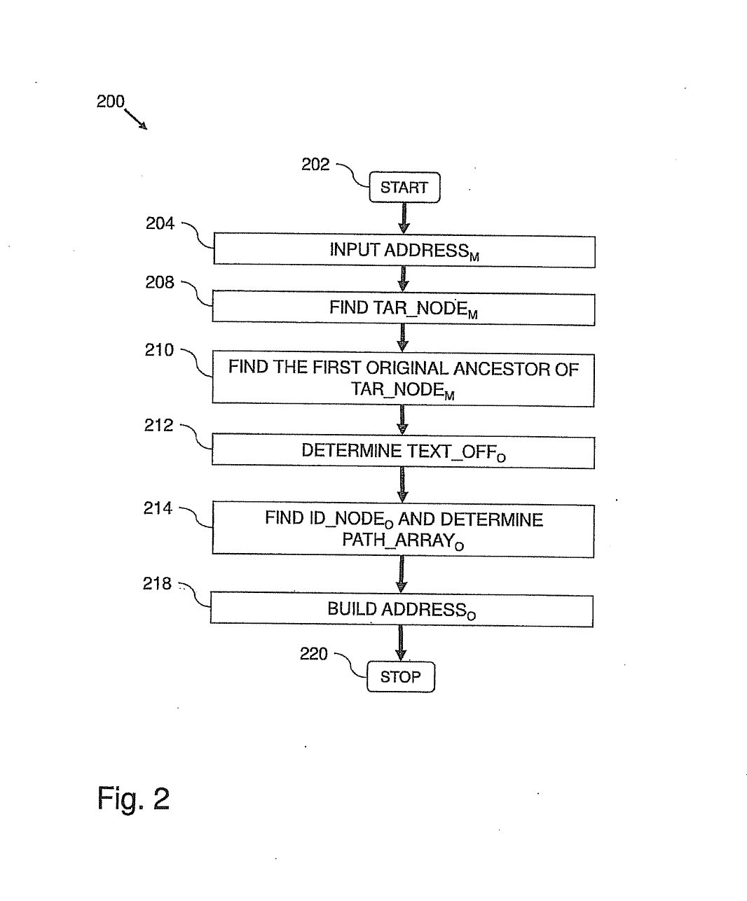

The processing method 200 may receive a modified address 104 and, in light of a modified tree-based structure 108, produce an original address 112. The processing method 200 may be described in greater detail hereinafter with reference to FIG. 2 and elsewhere.

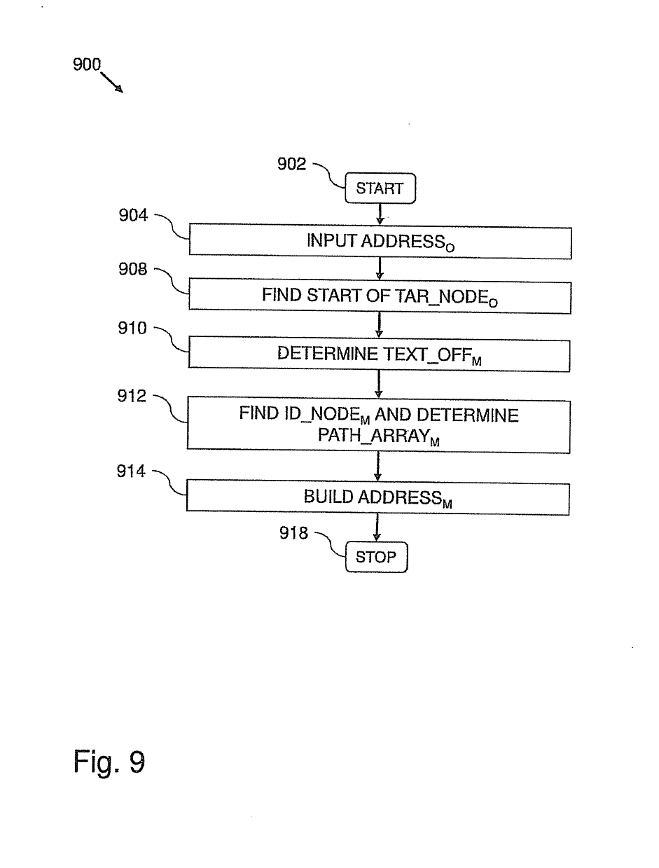

The processing method 900 may receive an original address 112 and, in light of a modified tree-based structure 108, produce the modified address 104. The processing method 900 may be described in greater detail hereinafter with reference to FIG. 9 and elsewhere.

FIG. 9 depicts a method of locating an original address 112 as a modified address 104 in a modified tree-based structure 108. In some embodiments, the information processor 102 may employ this method 900 when inserting information into a modified tree-based structure 108. For example and without limitation, the information may contain any number of annotations to be applied to the original tree-based structure. Each of these annotations may be associated with an address 112 in the original tree-based structure. The modified tree-based structure 108 may begin as the original tree-based structure and then be modified as the annotations are inserted. In order to insert successive annotations, it may be necessary to locate an original address 112 as a modified address 104 in the modified tree-based structure 108, as contemplated in the method 900 described below.

A tree-based structure may begin as an original tree-based structure and become the modified tree-based structure 108 when modifications are applied to the original tree-based structure. In the case where no modifications have yet been applied to a tree-based structure, it's modified and original states are equivalent. A tree-based structure is considered modified when it differs in state relative to the original tree-based structure, regardless of when or how a modification resulting in such differed state may have been applied.

An address is considered original when it is relative to an original (i.e., unmodified) tree-based structure. An address is considered modified when it is relative to a modified tree-based structure, regardless of when or how the original tree-based structure became modified. Hence, a modified address 104 need not be considered modified due to the application of any particular modification, whether to the address or to the tree-based structure. Instead, it may be considered modified simply because it is relative to a modified version of the tree-based structure. As such, all addresses relative to a modified tree-based structure 108 may be labeled “modified addresses,” notwithstanding that such addresses may not have themselves been modified.

For a given modified tree-based structure 108, a modified address 104 for a position, item or node of interest may be or may be equivalent to an original address 112 for the position, item or node, such as in the case where no modification has been made to the original tree-based structure. Also, for a given modified tree-based structure 108, a modified address 104 for a position, item or node of interest may be or may be equivalent to an original address 112 for the position, item or node in the case where a modification relative to the original tree-based structure has not disturbed the location of the position, item or node within the modified tree-based structure 108.

In practice, the methods and systems disclosed herein are applied relative to the current state of the modified tree-based structure 108.

It should be noted that an information processor 102 may, as described more particularly below, include various software, hardware, services and other information technology components, configured to enable the methods and systems of the addressing schema disclosed throughout this disclosure; thus, boundaries indicated in FIG. 1 should be understood as illustrating one of many possible embodiments of the information processor 102. In other embodiments, information processor 102 may store any items of information and execute or support any methods disclosed in this disclosure; conversely, items such as modified addresses 104 need not necessarily be stored in information processor 102, as such addresses 104 may not be needed in order to effectuate the methods and systems described herein.

In some embodiments, an application including the information processor 102 may have produced the modified tree-based structure 108. For example and without limitation, the modified tree-based structure 108 may represent a web document into which one or more annotations have been incorporated by the application.

The information processor 102 may be a component of an application. In some embodiments, the application may include a server-side application. In some embodiments, the application may include a web server providing a web page embodying the modified tree-based structure 108. In some embodiments, the application may include a client-side application. In some embodiments, the application may include a client program receiving input from a user interface, displaying an image representing a document defined by the modified tree-based structure 108, and altering the modified tree-based structure 108 in response to the input.

In some embodiments, the application may include a client-server or peer-to-peer application. For example and without limitation, the modified tree-based structure 108 and original tree-based structure and at least some of the original addresses 112 may reside on a remote computer. During operation of the application on a local computer, some or all of the modified tree-based structure 108 and original tree-based structure and original addresses 112 on the remote computer may be accessed.

In some embodiments, a computer program product may embody the application. In some embodiments, the computer program product may be downloaded to a web client (e.g., an Internet browser or other client device or application capable of consuming web services or using web-based applications) as part of or in association with a webpage, such as to enable tracking of annotations to a webpage. In some embodiments, the computer program product may be downloaded to a web client as a plug-in, module, dynamically linked library, or the like. Such embodiments may function substantially like the aforementioned client or client-side application, including, without limitation, to allow annotation functionality, such as allowing visitors to or users of a web page to annotate the page. In some embodiments, the functionality of the information processor 102 may be provided as part of or in connection with an applet, script, bookmark, toolbar, bookmarklet, or similar element available in connection with a web browser or document-processing program. In some embodiments, the annotation functionality may be called via, for example, JavaScript, such as by interaction of a user with a web browser toolbar, bookmark or bookmarklet.

In some embodiments, the application may provide a user interface for allowing a user to make an annotation to a document. The user interface may allow the user to select a point or region in the document, select an annotation, and apply the annotation to the point or region. Applying the annotation may include altering a modified tree-based structure 108 so that another modified tree-based structure 108 represents the document with the annotation. In conjunction with applying the annotation, the method 200 may be employed to calculate the original address 112 of the annotation. In some embodiments, the original address 112 may be stored for later use. It will be understood that a variety of such applications providing user interfaces are possible.

In some embodiments, the application may provide a user interface allowing a user to select an annotation already in the document and remove the annotation. Removing the annotation may include recreating a modified tree-based structure 108 without the removed annotation. In conjunction with recreating the modified tree-based structure 108, the original addresses 112 associated with the removed annotation may be discarded; the method 900 may utilize each of the remaining original addresses 112 to calculate modified addresses 104; and the modified addresses 104 may be used to re-apply the remaining annotations. This may be described in greater detail hereinafter with reference to FIGS. 22-27 and elsewhere. It will be understood that a variety of such applications providing user interfaces are possible.

In some embodiments, the application may allow a plurality of overlapping annotations to the document. In some embodiments, the application may apply a dominance rule indicating which of the overlapping annotations to apply and/or in which order to apply the annotations.

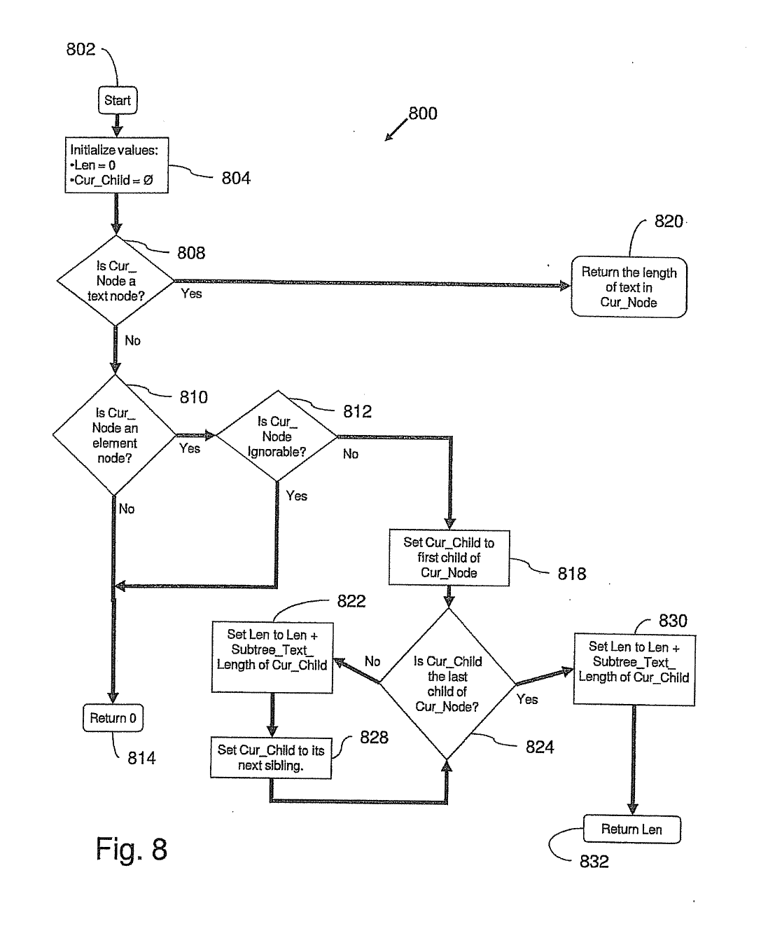

Referring generally to the Figures: A target node (Tar_Node) may be a node of interest in a tree-based structure. A target position (Tar_Pos) may be a position of an item of interest within a target node. A node containing a target position may be a target node. A text node (Text_Node) may be a target node containing text. If a target position is in a text node, that text node may be a target text node (Tar_Text_Node). If a target node is a text node, the target position may be a target text position (Tar_Text_Pos), which may be the position of a character of interest within the target text node. A reference node (Ref_Node) may be any node being used as a reference in a tree-based structure. An identifiable node (Id_Node) may be a target node's closest direct ancestor node having a unique identifier. When no such direct ancestor node exists, the Id_Node may be a root node or other directly accessible, established node. A reference node identifier (Ref_Node_ID) may be an identifier of a reference node. An identifiable node identifier (Id_Node_ID) may be an identifier of an identifiable node. An identifiable-node-to-target-node path (Path) may be a path through a tree-based structure from an identifiable node to a target node. An identifiable-node-to-target-node-path array (Path_Array) may be a data structure encoding a path through a tree-based structure, the path starting at an identifiable node and ending at a target node. In some embodiments, the Path_Array may include an ordered set of child indexes. It will be understood that a variety of embodiments of the Path_Array are possible. A text offset (Text_Off) may be an index of a target text position into a target node that is a target text node. If the target node is not a text node, the text offset may be an index of a target position or target item position into the target node. An index (Ind) may be a child index. An identifiable-node-to-target-node-path-array counter (Path_Array_Counter) may be a counter or simply an integer variable. An original node position counter (Orig_Node_Counter) may be a counter or simply an integer variable. A track node (Track_Node) may be a pointer or reference to a node. Path indices (Path_Indices) may be an integer array or the like containing child indexes. An offset counter (Off_Counter) may be a counter or simply an integer variable. A subtree text length (Subtree_Text_Length) may be a count of all original characters within all original text within a specified node and its descendents. In some embodiments, this count may be calculated and returned by a subtree text length method, described hereinafter with reference to FIG. 8 and elsewhere. A current node (Cur_Node) may be a pointer or a reference to a node. In some embodiments, a node may be passed to the sub-tree text length method. A current child (Cur_Child) may be a node pointer to a child node of the current node. A string length (Len) may be the length of a string (e.g., the number of characters in the string).

An address may be a location of a target position within a tree-based structure. In some embodiments, the address may include a 3-tuple having the components Id_Node_ID, Path_Array, and Text_Off. Throughout this disclosure and elsewhere, an address may be represented as {Id_Node_ID, [Path_Array], Text_Off} or the like.

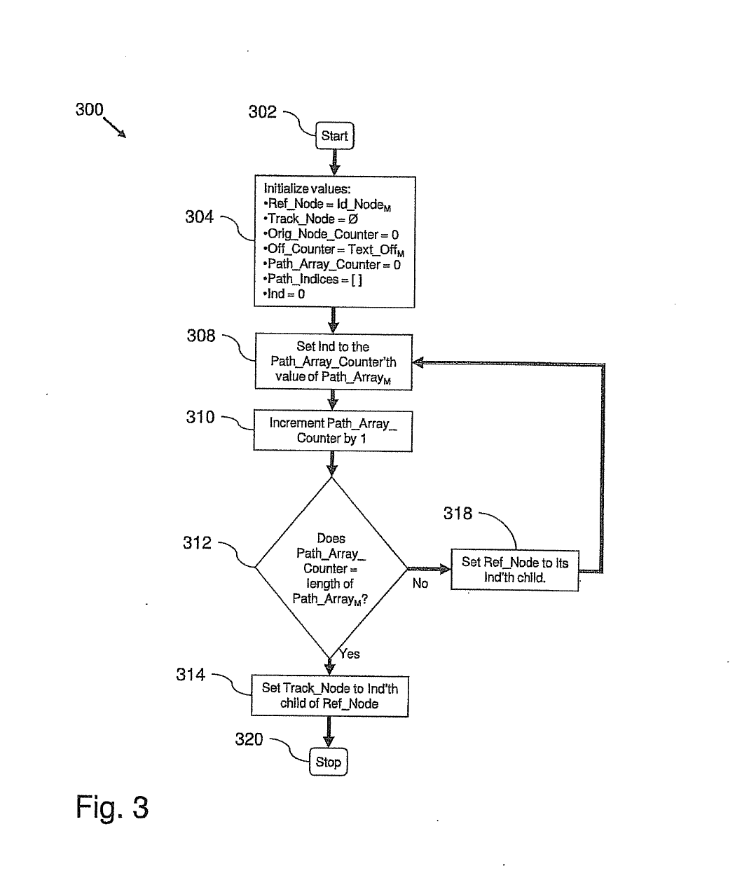

FIG. 2 depicts a method of converting a modified address 104 into an original address 112. In some embodiments, this method may be used to determine and store the original address 112 equivalent of a position located in the current state of a modified tree-based structure 108 by a modified address 104. In some embodiments, this method may be used to_accurately locate the position of an annotation relative to an original tree-based data structure capable of defining a document. Beginning at step 202, the method 200 may retrieve or receive a modified address 104 at step 204. The modified Tar_Node may be found as shown by step 208. In some embodiments, this includes, in the current state of the modified tree-based structure 108, finding the modified Tar_Node (e.g., by finding the start of such modified Tar_Node). The first original ancestor of the modified Tar_Node may be found as shown by step 210. In some embodiments, this includes, in the current state of the modified tree-based structure 108, finding the first ancestor of Tar_Node that also exists in the original tree-based structure. An original Text_Off may be determined as shown by step 212. In some embodiments, this includes, in the current state of the modified tree-based structure 108, determining the character count from the start of the first node in the current state of the modified tree-based structure that was a part of the same node as Tar_Node in the original tree-based structure to the target position Tar_Pos. An original Id_Node may be found and an original Path_Array may be determined as shown by step 214. In some embodiments, this includes, in the current state of the modified tree-based structure 108, finding the first identifiable ancestor of Tar_Node in the current state of the modified tree-based structure that also exists in the original tree-based structure, and determining the path in the original tree-based structure from the first identifiable ancestor to Tar_Node in the original tree-based structure. The original address may be built as shown by step 218. In some embodiments, the original address may be the original address 112 relative to the original tree-based structure. The method 200 may end at step 220. The method 200 may be understood with reference to the FIGS. 3-7, which respectively describe in detail the steps 208, 210, 212, 214, and 218.

In some embodiments, the modified address 104 may include an identifier of the modified identifiable node (modified Id_Node_ID), the modified path array (modified Path_Array), and an offset or index into the modified target node (modified Text_Off). In some embodiments, an identifier may be dynamically generated and assigned to a modified node.

FIG. 3 depicts a method 300 of finding the modified Tar_Node (e.g., by finding the start of such modified Tar_Node). In some embodiments, the method 300 may be employed at step 208.

Beginning at step 302, the method 300 may initialize a number of values as shown by step 304. The Ref_Node may be equal to the modified Id_Node, the Track_Node may be set to null, the Orig_Node_Counter may be set to zero, the Off_Counter may be set to the modified Text_Off, the Path_Array_Counter may be set to zero, the Path_Indices may be set to the empty set, and Ind may be set to zero.

In step 308, Ind may be set to the Path_Array_Counter'th value of the modified Path_Array.

In step 310, the Path_Array_Counter may be incremented by one.

In step 312, a test determines whether the Path_Array_Counter equals the length of the modified Path_Array. In the case of a negative result, the Ref_Node may be set to its Ind'th child as shown in step 318. Otherwise, the Track_Node may be set to the Ind'th child of the Ref_Node as shown in step 314. The method 300 may stop as shown in step 320.

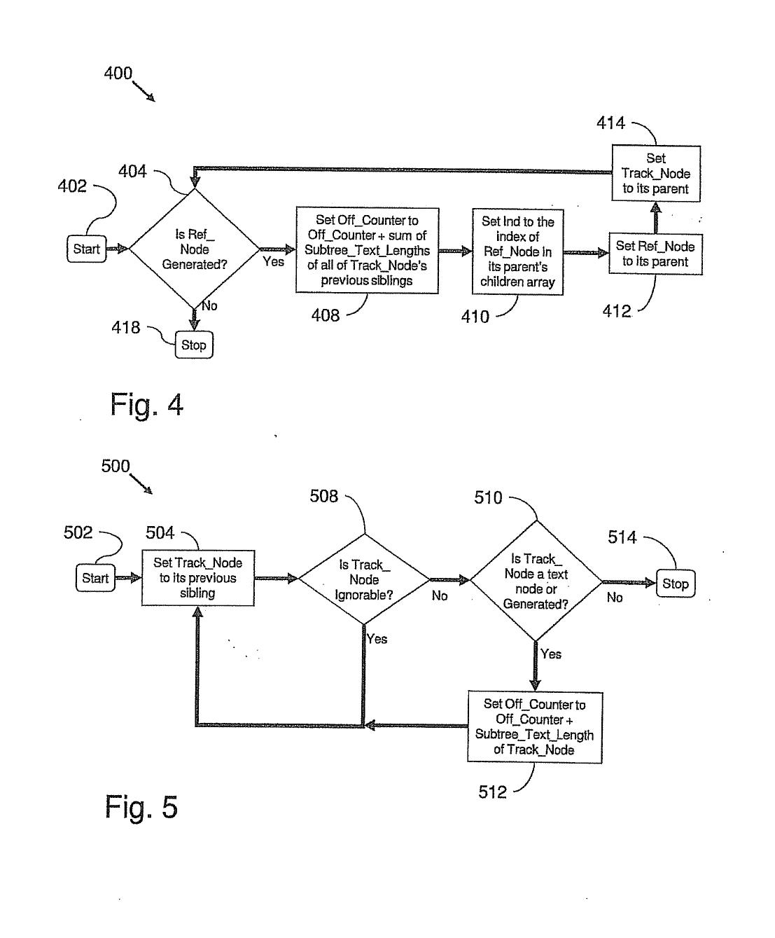

FIG. 4 depicts a method 400 of finding the first original ancestor of the modified Tar_Node. In some embodiments, the method 400 may be employed at step 210. Beginning at step 402, the method 400 may test whether the Ref_Node is generated as shown in step 404. In the case of a negative result, the method 400 ends as shown in step 418. Otherwise, the Off_Counter may be set to Off_Counter plus a sum of Subtree_Text_Lengths of all of the Track_Node's previous siblings as shown in step 408. Then, the Ind may be set to the index of Ref_Node in its parent's children array as shown in step 410. Next, the Ref_Node may be set to be its parent as shown in step 412. Next, the Track_Node may be set to its parent as shown in step 414. From there, processing may continue back to step 404.

FIG. 5 depicts a method of determining the original text offset. In some embodiments, the method 500 may be employed at step 212. Beginning at step 502, the method 500 may set the Track_Node to its previous sibling as shown in step 504. Then a test determines whether the Track_Node is ignorable as shown in step 508. If the test results in an affirmative result, the method 500 may return to step 504. Otherwise, a test may determine whether the Track_Node is a text node or a generated node as shown by step 510. When the result of this test is affirmative, the method 500 may first set the Off_Counter to Off_Counter plus the Subtree_Text_Length of the Track_Node as shown by step 512 and then return to step 504. Otherwise, the method may stop as shown by step 514.

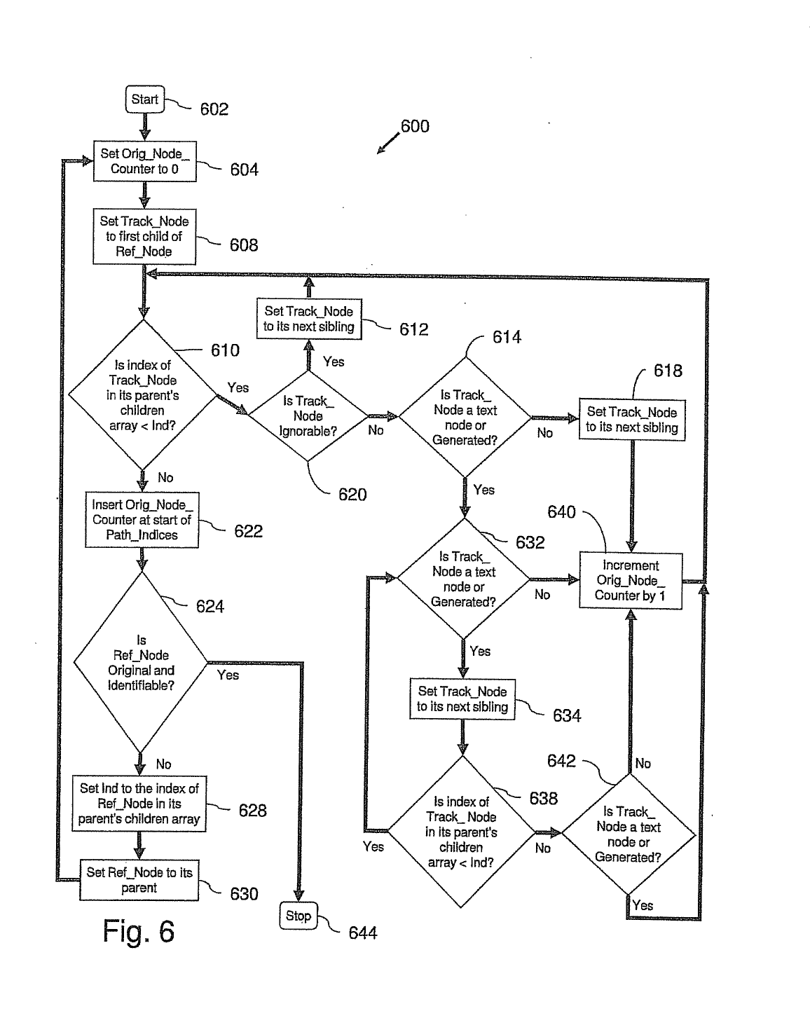

FIG. 6 depicts a method of finding the original Id_Node and determining the original Path_Array. In some embodiments, the method may be employed at step 214. Beginning at step 602, the method 600 may set the Orig_Node_Counter to zero as shown by step 604. The Track_Node may be set to the first child of the Ref_Node as shown by step 608. A test at step 610 may determine whether the index of the Track_Node in its parent's children array is less than Ind. When the result of this test is affirmative, the method 600 may continue to step 620. Otherwise, the method may continue to step 622.

At step 620, a test may determine whether the Track_Node is ignorable. If it is, the Track_Node may be set to its next sibling as shown in step 612. From there, the method 600 may return to step 610. However, if the Track_Node is not ignorable, then a test may determine whether the Track_Node is a text node or a generated node as shown by step 614. When the result of this test is affirmative, the method 600 may continue to a test shown by step 632. Otherwise, the method 600 may continue to step 618.

At step 618, Track_Node may be set to its next sibling. Then, the Orig_Node_Counter may be incremented by one as shown by step 640. From there, the process 600 may return to step 610.

At step 632, a test may determine whether the Track_Node is a text node or a generated node. When the result of this test is negative, the method 600 may proceed to step 640. Otherwise, the Track_Node may be set to its next sibling as shown by step 634. A test may then determine whether the index of Track_Node in its parent's children array is less than Ind as shown by step 638. If it is, the method 600 may return to step 632. Otherwise, the method may continue to step 642, where a test determines whether the Track_Node is a text node or a generated node. If this test results in an affirmative result, then the method 600 may return to step 610. Otherwise, the method 600 may continue to step 640.

At step 622, The Orig_Node_Counter may be prepended to the Path_Indices. A test may determine whether the Ref_Node is original and identifiable as shown by step 624. If it is, the method may stop as shown by step 644. Otherwise, the Ind may be set to the index of Ref_Node in its parent's children array as shown by step 628. The Ref_Node may then be set to its parent as shown by step 630. From there, the method 600 may return to step 604.

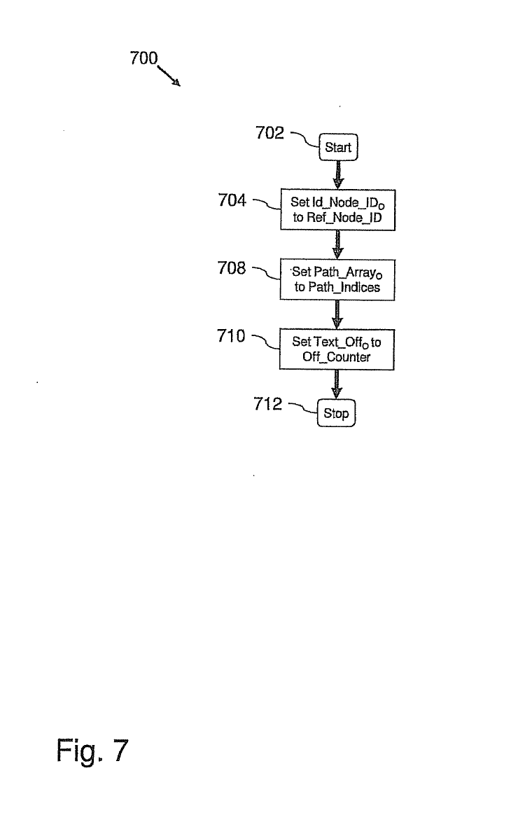

FIG. 7 depicts a method of building an original address 112. In some embodiments, the method may be employed at step 218. Beginning at step 702, the method may set an original Id_Node_ID to the Ref_Node_ID as shown by step 704. An original Path_Array may be set to the Path_Indices as shown by step 708. An original Text_Off may be set to the Off_Counter as shown by step 710. The method 700 may end at step 712. In some embodiments, the original address 112 may include the original Id_Node_ID, the original Path_Array, and the original Text_Off.

FIG. 8 depicts a method of determining a text length of the sub-tree rooted at the current node of interest Cur_Node at the point that the method 800 is applied. In other words, the text length may be the length of all original text that is contained within the Cur_Node and its descendents. This method 800 may be referred to herein and elsewhere as Subtree_Text_Length. Beginning at step 802, the method 800 may initialize the Len to zero and the Cur_Child to null as shown in step 804. A test may then determine whether the Cur_Node is a text node as shown in step 808. If the test produces an affirmative result, the length of text in the Cur_Node may be returned as shown by step 820. Otherwise, a test may determine whether the Cur_Node is an element node as shown by step 810. In this context, an element node is a node such as an HTML DIV or SPAN element capable of containing text that may be included in the text length being determined herein. If the test results in a negative result, the method 800 may return zero as shown by step 814. Otherwise, a test may determine whether the Cur_Node is ignorable as shown by step 812. If the test produces an affirmative result, the method 800 may proceed to step 814. Otherwise, the Cur_Child may be set to the first child of the Cur_Node as shown by step 818.

A test may determine whether the Cur_Child is the last child of Cur_Node as shown by step 824. If the test produces an affirmative result, the Len may be set to Len plus Subtree_Text_Length of the Cur_Child and then Len may be returned, as shown by steps 830 and 832 respectively. Otherwise, Len may be set to Len plus Subtree_Text_Length of the Cur_Child as shown by step 822. The Cur_Child may then be set to its next sibling as shown by step 828. The method 800 may then return to step 824.

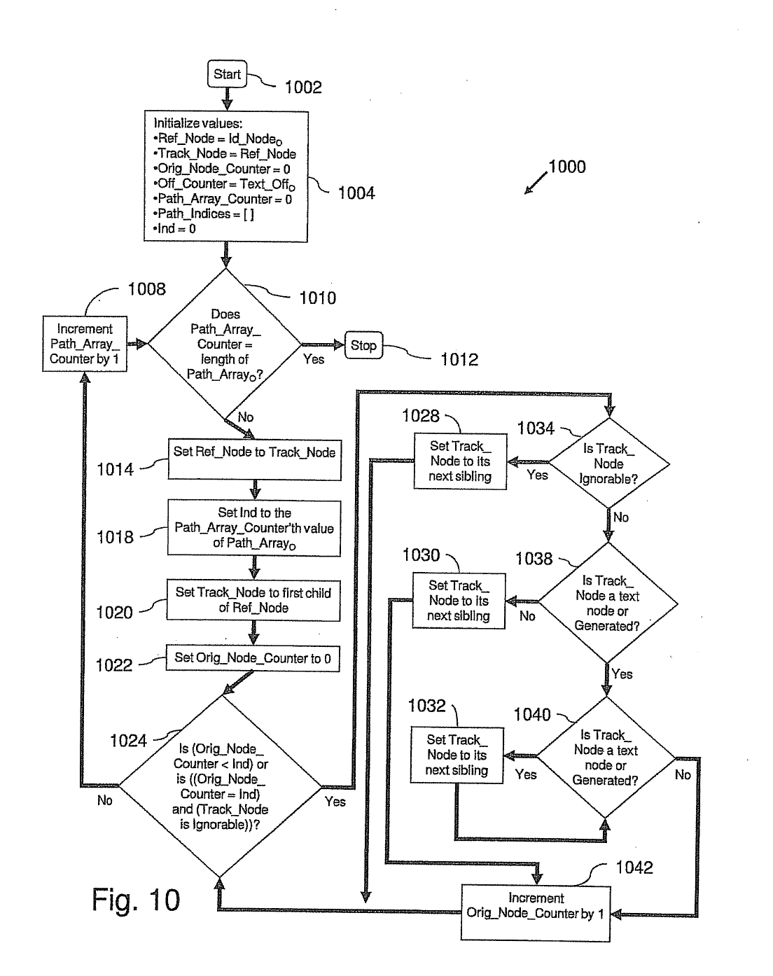

FIG. 9 depicts a method of converting an original address 112 into a modified address 104. In some embodiments, this method may be used to locate a modified address 104 in the current state of the modified tree-based structure 108 that corresponds to the original address 112 in the original tree-based structure. In some embodiments, this method may be used to_accurately locate and insert an annotation into the current state of a modified tree-based structure 108 capable of defining a document. Beginning at step 902, the method 900 may retrieve or receive an original address 112 at step 904. The original Tar_Node's start may be found as shown by step 908. In some embodiments, this includes, in the current state of the modified tree-based structure 108, finding the start of the first node that was a part of the same node as Tar_Node in the original tree-based structure. The modified Text_Off may be determined as shown by step 910. In some embodiments, this includes, in the current state of the modified tree-based structure 108, determining the character count from the start of Tar_Node in the current state of the modified tree-based structure 108 to the target position Tar_Pos. The modified Id_Node may be found and the modified Path_Array may be determined as shown by step 912. In some embodiments, this includes, in the current state of the modified tree-based structure 108, finding the first identifiable node that is an ancestor of Tar_Node and determining the path from such first identifiable node to Tar_Node. The modified address may be built as shown by step 914. In some embodiments, the modified address may be the modified address 104 address in the current state of the modified tree-based structure 108. The method 900 may end at step 918. The method 900 may be understood with reference to the FIGS. 10-13, which respectively describe in detail the steps 908, 910, 912, and 914.

In some embodiments, the original address 112 may include an original Id_Node_ID, an original Path_Array, and an original Text_Off.

FIG. 10 depicts a method of finding the original Tar_Node's start in the modified tree-based structure. In some embodiments, this method may be employed at step 908. Starting at step 1002, the method 1000 may initialize a number of values at step 1004 as follows: Ref_Node may be equal to the original Id_Node; Track_Node may be equal to Ref_Node; Orig_Node_Counter may be set to zero; Off_Counter may be set to the original Text_Off; Path_Array_Counter may be set to zero; Path_Indices may be set to the empty set; and Ind may be set to zero.

A test may determine whether Path_Array_Counter equals the length of the original Path_Array as shown by step 1010. Original Path_Array may be the Path_Array component of the original address provided in step 904. If the test produces an affirmative result, the method 1000 may end as shown by step 1012. Otherwise, the Ref_Node may be set to the Track_Node, the Ind may be set to the Path_Array_Counter'th value of the original Path_Array, the Track_Node may be set to the first child of the Ref_Node, and the Orig_Node_Counter may be set to zero as respectively shown by steps 1014, 1018, 1020, and 1022.

After step 1022, a test may determine whether the Orig_Node_Counter is less than Ind or whether both the Orig_Node_Counter equals Ind and the Track_Node is ignorable. If the test results in a negative result, the method 1000 may increment the Path_Array_Counter by one and then return to step 1010, as shown by step 1008. Otherwise, a test may determine whether the Track_Node is ignorable as shown by step 1034. Upon an affirmative result of the test, the Track_Node may be set to its next sibling and then the method 1000 may return to step 1024, as shown by step 1028. Otherwise, a test may determine whether the Track_Node is a text node or a generated node as shown by step 1038. If this test produces a negative result, the Track_Node may be set to its next sibling and the Orig_Node_Counter may be incremented by one as respectively shown by steps 1030 and 1042. Otherwise, a test may determine whether the Track_Node is a text node or a generated node as shown by step 1040. If the result of this test is affirmative, the Track_Node may be set to its next sibling and then return to step 1040, as shown by step 1032. Otherwise, the method 1000 may proceed to step 1042. In any case, from step 1042 the method may return to step 1024.

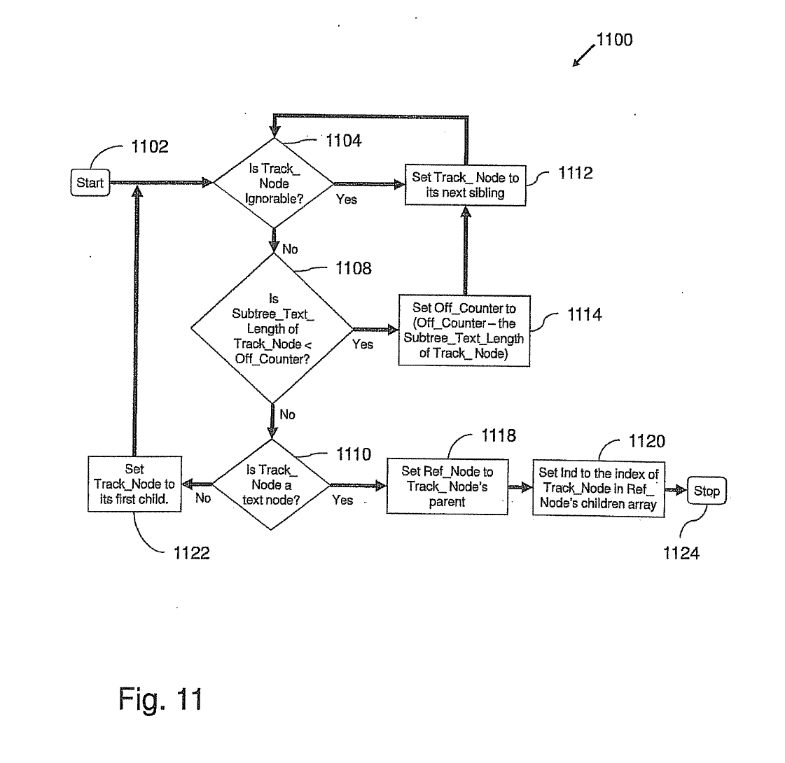

FIG. 11 depicts a method of determining a modified Text_Off. In some embodiments, this method 1100 may be employed at step 910. Beginning at step 1102, the method 1100 may test whether the Track_Node is ignorable as shown by step 1104. If this test produces an affirmative result, the Track_Node may be set to its next sibling and then return to step 1104, as shown by step 1112. Otherwise, a test may determine whether the Subtree_Text_Length of the Track_Node is less than the Off_Counter as shown by step 1108. If this test produces an affirmative result, the Off_Counter may be set to the Off_Counter minus the Subtree_Text_Length of the Track_Node as shown by step 1114, after which the method 1100 would proceed to the step 1112. Otherwise, a test may determine whether the Track_Node is a text node as shown by step 1110. If this test produces a negative result, the Track_Node may be set to its first child and then the method may return to step 1104, as shown by step 1122. Otherwise, the Ref_Node may be set to the Track_Node's parent; the Ind may be set to the index of the Track_Node in the Ref_Node's children array; and the method 1100 may end as respectively shown by steps 1118, 1120, and 1124.

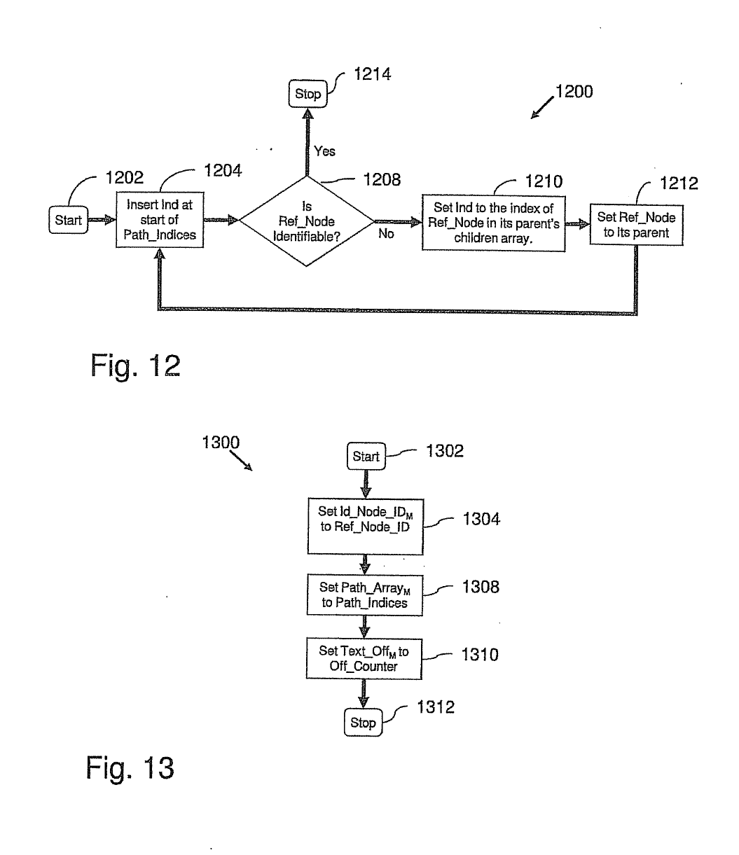

FIG. 12 depicts a method of finding a modified Id_Node and determining a modified Path_Array. In some embodiments, this method 1200 may be employed at step 912. Beginning at step 1202, the method 1200 may prepend Ind to the Path_Indices as shown by step 1204. Then, a test may determine whether the Ref_Node is identifiable as shown by step 1208. If this test produces an affirmative result, the method 1200 may end as shown by step 1214. Otherwise, the Ind may be set to the index of Ref_Node in its parent's children array; the Ref_Node may be set to its parent; and the method 1200 may return to step 1204, as respectively shown by steps 1210 and 1212.

FIG. 13 depicts a method of building a modified address. In some embodiments, this method 1300 may be employed at step 914. Beginning at step 1302, the method 1300 may set a modified Id_Node_ID to the Ref_Node_ID, the modified Path_Array to the Path_Indices, and the modified Text_Off to the Off_Counter, as respectively shown in steps 1304, 1308, and 1310. The method 1300 may end at step 1312.

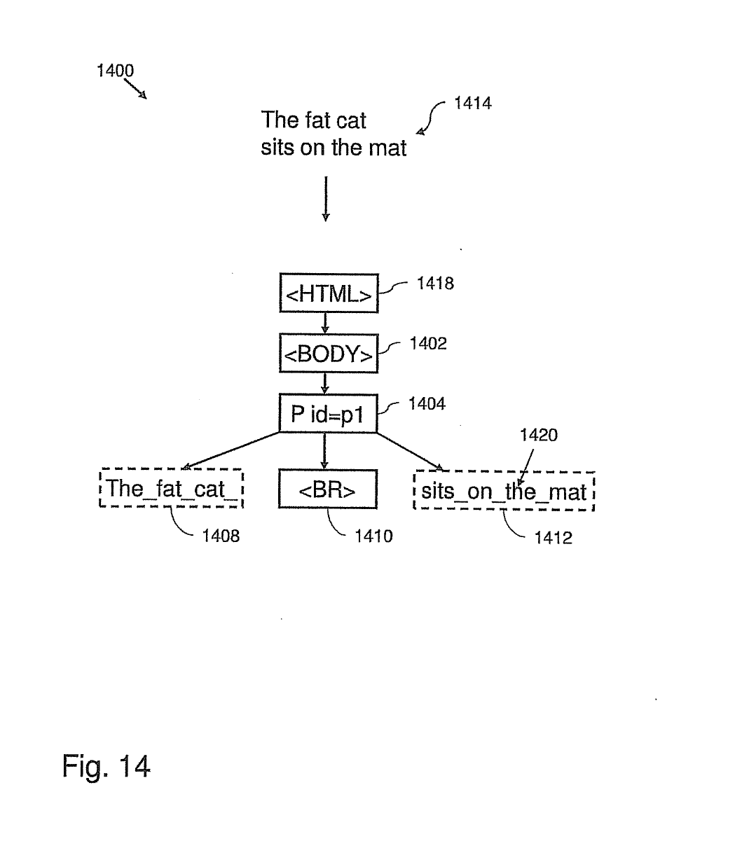

FIG. 14 depicts text encoded in a DOM. In this and other figures, an underscore may be used in text strings to indicate the location of a space.

The text 1414 (“The fat cat<br />sits on the mat”) may be an excerpt from an HTML-based web document. The DOM may include an HTML element 1418 containing a body element 1402 with a paragraph element P 1404 as a child. The paragraph element P 1404 may have an identifier that is ‘p1’ and three children. The three children may include a text node 1408 containing “The fat cat”, a break element 1410, and a text node 1412 containing the text “sits on the mat”. An original target position 1420 may coincide with the letter ‘h’ in the text node 1412.

For example and without limitation, this DOM may be an original tree-based structure and the target position 1420 may be an original target position Tar_Pos.

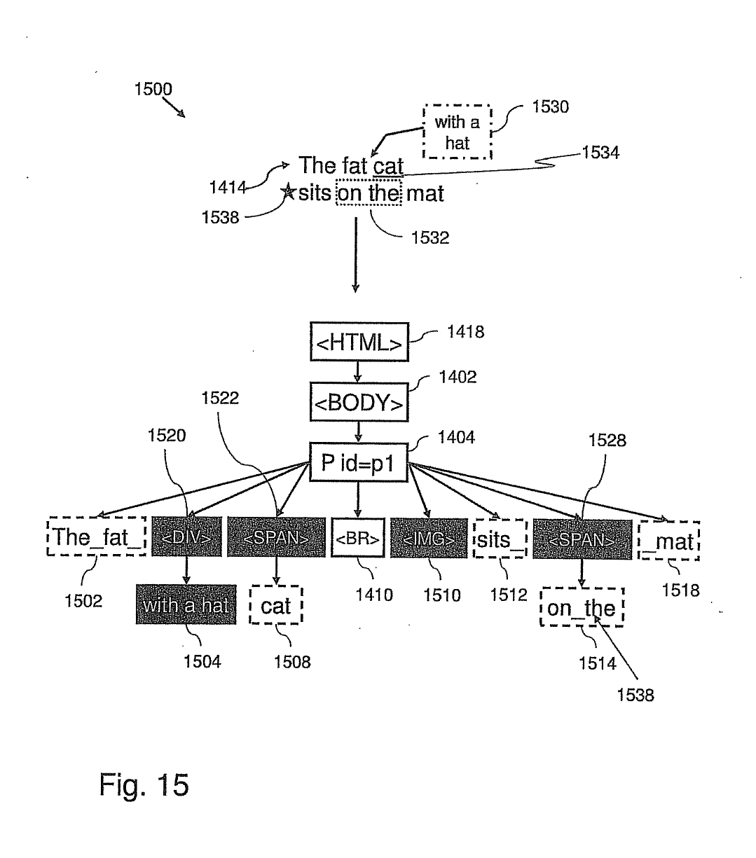

FIG. 15 depicts text encoded in a DOM. Here, the text 1414 may be an excerpt from an HTML-based web document that contains annotations. The annotations may include a note 1530, an underline 1534, a highlight 1532, and an image 1538.

The DOM may include the HTML element 1418 containing the body element 1402 having the paragraph element 1404. The paragraph element 1404 may have eight children, which are: a text node 1502, an ignorable generated DIV node 1520, a generated SPAN node 1522, the break element 1410, an ignorable generated image node 1510, a text node 1512, a generated SPAN node 1528, and a text node 1518. The ignorable generated DIV node 1520 may have one child that is an ignorable generated text node 1504. A modified target position 1538 may coincide with the letter ‘h’ in the text element 1514. It will be understood that this DOM may encode an HTML-based web document containing the text 1414 with the annotations.

Both the original target position 1420 and the modified target position 1538 may coincide with the letter ‘h’ in the string ‘on the mat’. In some embodiments, the original target position 1420 may be encoded as the original address {‘p1’, [2], 9}, which may be read as follows: the 10^{th} item in the 3^{rd} child of the node identified as ‘p1’. In some embodiments, the modified target position 1538 may be encoded as the modified address {‘p1’, [6,0], 4}, which may be read as follows: the 5^{th} item in the 1^{st} child of the 7^{th} child of the node identified as ‘p1’. It will be understood that a variety of embodiments of the addresses are possible.

In some embodiments, the modified tree-based structure 108 may be the DOM with annotations of FIG. 15 and the modified address 104 may indicate the modified target position 1538. The information processor 102 may receive the modified target position 1538 as a modified address, apply the processing method 200 of FIG. 2, and produce the original address 112.

The following discussion may provide a walk-through example usage of the methods described hereinabove with reference to FIG. 2, FIG. 9, and elsewhere.

Referring again to FIG. 2, the method 200 may begin and step 202 and then continue to step 204 where the modified address {‘p1’, [6,0], 4} as Address_{M} (i.e., modified address 104) is received.

Referring again to FIG. 3, at step 304: The Ref_Node may be initialized to the identifiable node Id_Node_{M}, which in this case is paragraph element P 1404. Track_Node may be initialized to null. Orig_Node_Counter, Path_Array_Counter, and Ind may be initialized to 0. Off_Counter may be initialized to Text_Off_{M}, which is 4. Path_Indices may be initialized to an empty set.

At this point, the following variables have the following values: Ref_Node: P; Track_Node: null; Orig_Node_Counter: 0; Ind: 0; Path_Array_Counter: 0; Off_Counter: 4; and Path_Indices: [ ].

At step 308 Ind is set to the Path_Array_Counter'th value of the Path_Array_{M}, Path_Array_{M} being the second component of the modified address {‘p1’, [6,0], 4}. The 0^{th} element of array [6,0] is 6, so Ind is set to 6.

At step 310 Path_Array_Counter is incremented by 1, so Path_Array_Counter is now 1.

At step 312 the test “is Path_Array_Counter equal to the length of array Path_Array_{M}” produces a negative result because the array length is 2.

Branching to step 318, Ref_Node is set to its Ind'th child. Looking at the children of P, SPAN 1528 is the 6^{th} child (zero based).

At this point, the following variables have the following values: Ref_Node: SPAN 1528; Track_Node: null; Orig_Node_Counter: 0; Ind: 6; Path_Array_Counter: 1; Off_Counter: 4; and Path_Indices: [ ].

Returning to step 308, Ind is set to the Path_Array_Counter'th value in Path_Array_{M}, so Ind is now 0 since 0 is in position 1 of the array [6,0].

Again at step 310, Path_Array_Counter is incremented by 1, making it 2.

At step 312 the test “Is Path_Array_Counter equal to the length of array Path_Array_{M}?”, produces an affirmative result because Path_Array_Counter is 2, which is the length of the array [6,0].

Branching to step 314, Track_Node is set to be the Ind'th child of Ref_Node, which is the 0^{th} child under SPAN 1528, which is the text node “on the”.

Referring again to FIG. 4, at step 402, the following variables have the following values: Ref_Node: SPAN 1528; Track_Node: text node “on the”; Orig_Node_Counter: 0; Ind: 0; Path_Array_Counter: 2; Off_Counter: 4; and Path_Indices: [ ].

At step 404, the test “Is Ref_Node a generated node?” produces an affirmative result.

Branching to step 408, Off_Counter is set to be Off_Counter plus the sum of the Subtree_Text_Lengths of all of Track_Node's previous siblings. Since Track_Node has no previous siblings, Off_Counter remains 4.

At step 410, Ind is set to be the index of Ref_Node in its parent's children array. Because Ref_Node (currently SPAN 1528) is the 6^{th} child of its parent P 1404 (using zero-based indexing), Ind is now 6.

At step 412, Ref_Node is set to be its parent. So, Ref_Node is now the P 1404 element.

At step 414, Track_Node is set to be its parent. So, Track_Node is now the SPAN 1528 element.

Returning to step 404, the test “Is Ref_Node a generated node?” produces a negative result since Ref_Node is the P 1404 element, which is an original element appearing in the original tree-based structure.

Branching to step 418, the method 400 stops.

Referring again to FIG. 5, at step 502, the following variables have the following values: Ref_Node: P 1404; Track_Node: SPAN 1528; Orig_Node_Counter: 0; Ind: 6; Path_Array_Counter: 2; Off_Counter: 4; and Path_Indices: [ ]

At step 504, Track_Node is set to be its previous sibling. So, Track_Node is now the text node “sits” 1512.

At step 508, the test “Is Track_Node ignorable?” produces a negative result.

Branching to step 510, the test “Is Track_Node a text node or Generated?” produces an affirmative result.

Branching to step 512, the Off_Counter is set to Off_Counter+Subtree_Text_Length of Track_Node.

Referring to FIG. 8, to compute the Subtree_Text_Length of Track_Node, method 800 may be applied to Track_Node.

At step 802, Cur_Node is initialized to be Track_Node since Track_Node is the current node of interest, Len is set to 0, and Cur_Child is set to null.

At step 808, the test “Is Cur_Node a text node?” produces an affirmative result because the current value of Track_Node is the text node “sits” 1512.

Branching to step 820, the length of the text in Cur_Node (i.e., 5) is returned. Thus, the Subtree_Text_Length of Track_Node is 5.

Referring again to FIG. 5, at step 512 Off_Counter is set to 9 since 4 plus 5 equals 9.

At this point, the following variables have the following values: Ref_Node: P 1404; Track_Node: text node “sits” 1512; Orig_Node_Counter: 0; Ind: 6; Path_Array_Counter: 2; Off_Counter: 9; Path_Indices: [ ]

Returning to step 504, Track_Node is set to be its previous sibling, which makes Track_Node the element IMG 1510.

At step 508, the test “Is Track_Node ignorable?” produces an affirmative result.

Branching to step 504, Track_Node is set to be its previous sibling, which makes Track_Node the element BR 1410.

At step 508, the test “Is Track_Node ignorable?” produces a negative result.

Branching to step 510, the test “Is Track_Node a text node or Generated?” produces a negative result.

Branching to step 514, the method 500 stops.

Referring again to FIG. 6, at step 602, the following variables have the following values: Ref_Node: P 1404; Track_Node: BR 1410; Orig_Node_Counter: 0; Ind: 6; Path_Array_Counter: 2; Off_Counter: 9; Path_Indices: [ ].

At step 604, Orig_Node_Counter is set to 0.

At step 608, Track_Node is set to the first child of Ref_Node, which makes Track_Node the text node “The fat” 1502.

At step 610, the test “Is index of Track_Node in its parent's children array less than Ind?” returns an affirmative result because Track_Node's index in its parent's children array is 0 and Ind is 6.

Branching to step 620, the test “Is Track_Node ignorable?” produces a negative result.

Branching to step 614, the test “Is Track_Node a text node or Generated?” produces an affirmative result because Track_Node is a text node.

Branching to step 632, the test “Is Track_Node a text node or Generated?” produces an affirmative result.

Branching to step 634, the Track_Node is set to its next sibling, making Track_Node the element DIV 1520.

At step 638, the test “Is index of Track_Node in its parent's children array less than Ind?” produces an affirmative result because Track_Node is at index 1 of its parent's children array.

Returning to step 632, the test “Is Track_Node a text node or Generated?” produces an affirmative result because the DIV 1520 element is a generated node.

At step 634, Track_Node is set to be its next sibling, making Track_Node the element SPAN 1522.

At step 638, the test “Is index of Track_Node in its parent's children array less than Ind?” produces an affirmative result because Track_Node is at index 2 of its parent's children array.

At step 632, the test “Is Track_Node a text node or Generated?” produces an affirmative result because SPAN 1522 is a generated node.

Branching to step 634, the Track_Node is set to be its next sibling, making Track_Node the element BR 1410.

At step 638, the test “Is index of Track_Node in its parent's children array less than Ind?” produces an affirmative result because the Track_Node is at index 3 of its parent's children array.

Branching to step 632, the test “Is Track_Node a text node or Generated?” produces a negative result because the BR element 1410 is an original node.

Branching to step 640, Orig_Node_Counter is incremented by 1, making it 1.

At this point, the following variables have the following values: Ref_Node: P 1404; Track_Node: BR 1410; Orig_Node_Counter: 1; Ind: 6; Path_Array_Counter: 2; Off_Counter: 9; and Path_Indices: [ ].

Returning to step 610, the test “Is index of Track_Node in its parent's children array less than Ind?” produces an affirmative result because Track_Node is at index 3 of its parent's children array.

Branching to step 620, the test “Is Track_Node ignorable?” produces a negative result.

Branching to step 614, the test “Is Track_Node a text node or Generated?” produces a negative result.

Branching to step 618, Track_Node is set to its next sibling, which is IMG 1510.

At step 640, Orig_Node_Counter is incremented by 1, making it 2.

At this point, the following variables have the following values: Ref_Node: P 1404; Track_Node: IMG 1510; Orig_Node_Counter: 2; Ind: 6; Path_Array_Counter: 2; Off_Counter: 9; and Path_Indices: [ ].

Returning to step 610, the test “Is index of Track_Node in its parent's children array less than Ind?” produces an affirmative result because Track_Node is at index 4 of its parent's children array.

Branching to step 620, the test “Is Track_Node ignorable?” produces an affirmative result.

Branching to step 612, Track_Node is set to its next sibling, which is the text node “sits” 1512.

At this point, the following variables have the following values: Ref_Node: P 1404; Track_Node: text node “sits” 1512; Orig_Node_Counter: 2; Ind: 6; Path_Array_Counter: 2; Off_Counter: 9; and Path_Indices: [ ].

Returning to step 610, the test “Is index of Track_Node in its parent's children array less than Ind?” produces an affirmative result because Track_Node is at index 5 of its parent's children array.

Branching to step 620, the test “Is Track_Node ignorable?” produces a negative result.

Branching to step 614, the test “Is Track_Node a text node or Generated?” produces an affirmative result.

Branching to step 632, the test “Is Track_Node a text node or Generated?” produces an affirmative result.

Branching to step 634, Track_Node is set to its next sibling, making Track_Node the element SPAN 1528.

At step 638, the test “Is index of Track_Node in its parent's children array less than Ind?” produces a negative result because Track_Node is at index 6 of its parents children array.

Branching to step 642, the test “Is Track_Node a text node or Generated?” produces an affirmative result because the Track_Node is a generated node.

At this point, the following variables have the following values: Ref_Node: P 1404; Track_Node: SPAN 1528; Orig_Node_Counter: 2; Ind: 6; Path_Array_Counter: 2; Off_Counter: 9; and Path_Indices: [ ].

At step 610, the test “Is index of Track_Node in its parent's children array less than Ind?” produces a negative result.

Branching to step 622, Orig_Node_Counter is inserted at the beginning of Path_Indices, making it [2].

At step 624, the test “Is Ref_Node Original and Identifiable?” produces an affirmative result because P 1404 is original to the page and has an identifier “p1”.

Branching to step 644, the method 600 stops.

At this point, the following variables have the following values: Ref_Node: P 1404; Track_Node: SPAN 1528; Orig_Node_Counter: 2; Ind: 6; Path_Array_Counter: 2; Off_Counter: 9; and Path_Indices: [2].

Referring again to FIG. 7, the method 700 starts at 702 and continues through steps 704, 708, and 710 in which Id_Node_ID_{O} is set to Ref_Node_ID, which is “p1”; Path_Array_{O} is set to Path_Indices, which is [2]; and Text_Off_{O} is set to Off_Counter, which is 9. Thus, the original address 112 is {“p1”,[2],9}.

At step 712, the method 700 stops.

Referring again to FIG. 9, the original address {p1,[2],9} as Address_{O} (i.e., original address 112) may be input at step 904.

Referring again to FIG. 10, at step 1004 the Ref_Node is initialized to Id_Node_{O}, which is the paragraph element P 1404; Track_Node is initialized to be the same as Ref_Node and so is also P 1404; Orig_Node_Counter, Path_Array_Counter, and Ind are all initialized to 0; Off_Counter is initialized to Text_Off_{O}, which is 9, the last component of the original address, Address_{O}; and Path_Indices is initialized to an empty set.

At this point, the following variables have the following values: Ref_Node: P 1404; Track_Node: P 1404; Orig_Node_Counter: 0; Ind: 0; Path_Array_Counter: 0; Off_Counter: 9; Path_Indices: [ ].

At step 1010, the test “Does Path_Array_Counter=length of Path_Array_{O}?” produces a negative result because the Path_Array_Counter is 0 and the length of the array [2] is 1.

At step 1014, the Ref_Node is set to Track_Node and so Ref_Node remains P 1404. At step 1018, Ind is set to the Path_Array_Counter'th value of Path_Array_{O}, which is the 0th value of [2], which is 2. So, Ind is set to 2. At step 1020, Track_Node is set to the first child of Ref_Node, which makes Track_Node the text node “The fat” 1502. At step 1022, Orig_Node_Counter is set to 0.

At step 1024, the test “Is (Orig_Node_Counter less than Ind) or is ((Orig_Node_Counter equal to Ind) and (Track_Node is Ignorable))?” produces an affirmative result because Orig_Node_Counter is 0 and Ind is 2.

Branching to step 1034, the test “Is Track_Node Ignorable?” produces a negative result.

Branching to step 1038, the test “Is Track_Node a text node or Generated?” produces an affirmative result.

Branching to step 1040, the test “Is Track_Node a text node or Generated?” produces an affirmative result.

Branching to step 1032, Track_Node is set to its next sibling, making Track_Node the element DIV 1520.

Returning to step 1040, the test “Is Track_Node a text node or Generated?” produces an affirmative result.

Branching to step 1032, Track_Node is set to its next sibling, making Track_Node the element SPAN 1522.

Returning to step 1040, the test “Is Track_Node a text node or Generated?” produces an affirmative result.

Branching to step 1032, Track_Node is set to its next sibling, making Track_Node the element BR 1410.

Returning to step 1040, the test “Is Track_Node a text node or Generated?” produces a negative result.

Branching to step 1042, Orig_Node_Counter is incremented by 1, making it 1.

At this point, the following variables have the following values: Ref_Node: P 1404; Track_Node: BR 1410; Orig_Node_Counter: 1; Ind: 2; Path_Array_Counter: 0; Off_Counter: 9; and Path_Indices: [ ].

Returning to step 1024, the test “Is (Orig_Node_Counter less than Ind) or is ((Orig_Node_Counter equal to Ind) and (Track_Node is Ignorable))?” produces an affirmative result because Orig_Node_Counter is 1 and Ind is 2.

Branching to step 1034, the test “Is Track_Node Ignorable?” produces a negative result.

Branching to step 1038, the test “Is Track_Node a text node or Generated?” produces a negative result because BR 1410 is not generated.

Branching to step 1030, Track_Node is set to its next sibling, IMG 1510.

At step 1042, Orig_Node_Counter is incremented by 1, making it 2.

At this point, the following variables have the following values: Ref_Node: P 1404; Track_Node: IMG 1510; Orig_Node_Counter: 2; Ind: 2; Path_Array_Counter: 0; Off_Counter: 9; and Path_Indices: [ ].

Returning to step 1024, test “Is (Orig_Node_Counter less than Ind) or is ((Orig_Node_Counter equal to Ind) and (Track_Node is Ignorable))?” produces an affirmative result because Orig_Node_Counter is 2 and Ind is 2 AND Track_Node is an ignorable element.

Branching to step 1034, the test “Is Track_Node Ignorable?” produces an affirmative result.

Branching to step 1028, Track_Node is set to its next sibling, the text node “sits” 1512.

At this point, the following variables have the following values: Ref_Node: P 1404; Track_Node: text node “sits” 1512; Orig_Node_Counter: 2; Ind: 2; Path_Array_Counter: 0; Off_Counter: 9; and Path_Indices: [ ].

Returning to step 1024, the test “Is (Orig_Node_Counter less than Ind) or is ((Orig_Node_Counter equal to Ind) and (Track_Node is Ignorable))?” produces a negative result because Orig_Node_Counter and Ind are 2 and Track_Node is not an ignorable element.

Branching to step 1008, Path_Array_Counter is incremented by 1, making it 1.

At step 1010, the test “Does Path_Array_Counter equal the length of Path_Array_{O}?” produces an affirmative result because the Path_Array_Counter and the length of [2] are both 1.

At step 1012, the method 1000 stops.

At this point, the following variables have the following values: Ref_Node: P 1404; Track_Node: text node “sits” 1512; Orig_Node_Counter: 2; Ind: 2; Path_Array_Counter: 1; Off_Counter: 9; and Path_Indices: [ ].

Referring again to FIG. 11, at step 1104 the test “Is Track_Node Ignorable?” produces a negative result.

Branching to step 1108, the test “Is Subtree_Text_Length of Track_Node less than Off_Counter?” produces an affirmative result because, as determined by method 800, the Subtree_Text_Length of the text node “sits” is 5, and 5 is less than 9.

Branching to step 1114, Off_Counter is set to Off_Counter minus the Subtree_Text_Length of Track_Node. So, Off_Counter is set to 4 because 9 minus 5 equals 4.

At step 1112, Track_Node is set to its next sibling, making Track_Node the element SPAN 1528.

At this point, the following variables have the following values: Ref_Node: P 1404; Track_Node: SPAN 1528; Orig_Node_Counter: 2; Ind: 2; Path_Array_Counter: 1; Off_Counter: 4; and Path_Indices: [ ].

At step 1104, the test “Is Track_Node Ignorable?” produces a negative result.

Branching to step 1108, the test “Is Subtree_Text_Length of Track_Node less than Off_Counter?” produces a negative result because Subtree_Text_Length of Track_Node (which is now SPAN 1528) is 6 and Off_Counter is 4.

Branching to step 1110, the test “Is Track_Node a text node?” produces a negative result.

Branching to step 1122, Track_Node is set to its first child.

At this point, the following variables have the following values: Ref_Node: P 1404; Track_Node: text node “on the” 1514; Orig_Node_Counter: 2; Ind: 2; Path_Array_Counter: 1; Off_Counter: 4; and Path_Indices: [ ].

Returning to step 1104, the test “Is Track_Node Ignorable?” produces a negative result.

Branching to step 1108, the test “Is Subtree_Text_Length of Track_Node less than Off_Counter?” produces a negative result because Track_Node is the text node “on the”; the Subtree_Text_Length of this node is 6; Off_Counter is 4; and 6 is >4.

Branching to step 1110, the test “Is Track_Node a text node?” produces an affirmative result.

Branching to step 1118, Ref_Node is set to be Track_Node's parent, which is SPAN 1528.

At step 1120, Ind is set to the index of Track_Node in Ref_Node's children array, which makes Ind 0.

At step 1124, the method 1100 stops.

Referring again to FIG. 12, the method 1200 begins at step 1202.

At this point, the following variables have the following values: Ref_Node: SPAN 1528; Track_Node: text node “on the” 1514; Orig_Node_Counter: 2; Ind: 0; Path_Array_Counter: 1; Off_Counter: 4; and Path_Indices: [ ].

At step 1204, Ind is inserted at the beginning of Path_Indices, making it [0].

At step 1208, the test “Is Ref_Node Identifiable?” produces a negative result because SPAN 1528 does not have an identifier.

Branching to step 1210, Ind is set to the index of Ref_Node in its parent's children array, which is 6. So, Ind is now 6.

At step 1212, Ref_Node is set to its parent, making Ref_Node the element P 1404.

At this point, the following variables have the following values: Ref_Node: P 1404; Track_Node: text node “on the” 1514; Orig_Node_Counter: 2; Ind: 6; Path_Array_Counter: 1; Off_Counter: 4; Path_Indices: [0].

At step 1204, Ind is inserted at the start of Path_Indices, making it [6,0].

At step 1208, the test “Is Ref_Node Identifiable?” produces an affirmative result because P 1404 has an identifier “p1”.

At step 1214, the method 1200 stops.

Referring again to FIG. 13, the method 1300 begins at step 1302.

At this point, the following variables have the following values: Ref_Node: P 1404; Track_Node: text node “on the” 1514; Orig_Node_Counter: 2; Ind: 6; Path_Array_Counter: 1; Off_Counter: 4; and Path_Indices: [6,0].

At steps 1304, 1308, and 1310, the modified address 104 is built with the following values: Id_Node_ID_{M} is set to Ref_Node_ID, which is “p1”; Path_Array_{M} is set to Path_Indices, which is [6,0]; and Text_Off_{M} is set to Off_Counter, which is 4. Thus, the modified address is {“p1”,[6,0],4}.

As shown in FIG. 14, FIG. 15, and elsewhere, a tree-based structure may define a document. As shown in FIG. 15 and described in various examples provided herein and elsewhere, addressing annotations relative to the tree-based structure may enable annotations to the document. As shown in FIG. 1 and elsewhere, an original address 112 of an annotation may exist, and the original address 112 may be stored.

The original address 112 may be used to maintain a modified tree-based structure 108 capable of defining the document with annotations. For example and without limitation, successively applying one or more annotations to an original tree-based structure may create a modified tree-based structure 108 with annotations. Instructions for applying each of the annotations may be expressed in terms of one or more original addresses 112 (i.e., relative to the original tree-based structure). As each annotation is applied, the processing method 900 may translate the original addresses 112 into one or more modified addresses 104. Given these modified addresses 104, the modified tree-based structure 108 may be suitably modified at the modified addresses 104. In some embodiments, such a modification may include inserting a tag or the like into the tree-based structure. Thus, a tree-based structure capable of defining the document with annotations may contain a tag that is based upon the original address 112.

In some embodiments, one or more users may provide one or more annotations. Thus, in some embodiments, the document with annotations may contain a plurality of annotations, each by at least one of a plurality of users.

In some embodiments, the annotations may be tracked by user identification. For example and without limitation, a user name or other identifier may be associated with each annotation.

In some embodiments, the original address 112 may be used to allow a change of the annotation without disturbing other annotations to the document. For example and without limitation, an instruction for applying a particular annotation may be changed and then all instructions for applying various annotations may be utilized to create a modified tree-based structure 108. In this context, a change to an annotation may include adding to the annotation, deleting the annotation, modifying the annotation (e.g., changing bold text to italics), or the like.

It will be understood that a tree-based structure capable of defining a document may be an HTML structure using a document object model suitable for allowing display of a document in a web browser. Similarly, it will be understood that a tree-based structure capable of defining the document with annotations may be an HTML structure using a document object model suitable for allowing display of a document in a web browser.

In some embodiments, the original address 112 may be used to maintain a node in a tree-based structure, the tree-based structure corresponding to the document with annotations. Maintaining the node may include inserting the node, removing the node, altering the node, and so on. In some embodiments, maintaining the node may be achieved by reconstructing the modified tree-based structure 108 as described hereinabove and elsewhere.

In some embodiments, making an annotation may result in insertion of starting and ending tags in a tree-based structure. It will be understood that nodes in the DOM of FIG. 15 and elsewhere may correspond to a pair of start and end tags in a document. Furthermore, it will be understood that an original address 112 and a modified address 104 may include an address of a node containing a string and an address of at least one character in the string. The aforementioned target position 1420 may provide an example of this. Numerous other such examples will be understood.

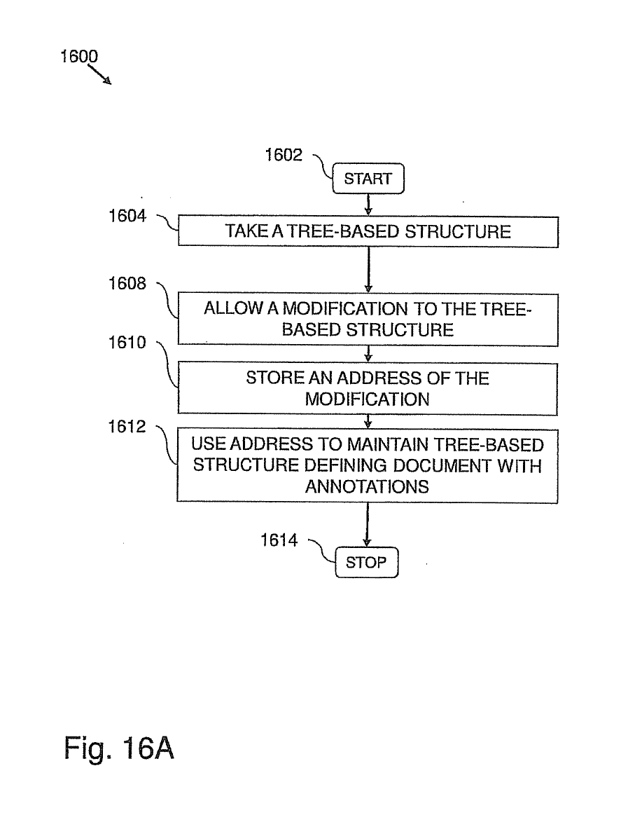

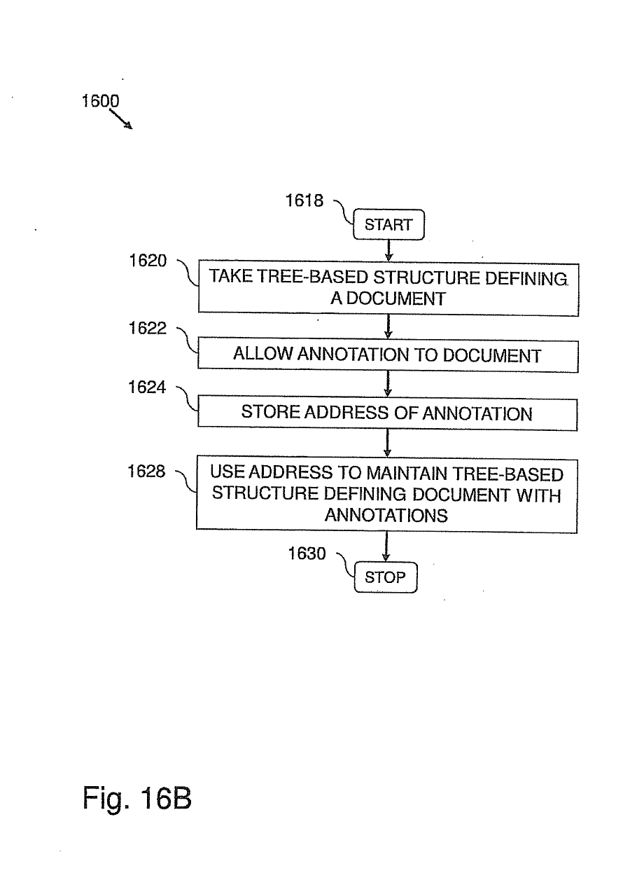

FIG. 16A depicts a flowchart of a method 1600 of maintaining a tree-based structure in accordance with an embodiment of the present invention. The method 1600 may begin at step 1602. At step 1604, a tree-based structure may be taken into consideration. The tree based structure may be capable of defining a document. At step 1608, modifications may be allowed in the tree-based structure. At step 1610, an address of the modification may be stored. For example, the original address 112 may be stored. At step 1612, a tree-based structure capable of defining the document with modifications may be maintained. For example, by using the original address 112, the tree-based structure may be maintained. The method 1600 may end at step 1614.

Similar to the flow chart of FIG. 16A, FIG. 16B depicts a flowchart of a method of maintaining a tree-based structure in accordance with another embodiment of the present invention. The method may begin at step 1618. At step 1620, a tree-based structure capable of defining a document may be taken into consideration. An annotation to the tree-based structure may be allowed, as shown in step 1622. An original address 112 of the annotation may be stored, as shown in step 1624. Using the original address 112, a tree-based structure capable of defining the document with annotations may be maintained, as shown in step 1628. The method may end at step 1630.

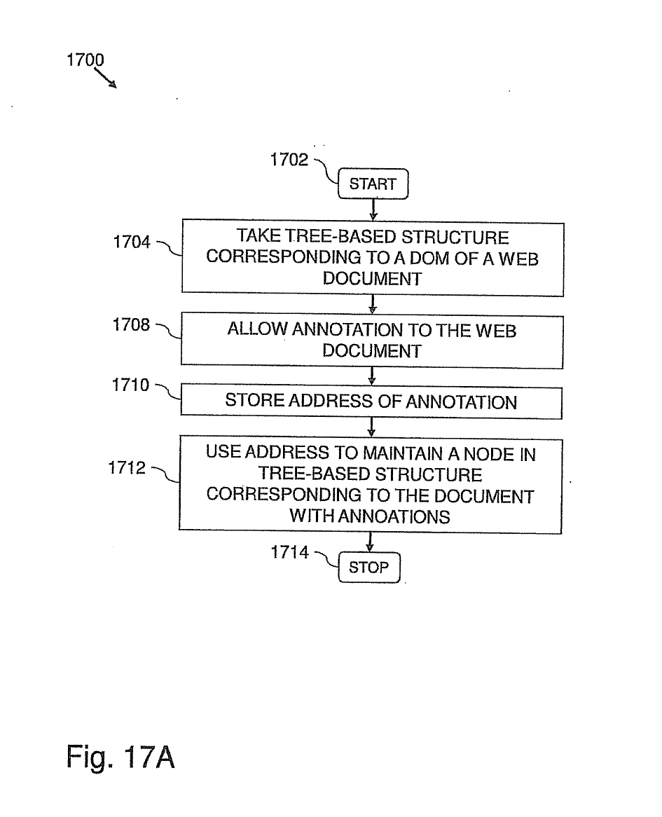

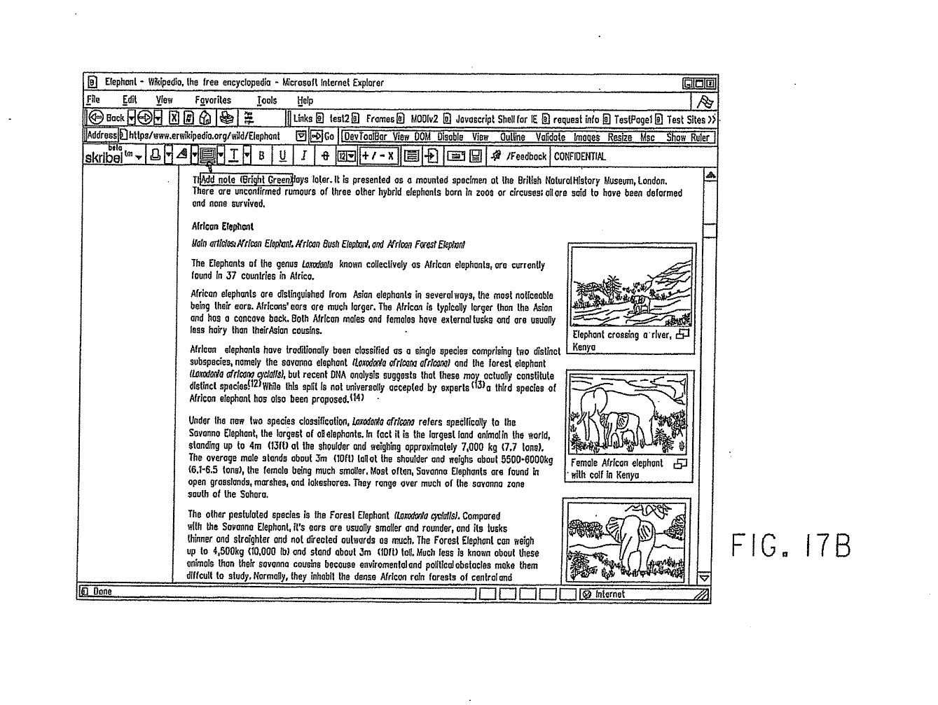

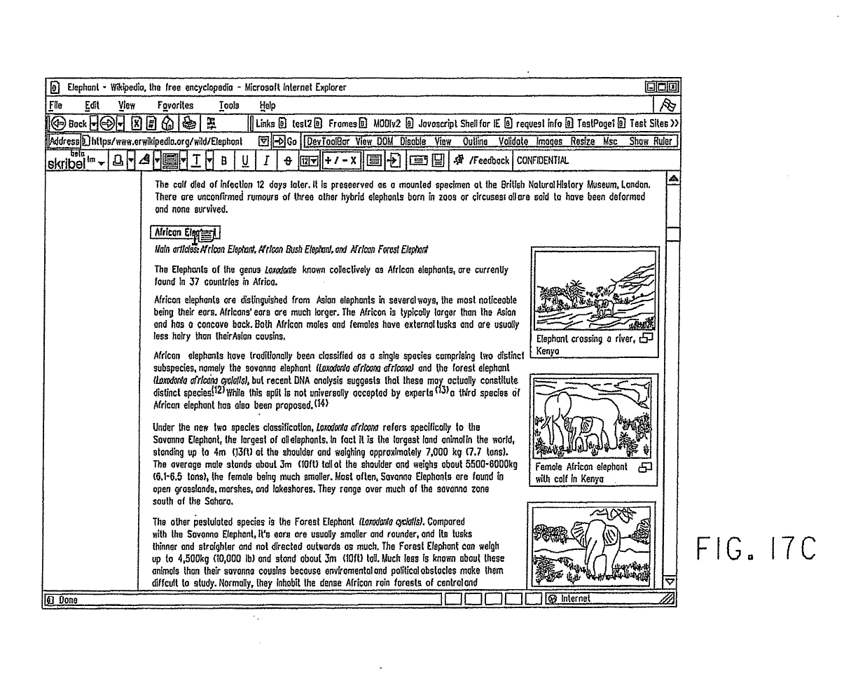

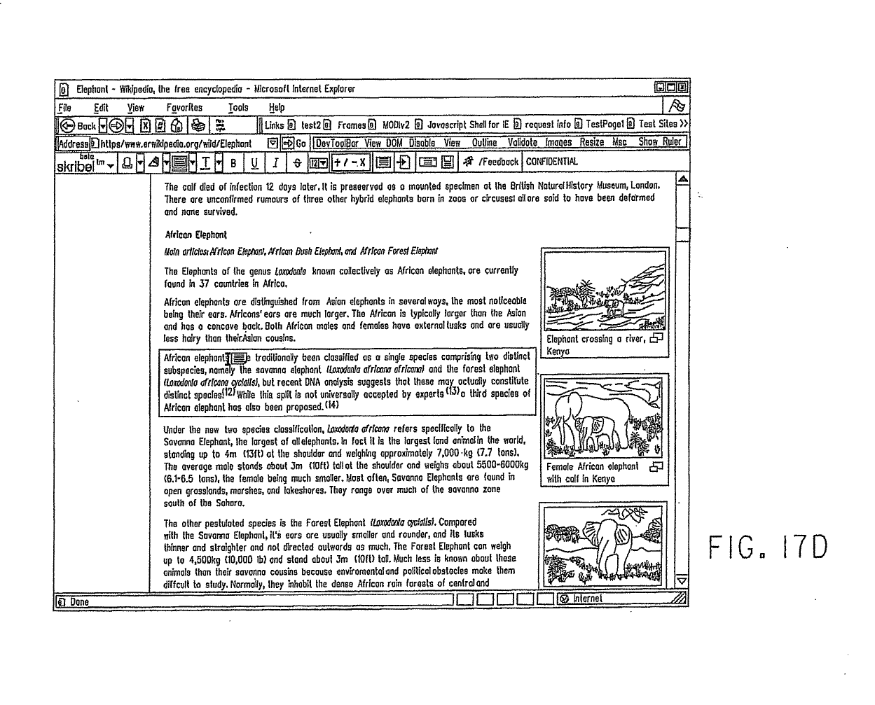

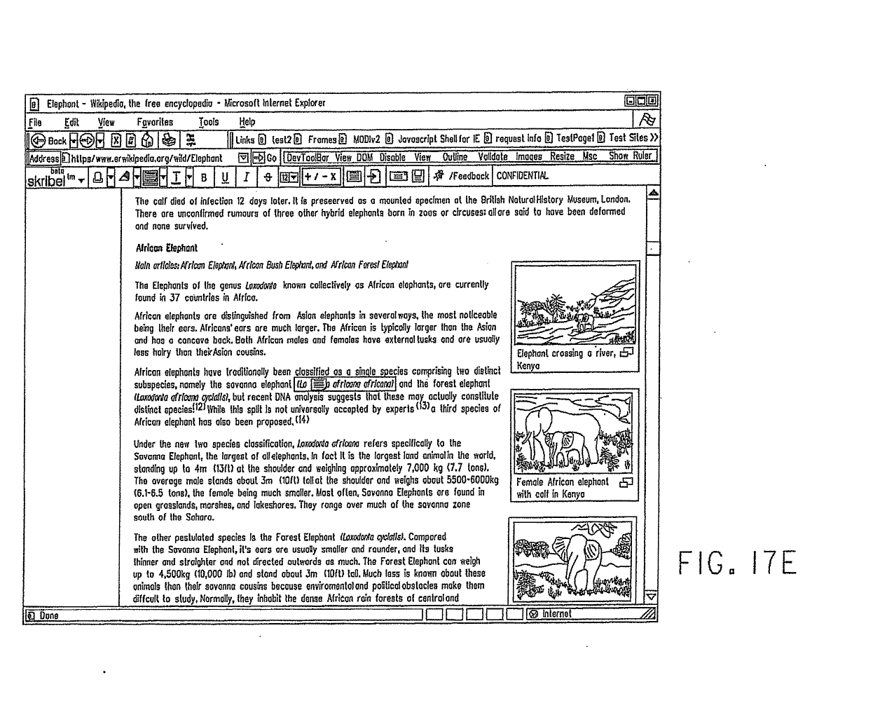

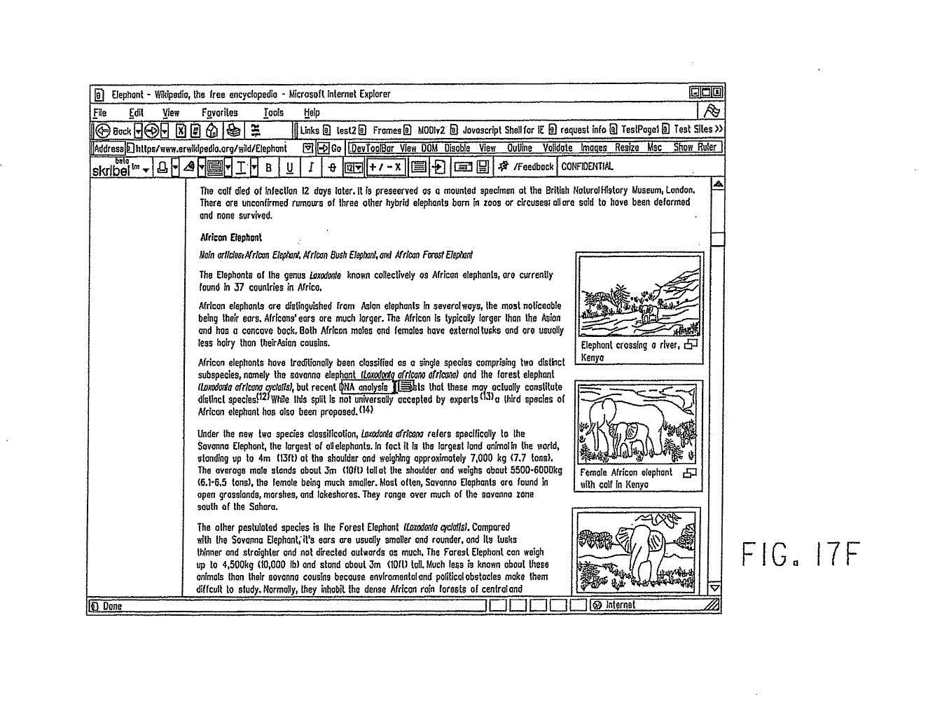

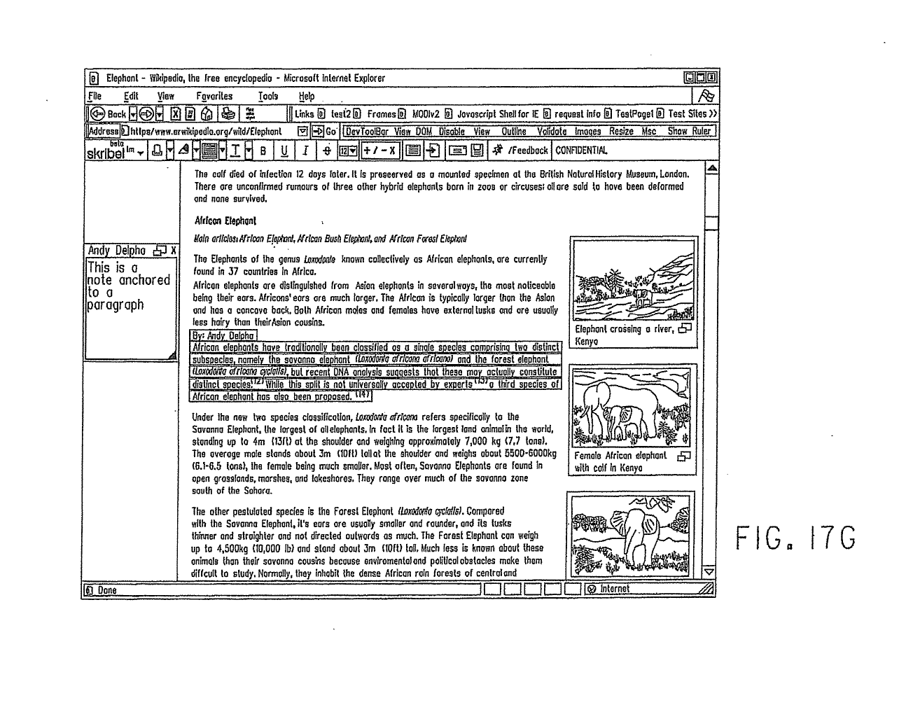

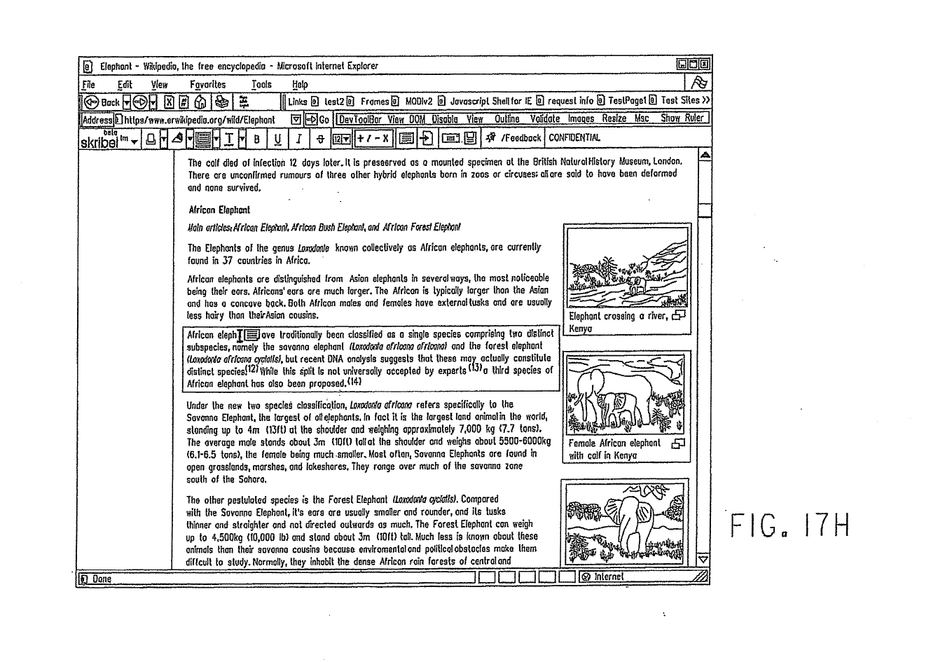

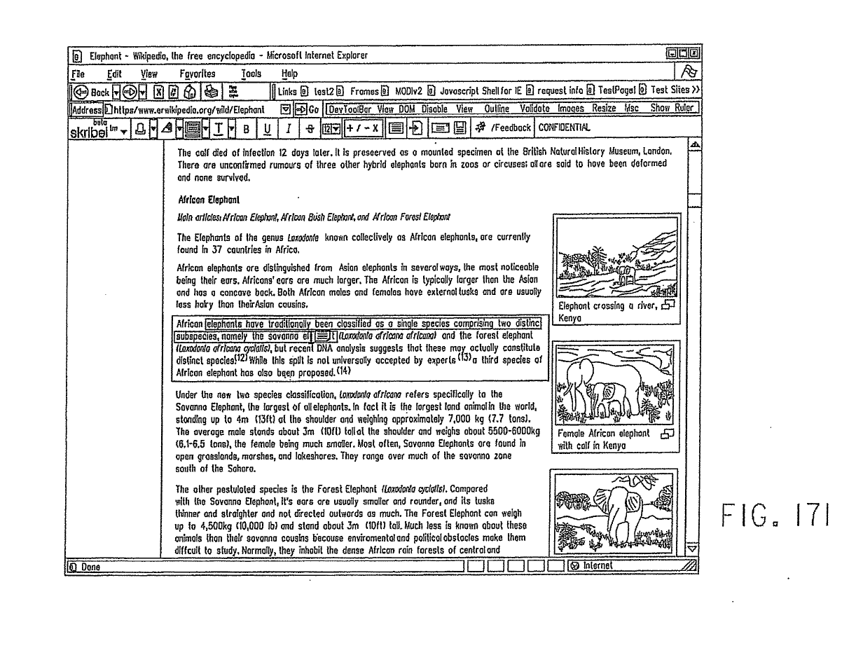

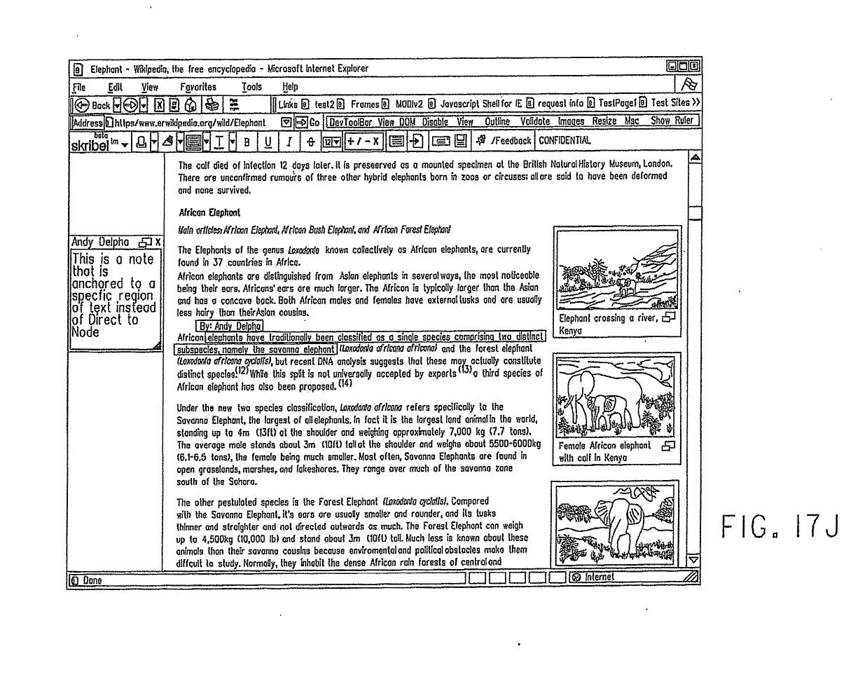

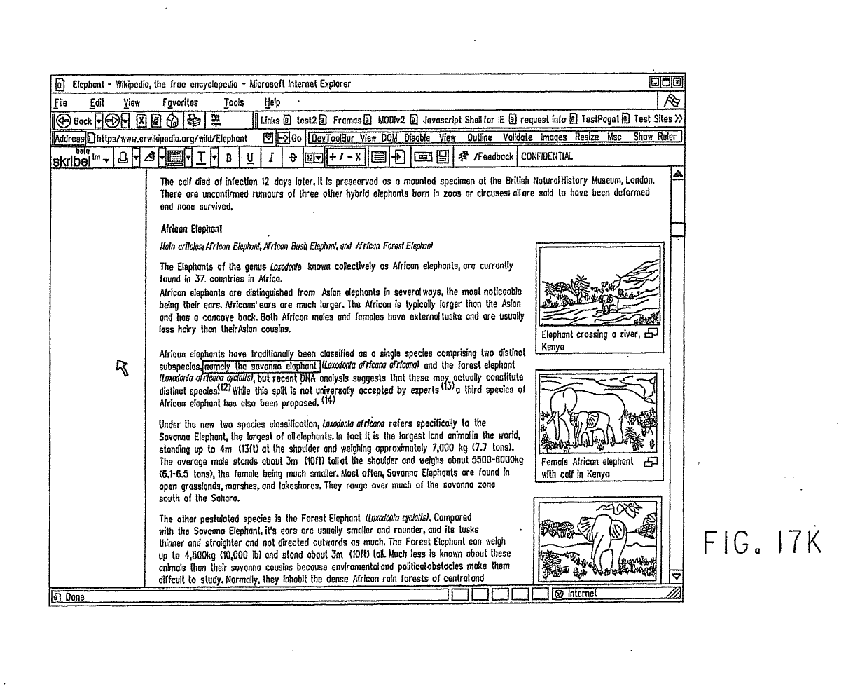

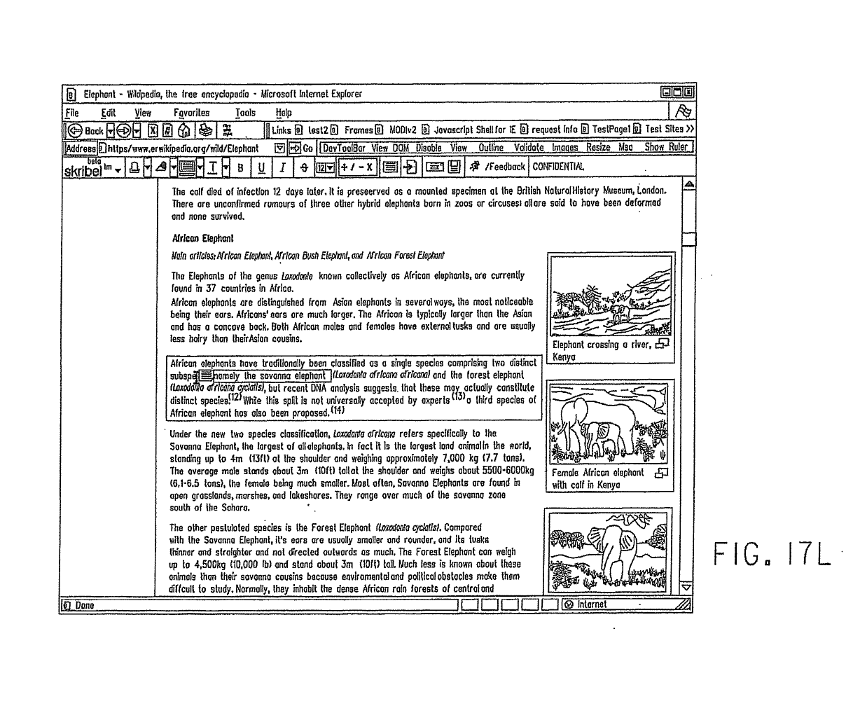

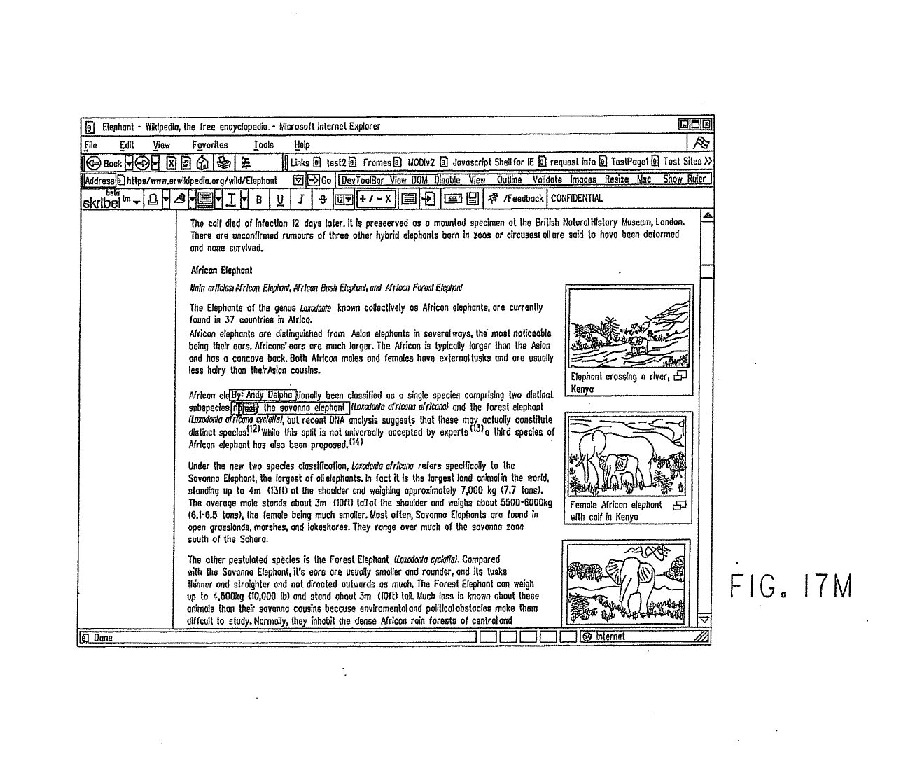

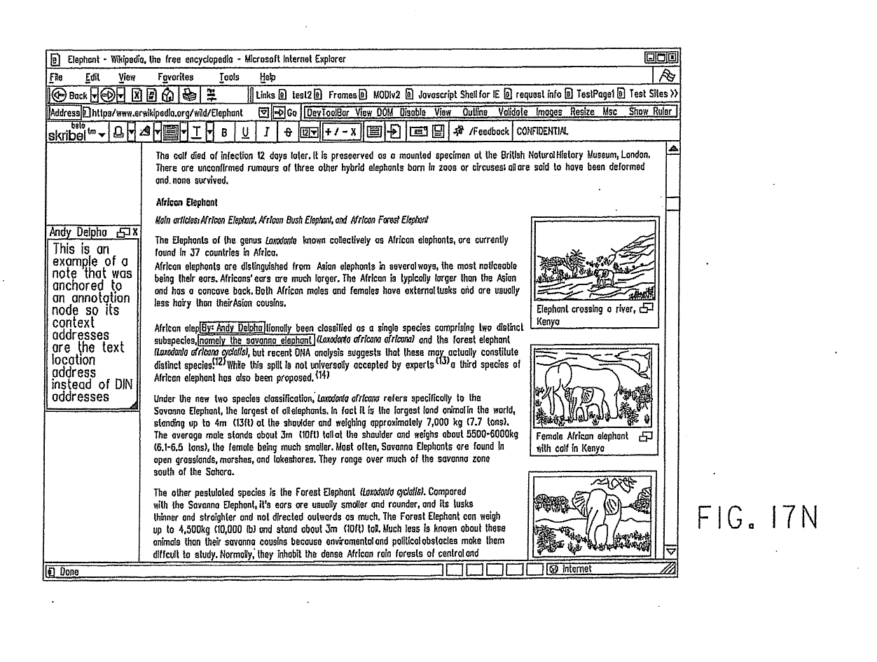

FIG. 17A depicts a flowchart of a method of maintaining a node in a tree-based structure. The method 1700 may begin at step 1702. At step 1704, a tree-based structure corresponding to a document object model of a web document may be taken into consideration. In some embodiments, the tree-based structure may have a plurality of nodes, at least one of the nodes having associated therewith a plurality of characters. At step 1708, a user may be allowed to make an annotation to the web document. At step 1710, an original address 112 of the annotation may be stored. At step 1712, the original address 112 may be used to maintain a node in a tree-based structure corresponding to the document with annotations. The method may end at step 1714.

In embodiments, it may be desirable to associate an annotation with a particular node rather than a particular character in a text node. Such addressing may be referred to as “Direct to Node addressing” or “DtN addressing,” and such annotations may be referred to as “DtN annotations.” DtN addressing may be useful for attaching an annotation to an entire node. For example, an image may be addressed or a whole paragraph in a webpage may be addressed.

To make this addressing compatible with the disclosed addressing conversion methods, the first two fields of the address (Id_Node_Id and Path_Array) may be used. These two fields may uniquely identify a target node. To indicate that an address is a DtN address, the Text_Off field of the address may be set to a specific predetermined value which may not coincide with a valid Text_Off value. For example, the user may use a nil, or may set it to a negative value since a negative text offset may not be valid. In this scenario, the predetermined value for the Text_Off field of a DtN address may be set as −1.

In embodiments, a user interface for Dtn annotation placement may be provided. A mechanism to afford feedback to the user during the placement may be provided for an intuitive interface to indicate DtN placement/addressing of annotations. In embodiments, as shown in FIG. 17B, the user may first indicate that they may want to place an annotation type that may use DtN addressing. Once the user has done that, as their mouse pointer moves over eligible placement nodes, the node that would be targeted may be emphasized as shown in FIG. 17C, FIG. 17D, FIG. 17E, FIG. 17F, and FIG. 17G. This may help the user to ensure that they are targeting the correct node. This may be important, because there may be extra markup nodes in what may appear to the user to be a single block of text. For instance, as shown in FIG. 17E, the text in Italics may be a node inside of the larger paragraph. FIG. 17F shows that links may be another case of a separate node inline within a block of text. FIG. 17G shows the note placement and the context of the note based on the framework shown in FIG. 17D, which may be the whole paragraph.

In embodiments, the user may not explicitly indicate that they want to place a DtN type annotation. Instead, as shown in FIG. 17B, the user may select an annotation to place. The user may automatically start using the emphasized target node for DtN style addressing as shown in FIG. 17H. However, as shown in FIG. 17I, if the user clicks and drags to make a selection, they may select a text range for the context of the note explicitly instead of using DtN to set the context as a single node. FIG. 17J shows a note and its context. As shown in FIG. 17J, the context may be an arbitrary, selected block of text instead of an entire node.

As shown in FIG. 17K-FIG. 17M, if a page already has annotations in it, the user may anchor a DtN annotation to an existing annotation element. The DtN annotation's context may be converted from the existing annotation node to the same context as that of the existing annotation as shown in FIG. 17N. This may avoid orphaning the DtN annotation's context when and if the existing annotation is removed in the future.

In embodiments, listening to the mouse movement events in the webpage may be enabled. This may determine the element on which the mouse pointer is positioned. These events may provide an X,Y coordinate within the webpage for the mouse pointer. From this step, use may be made of additional methods, such as IE's elementFromPoint method, which may return the element at a given point.

The current style settings of this element may be first stored. The current style settings may be replaced with the styles which may emphasize the nodes. For example, the background color may be set. When the user determines that the mouse is no longer over this element, the stored normal style properties may be restored. The method 1700 may end at step 1714.

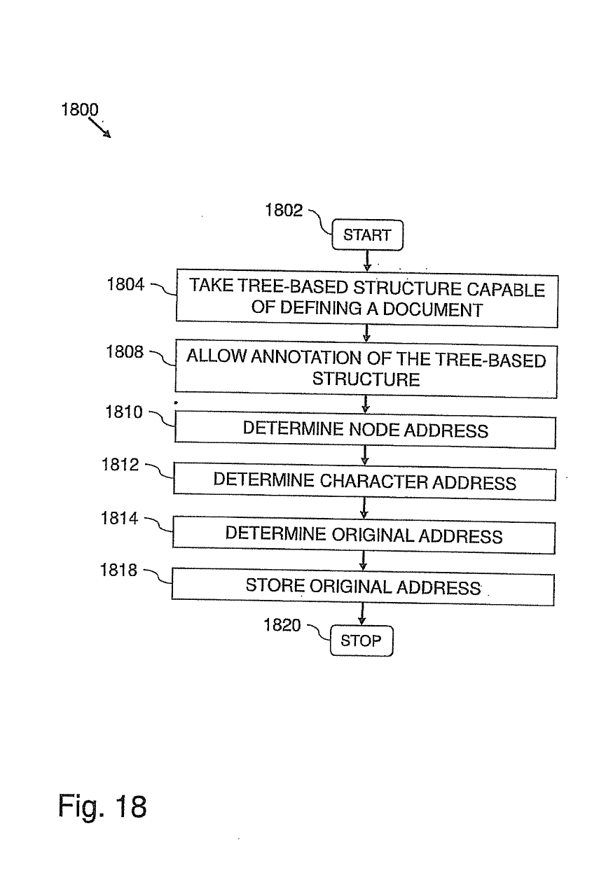

FIG. 18 depicts a flowchart of a method of determining an original address. The method 1800 may begin at step 1802. At step 1804, a tree-based structure capable of defining a document may be taken into consideration. At step 1808, an annotation to the tree-based structure may be allowed. In some embodiments, the annotation may correspond to a desired marking of the document. In some embodiments, the annotation may result in insertion of starting and ending tags in the tree-based structure. At step 1810, a node address of a node associated with a plurality of characters may be determined. In some embodiments, the plurality of characters may be framed by tags. At step 1812, a character address of at least one character may be determined, the character in text framed by tags. In some embodiments, the tags may be starting and ending tags. At step 1814, an original address 112 of at least one character may be determined. At step 1818, the original address may be stored. The method 1800 may end at step 1820.

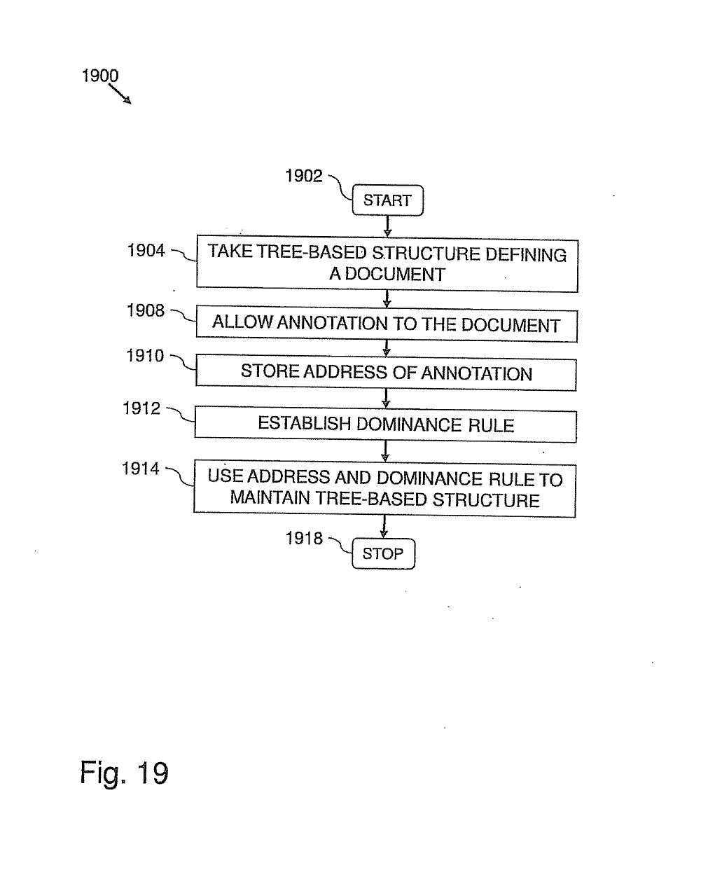

FIG. 19 depicts a flowchart of a method of maintaining a tree-based structure. The method 1900 may begin at step 1902. At step 1904, a tree-based structure capable of defining a document may be taken into consideration. At step 1908, an annotation to the document may be allowed. In some embodiments, the annotation may correspond to a modification of the tree-based structure, such as to produce a modified tree-based structure 108. At step 1910, an original address 112 of the position of the annotation may be stored. At step 1912, a dominance rule may be established whereby at least one type of annotation dominates another type of annotation. At step 1914, the original address 112 and the dominance rule may be used to maintain a tree-based structure capable of defining the document with annotations. The method 1900 may end at step 1918.

It may be noted that dominance rules may be applied in cases where two successive annotations to an item, such as a string of text in a document, are potentially inconsistent. For example, an annotation that renders a set of text characters in a particular unitary font color and a subsequent annotation that renders the text in a different unitary font color cannot both be represented at the same time, as a character can only have one unitary font color. Dominance rules may be applied to resolve such inconsistencies in various ways, such as by removing the initial annotation (optionally preserving a record of it in a modified tree-based structure according to the present disclosure) and replacing it with the later annotation (itself represented by a modified tree-based structure; by applying annotations according to an author hierarchy (such as a hierarchy based on the relative authority, position, or the like of the person making the annotation or the device upon which the annotation is made); by applying annotations based on a hierarchy of annotation type (e.g., rendering text in red dominates rendering text in yellow, or the like); by applying methods that partially resolve potential conflict (e.g., rendering text in multiple colors, rendering highlights in multiple bands of color, rendering elements that have conflicting annotations in a special way, cycling through different annotations of a particular text element over time, or the like); or the like. Dominance rules may also apply, according to user preferences, in cases of annotations that are not necessarily inconsistent; for example, an annotation that renders a text item bold and an annotation that renders a text item italicized are not necessarily inconsistent, because the text item can be represented simultaneously in bold and italics; however, a user may wish to specify a dominance rule such that after one such annotation (e.g., rendering text bold), a subsequent annotation (e.g., italicizing text) cancels the first annotation and replaces it with the second (in this case replacing bold text with italicized text). An alternative rule, again determined by the preference of the developer of an annotation program, would instead apply both annotations (in this case resulting in bold and italicized text). Dominance rules may also be used to merge nonconflicting, logically consistent annotations. For example, two highlight annotations of the same color may be merged into a single larger highlight annotation. Thus, dominance rules may be used to resolve sets of logically inconsistent annotations and sets of annotations that are logically consistent, but which produce multiple potential results. Dominance rules, and annotation capabilities more generally, may be applied in connection with a computer-implemented tool set, such as a set of word processing tools, desktop publishing tools, editing tools, HTML manipulation tools, annotation tools, applets, toolbar elements, or the like, in each case allowing a user to interact with text, nodes, elements or other items to produce various effects, such as various effects enabled by conventional versions of such tools. Thus, a developer of a tool set or other application that takes advantage of the addressing schema described throughout this disclosure may specify dominance rules and other annotation functions and capabilities according to preferences of the developer. Once such rules are specified, the methods and systems described herein may be used to enable an appropriate modified tree-based structure or set of modified tree-based structures to embody the effect of a particular annotation or series of annotations.

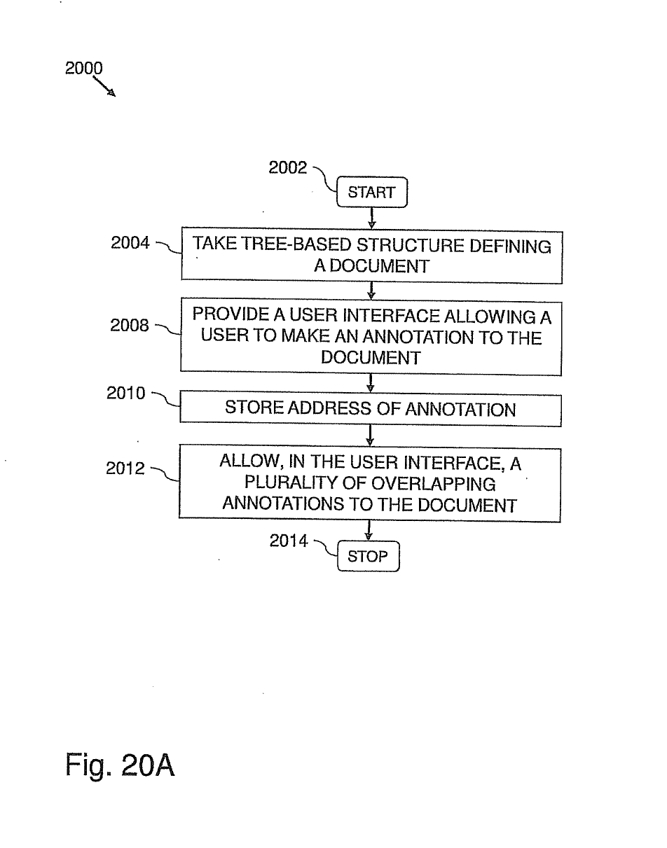

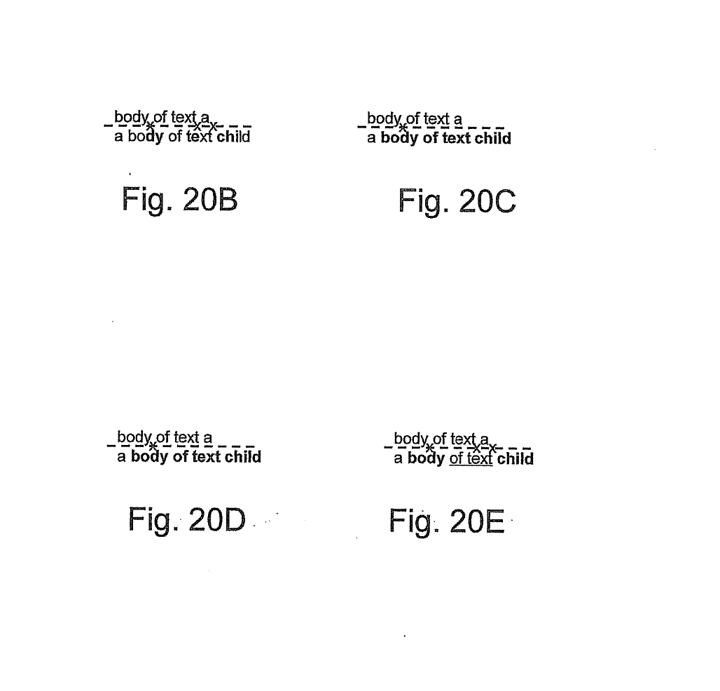

FIG. 20A depicts a flowchart of a method of allowing a plurality of overlapping annotations in a user interface. The method 2000 may begin at step 2002. At step 2004, a tree-based structure capable of defining a document may be taken into consideration. At step 2008, a user interface may be provided for allowing a user to make an annotation to the document. At step 2010, an original address 112 of the annotation may be stored. At step 2012, in the user interface, a plurality of overlapping annotations of the document may be allowed.

In embodiments, the user interface may provide a Toolbar, which may allow the user to select a type of annotation and to annotate a document. The user may drag a mouse or cursor over the text, and the like. This dragging may result in a variety of effects, which may include highlighting, underlining, font changes, italics, bold text, anchoring of comments, and the like. In embodiments, the Toolbar may optionally work as a bandbar plug-in for a web browser. This may be a type of plug-in which may show up as a “toolbar” in the toolbar area of the web browser window. In embodiments, the Toolbar may optionally allow the user to overlap annotations. For example, a bold annotation may overlap with a highlight annotation or it may overlap a font color change annotation.

In embodiments, the annotations may be merged. In an exemplary scenario, the user may place an annotation that may make changes to the formatting of the text in the page. The user may also place a second annotation of the exact same type such that the second annotation may overlap with the first annotation. These two annotations may be merged into a single annotation. For example, the user may make a yellow highlight over a stretch of text and then may create a second yellow highlight that may overlap with the last word of the first one, and then the two highlights may be merged into a single longer yellow highlight.

To merge the annotations, text-style annotations may be placed. Their start and end addresses may be checked to see if they fall within the range of any existing annotations of the exact same type or if any of the existing annotations of the exact same type may fall entirely within the new annotation range. This check may result in different overlap conditions for each annotation it is compared to.

In an exemplary scenario, the new annotation may overlap with the beginning of the existing annotation. In this case, the existing annotation may be removed and the end address of the new annotation may be changed to become the end address of the existing annotation. Alternatively, the start address of the existing annotation may be reset to the start address of the new annotation. The new annotation may be discarded.

In an exemplary scenario, the new annotation may overlap with the end of the existing annotation. In this case, the existing annotation may be removed and the start address of the new annotation may be changed to become the start address of the existing annotation. Alternatively, the end address of the existing annotation may be changed to be the end address of the new annotation. The new annotation may be discarded.

In yet another exemplary scenario, the new annotation may fall completely within the existing annotation. The new annotation may be discarded and further processing to place the annotation stops

In yet another exemplary scenario, the new annotation may completely surround the existing annotation. In this case, the existing annotation may simply be removed. Alternatively, the start and end addresses of the existing annotation may be changed to the start and stop addresses of the new annotation, respectively, and the new annotation may be discarded. Referring to FIG. 20B, a snapshot of two exemplary texts before the merging may be shown. FIG. 20C shows a snap shot of the texts after merging. As shown in FIG. 20B and FIG. 20C, the 3 existing red text color styles may be merged into the new red text color style annotation beginning at the start of the word ‘body’ and ending at the end of the word ‘child.’ It may be noted that each red colored “X” in the FIG. 20B and FIG. 20C may indicate a single annotation.

In embodiments, certain types of annotations may conflict with one another. For example, two overlapping highlights of different colors or two text color style annotations of different colors may conflict with one another. The annotation types that may result in conflicts may be placed, and checked with existing annotations in the page to determine if an overlap condition exists. There may be different ways of overlapping the annotations. A new annotation may overlap with several existing annotations, so different rules may be applied for each existing annotation. It may be noted that the new annotation may not be changed, as it may take priority over the existing annotations of the conflicting types. It should be noted that other priority rules may be applied in different scenarios, such as having annotations made by a particular user take precedence over annotations of another user.

In an exemplary scenario, the new annotation may overlap with the beginning of the existing annotation. In this case, the existing annotation may be trimmed. In this case, the start address of the existing annotation may be set to the end address of the new annotation.

In another exemplary scenario, the new annotation may overlap with the end of the existing annotation. In this case, the existing annotation may be trimmed. In this case, the end address may be set to the start address of the new annotation.

In yet another exemplary scenario, the new annotation may fall completely within the existing annotation. In this case, the existing annotation may be split into two, with the new annotation appearing in between the newly split annotation pieces. To achieve this, a third annotation may be created that may be a copy of the existing annotation. The existing annotation's end address may be set to the start address of the new annotation. The third annotation's start address may be set to the new annotation's end address, and the third annotation's end address may remain the existing annotation's pre-split end address. This is illustrated in FIG. 20D and FIG. 20E. As shown, FIG. 20E shows splitting after applying a new green text color annotation to the words ‘of text’ in the middle of the existing red text color style annotation. It may be noted that each red colored “X” in the FIG. 20D and FIG. 20E may indicate a single annotation.

In yet another exemplary scenario, the new annotation may completely surround the existing annotation. In this case, the existing annotation may be simply removed.

In embodiments, the annotations may be placed into a Web page. In an exemplary scenario, there may be two overlapping annotations, such as a highlight overlapping a red font coloring. In this example, highlights may specify a font color and background color styles. The font color may be specified so that the text may remain readable against the new background “highlight” color. If the context elements for the highlight are closer to the text node than the context elements for the font color annotation, the highlight's font color may win. In embodiments, when overlapping annotations are found, the context elements of the overlapping annotations may be removed, and may be re-added to the tree in a specific order to ensure the proper rendering of the desired visual effects. In this stated exemplary scenario, the highlight may be added first, and then the font color appended. This may cause the font color's context elements to be placed closest to the text nodes and last. The method 2000 may end at step 2014.

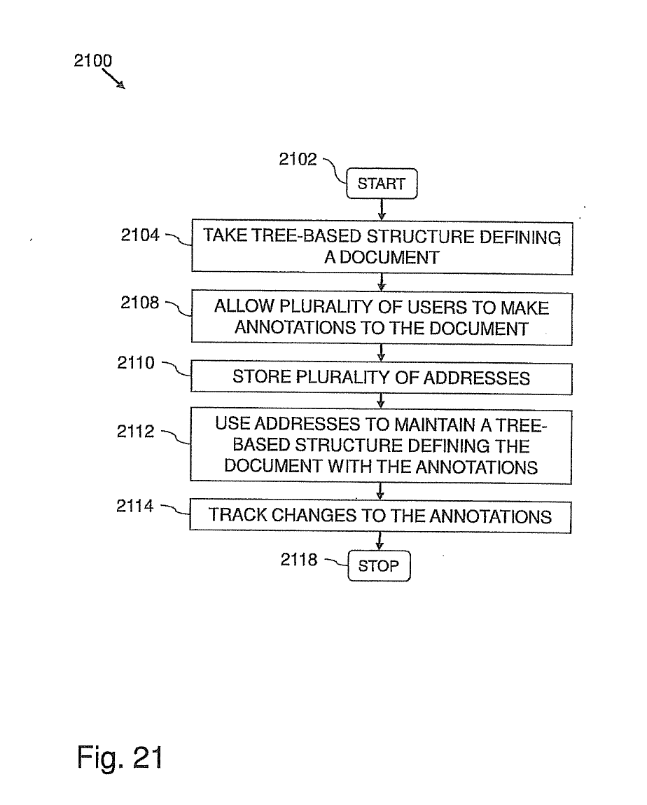

FIG. 21 depicts a flowchart of a method of tracking changes to annotations. The method 2100 may begin at step 2002. At step 2004, a tree-based structure capable of defining a document may be taken into consideration. At step 2008, a plurality of users may be allowed to make annotations to the document. In some embodiments, each of the annotations may correspond to a desired marking of the document. At step 2010, a plurality of original addresses 112, each corresponding to at least one of the annotations, may be stored. At step 2112, the original addresses 112 may be used to maintain a tree-based structure capable of defining the document with the annotations. At step 2114, changes to the annotations may be tracked. The method may end at step 2118.

In order to illustrate but a few possible embodiments and applications of tree-based structures and the methods and systems described herein for developing, storing, manipulating and using original and modified tree-based structures and addresses, FIGS. 22-27 are provided below. FIGS. 22-27 illustrate, among other things, use of the addressing schema described herein in the context of annotation of documents, such as web documents. It will be understood that a variety of embodiments and applications of the methods and systems described herein are possible.

FIG. 22 depicts a document 2204 in a web browser 2202 and a related DOM 2208. The DOM 2208 contains an HTML node having a BODY node as a child. The BODY node has a DIV node as a child. The DIV node has an identifier (“container”) and a P node a child. The P node has an identifier (“content”) and an original text node as a child. The original text node contains the text “The full moon was last night.”

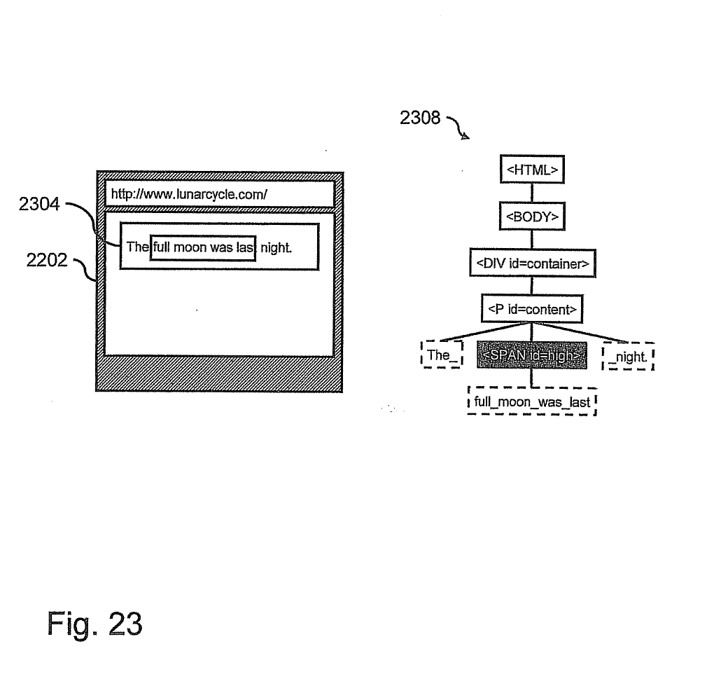

FIG. 23 depicts a document 2304 in the web browser 2202 and a related DOM 2308. The document 2304 may be the document 2204 with highlighting applied to the text “full moon was last”. The DOM 2308 may be the DOM 2208 modified to reflect the highlighting. In the DOM 2308, the original text node of DOM 2208 may be split into three text nodes (“The”, “full moon was last”, and “night.”). The P node has as children the 0^{th} and 2^{nd} of the three text nodes (using zero-based indexing). Additionally, the P node has a SPAN node as a child. The SPAN node has an identifier (“high”) and the 1^{st} of the three text nodes as a child (using zero-based indexing).

In some embodiments, the highlight may be applied according to the following acts: receiving a command to apply highlighting to the text “full moon was last”; calculating a modified start address and modified stop address (both relative to the DOM 2208); calculating an original start address and an original stop address (also both relative to the DOM 2208); modifying the DOM 2208 to become the DOM 2308; and storing the original addresses. In this case, the original addresses and the modified addresses may be the same because the DOM 2208 to which the highlighting is applied is the original DOM 2208. Thus, the modified start address and the original start may be {content, [0], 4}, and the modified stop address and the original stop address may be {content, [0], 22}. In this case, the start and stop addresses are based on a convention in which the annotation starts directly before the start address and stops directly before the stop address. Of course alternative conventions may be used; for example, annotations might stop or start at different points before or after a start or stop address for a particular text string. All such embodiments are intended to be encompassed by this disclosure. It will be understood that in some embodiments, the methods described herein, including the methods described in the documents incorporated herein by reference, may be employed to calculate the addresses.

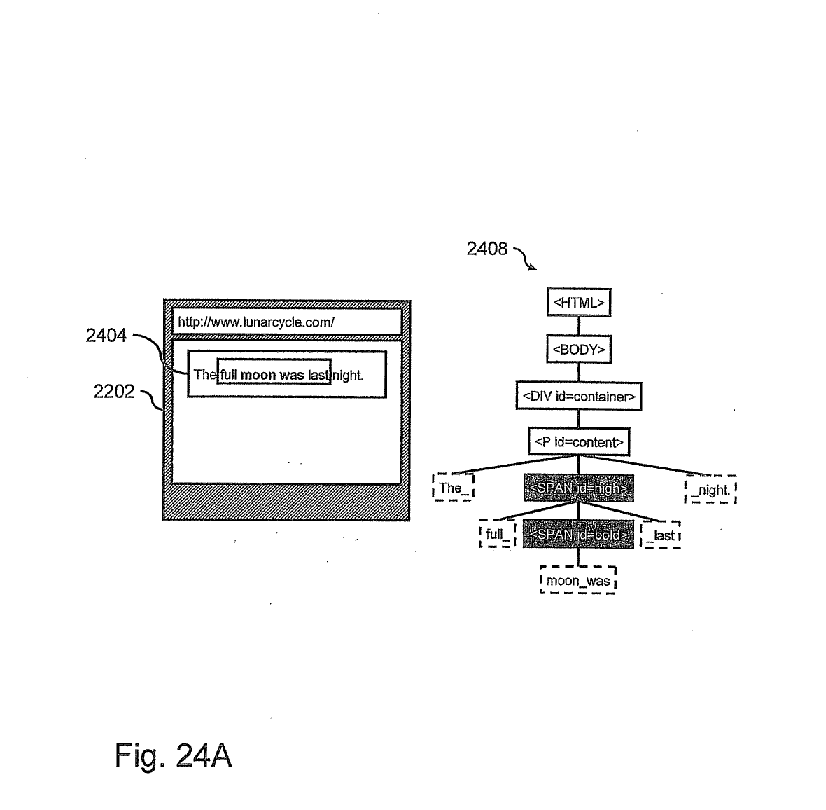

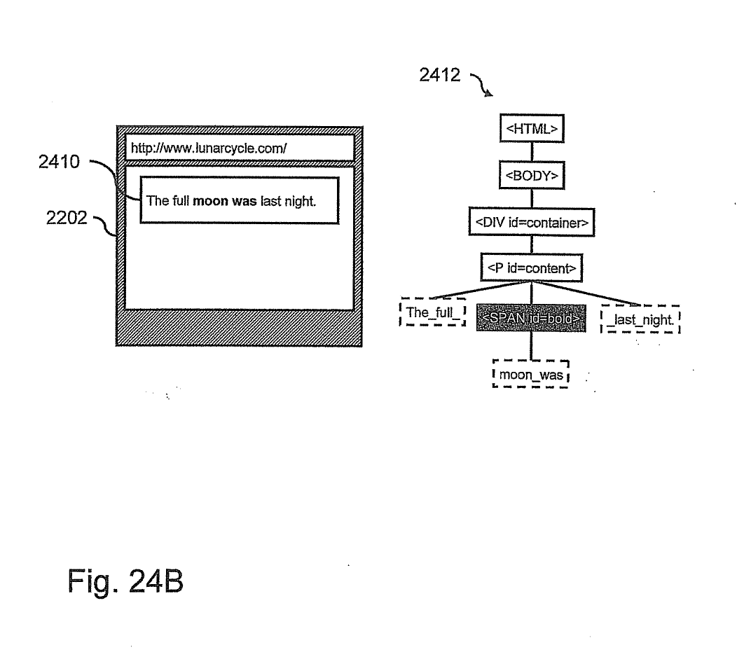

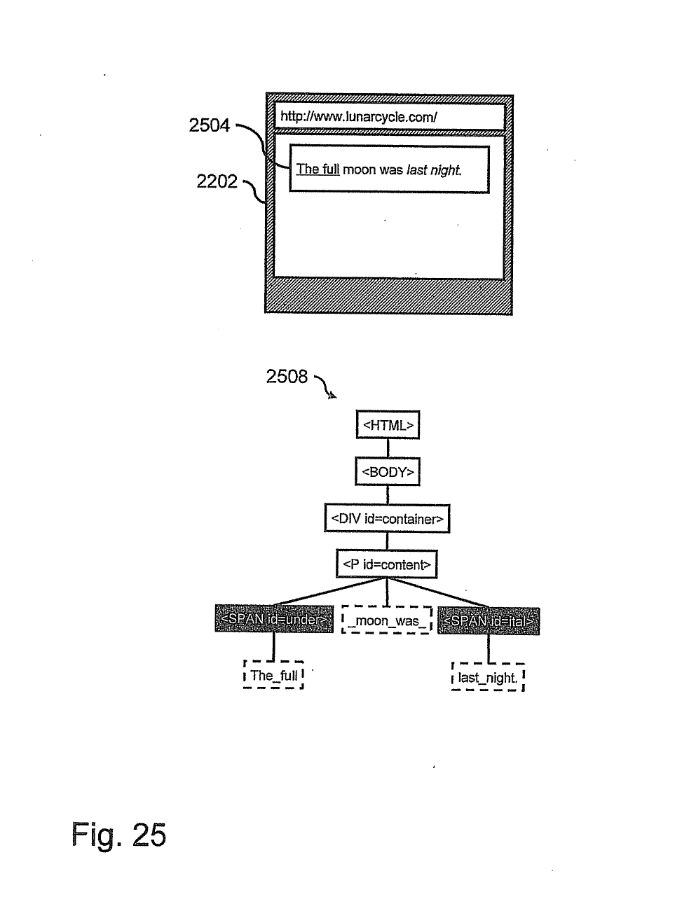

FIG. 24A depicts a document 2404 in the web browser 2202 and a related DOM 2408. The document 2404 may be the document 2304 of FIG. 23 with boldfacing applied to the text “moon was”. The DOM 2408 may be the DOM 2308 of FIG. 23 modified to include the boldfacing. In light of the description of the DOM 2208, the DOM 2308, and other disclosure herein and elsewhere, the reader will readily understand the DOM 2408 as a modified tree-based structure as described throughout this disclosure.

In some embodiments, the boldfacing may be applied according to the following acts: receiving a command to apply boldfacing to “moon was”; calculating a modified start address and a modified stop address (both relative to the DOM 2308); calculating an original start address and an original stop address (both relative to the DOM 2208); altering the DOM 2308 to become the DOM 2408; and storing the original addresses. Thus, the modified start address may be {high, [0], 5}; the modified stop address may be {high, [0], 13}; the original start address may be {content, [0], 9}; and the original stop address may be {content, [0], 17}. It will be understood that in some embodiments, the methods described herein, including the methods described in the documents incorporated herein by reference, may be employed to calculate the addresses.

FIG. 24B depicts a document 2410 in the web browser 2202 and a related DOM 2412. The document 2410 may be the document 2404 of FIG. 24A with highlighting from the text “full moon was last” removed. In this case, boldfacing for the text “moon was” remains. The DOM 2412 may be the DOM 2408 of FIG. 24A modified to remove the highlighting. In light of the description of the DOM 2208, the DOM 2308, and other disclosure herein and elsewhere, the reader will readily understand the DOM 2412 as a modified tree-based structure as described throughout this disclosure.

Since modified addresses are here calculated relative to DOM 2408, the modified start and stop addresses of the remaining boldfacing are {high, [0], 5} and {high, [0], 13}, respectively. However, these addresses are now invalid because removing the highlighting removed the node referenced by the first component of each modified address. In contrast, the original start and stop addresses {content, [0], 9} and {content, [0], 17}, respectively, remain valid and may be used to accurately and reliably locate the start and stop positions of the boldfacing. As such, this example demonstrates the utility of the system and methods disclosed herein for calculating original addresses and using such original addresses to maintain a tree-based structure capable of defining a document.

FIG. 25 depicts a modified document 2504 in the web browser 2202 and a related modified DOM 2508. The corresponding original document may be document 2204 and the corresponding original DOM may be DOM 2208. In light of the description of the DOM 2208, the DOM 2308, and other disclosure herein and elsewhere, the reader will readily understand the DOM 2508.

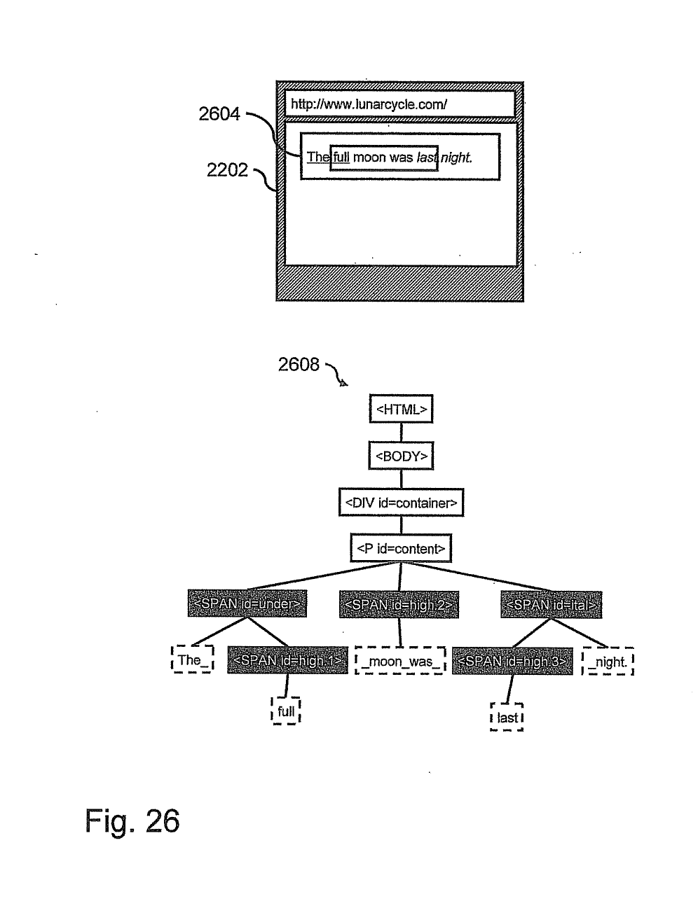

FIG. 26 depicts a document 2604 in the web browser 2202 and a related DOM 2608. The document 2604 may be the document 2504 with highlighting applied to the text “full moon was last”. The DOM 2608 may be the DOM 2508 altered to include the highlighting. In light of the description of the DOM 2208, the DOM 2308, and other disclosure herein and elsewhere, the reader will readily understand the DOM 2608.

In some embodiments, the highlighting may be applied according to the following acts: retrieve previously stored original start and stop addresses of the highlighting (relative to the original DOM 2208); calculating modified start and stop addresses of the highlighting (relative to the modified DOM 2508); and altering the modified DOM 2508 to include the highlighting. The original start address may be {content, [0], 4}; the original end address may be {content, [0], 22}; the modified start address may be {under, [0], 4}; and the modified end address may be {ital, [0], 4}. It will be understood that in some embodiments, the methods described herein, including the methods described in the documents incorporated herein by reference, may be employed to calculate the addresses.

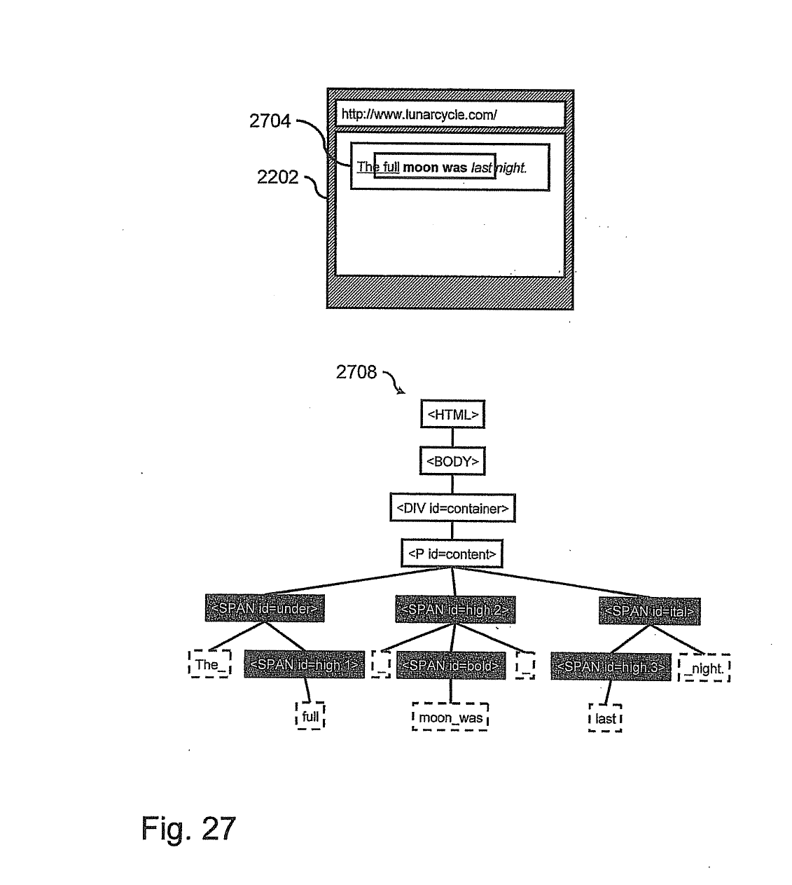

FIG. 27 depicts a document 2704 in the web browser 2202 and a related DOM 2708. The document 2704 may be the document 2604 with boldfacing applied to “moon was”. The DOM 2708 may be the DOM 2608 altered to include the boldfacing. In light of the description of the DOM 2208, the DOM 2308, and other disclosure herein and elsewhere, the reader will readily understand the DOM 2708.

In some embodiments, the boldfacing may be applied according to the following acts: retrieve previously stored original start and stop addresses of the boldfacing (relative to the original DOM 2208); calculating modified start and stop addresses of the boldfacing (relative to the modified DOM 2608); and altering the modified DOM 2608 to include the boldfacing. The original start address may be {content, [0], 9}; the original end address may be {content, [0], 17}; the modified start address may be {high.2, [0], 1}; and the modified end address may be {high.2, [0], 9}. It will be understood that in some embodiments, the methods described herein, including the methods described in the documents incorporated herein by reference, may be employed to calculate the addresses.

In some cases, different annotation types may be overlapped and combined. For example, FIG. 24A of the addressing schema application shows that, in the sentence “The full moon was last night”, “full moon was last” is highlighted, while “moon was” is bolded. So, the highlight, which was added first, may be overlapped with the bold. Similarly, FIGS. 26 and 27 of the addressing schema application show additional examples of overlapped text style annotations. In some cases, the reason for annotating using one type versus another may be difficult for the users to remember when there are different annotation types. In some other cases, a group of users may annotate collaboratively when there are different annotation types. It may be difficult for other users to decipher or understand the reason of using a particular annotation versus another. In some other cases, a single instance of information may be annotated for multiple purposes. Different annotation methodologies may be applied to the same information. For example, if a business consultant is reading a single article related to two different clients, he/she may highlight text relevant to one client in one color while highlighting text relevant to the other client in a different color. In such cases, the user may need a way to recognize and separate the annotations applied for each of the different purposes. It may be noted that information may include one or more documents, one or more files, and the like.

In embodiments, the present invention provides a system which may organize annotation and management tools. The present invention may also assign meaning to and decipher meaning from the employed annotation methodology. It may also be noted that the term ‘document’ may be understood to apply to information in general and not be limited to any particular definition of what constitutes a document.

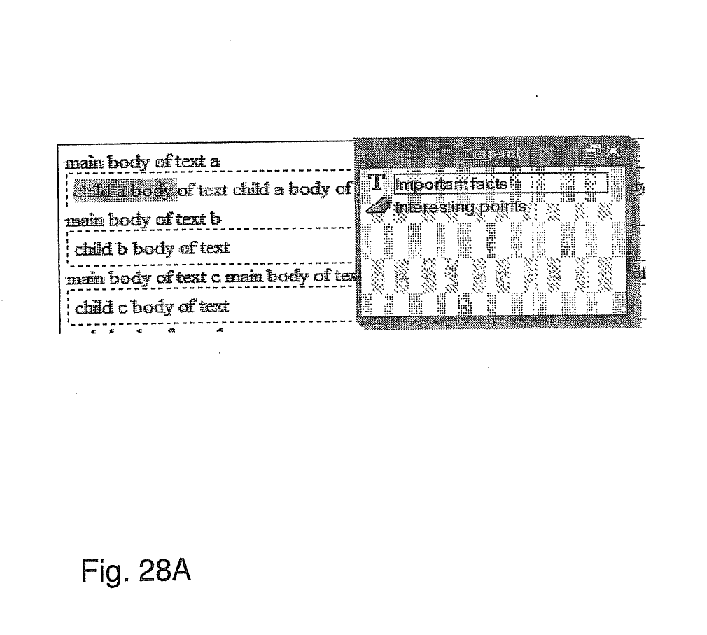

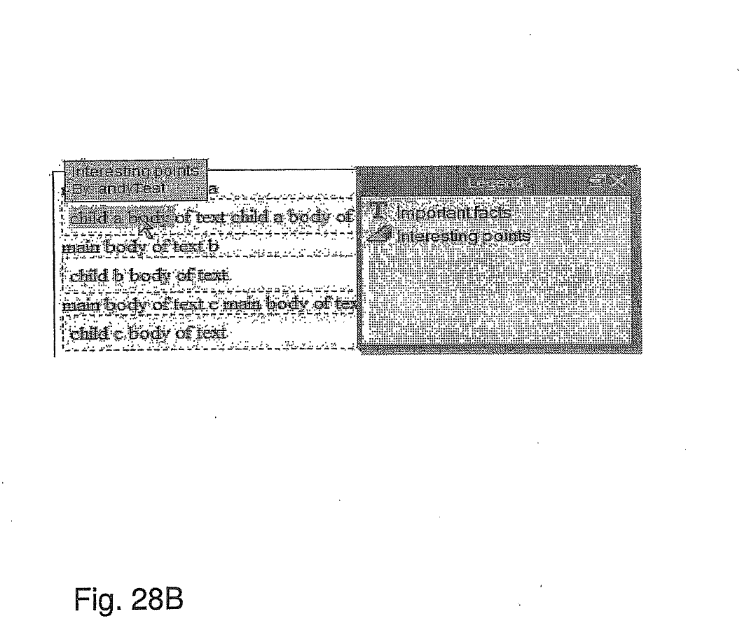

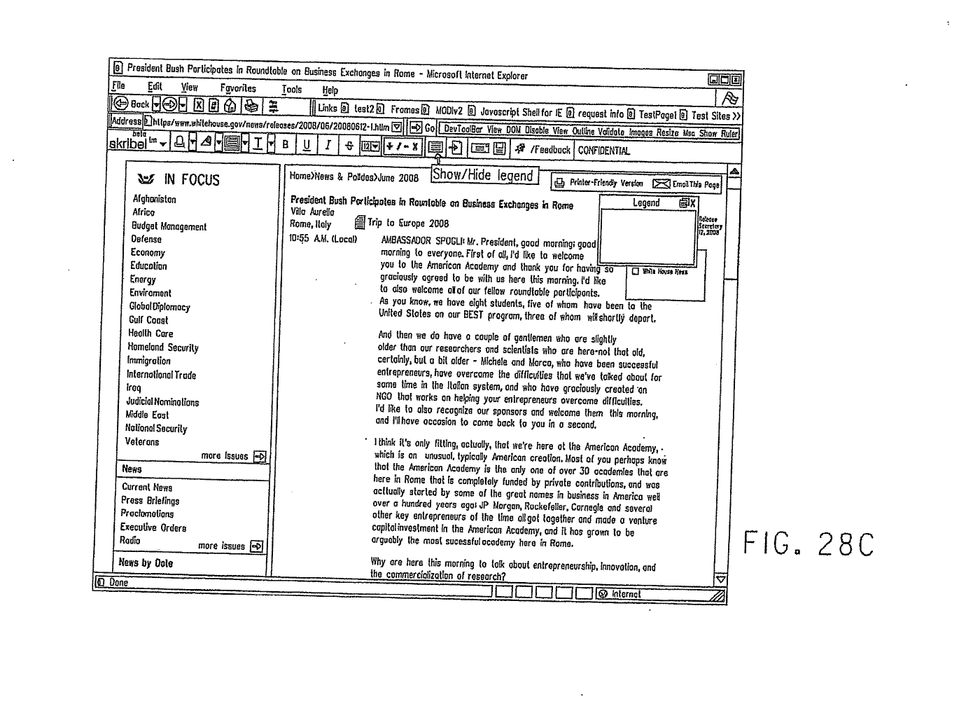

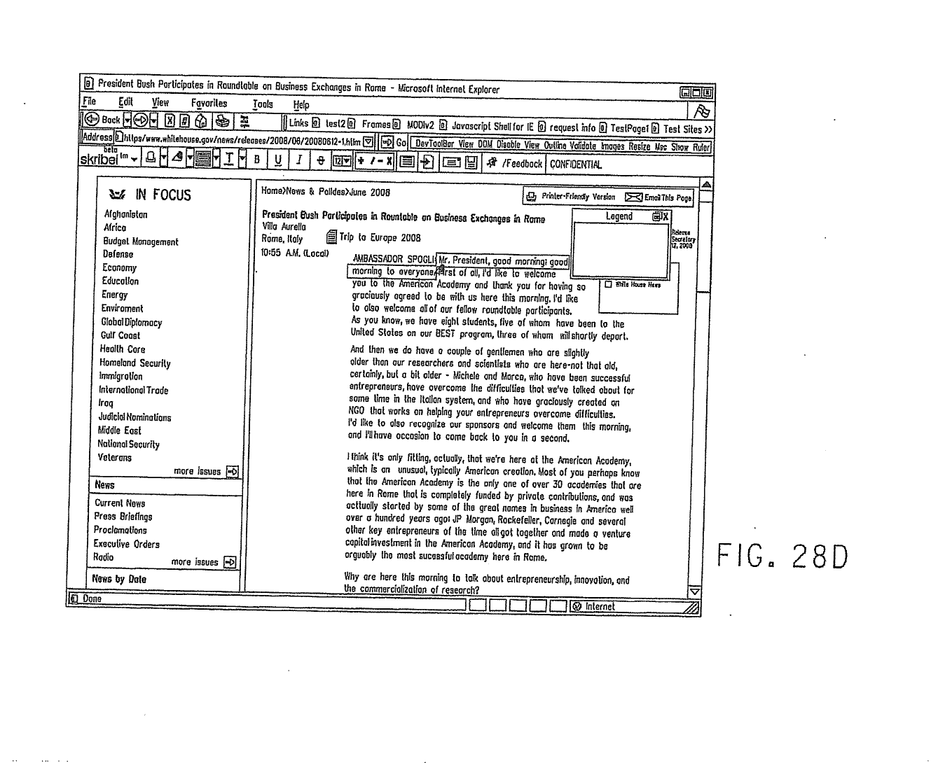

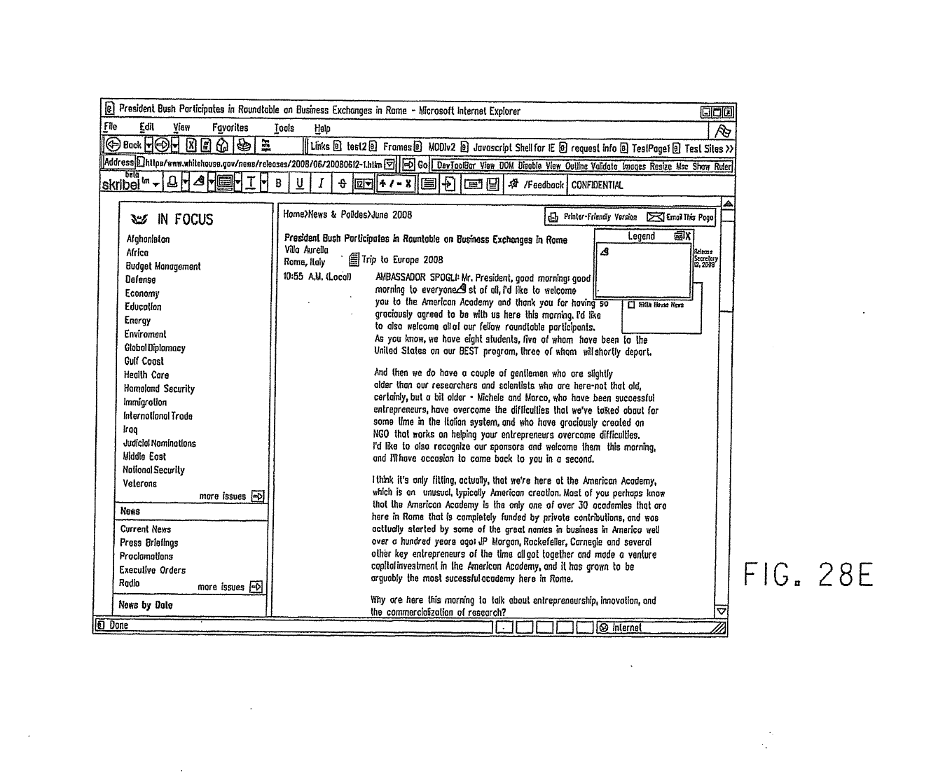

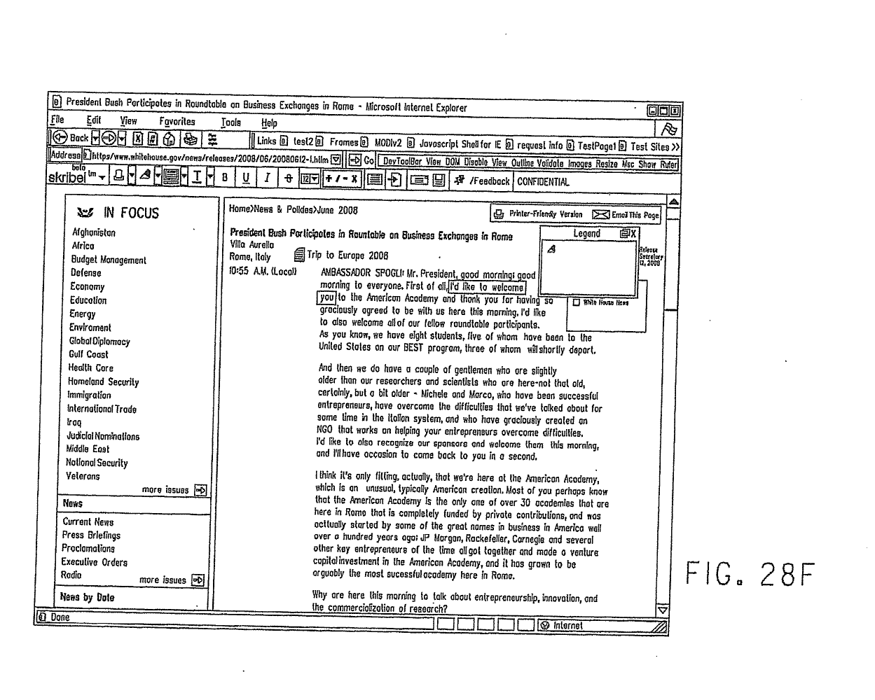

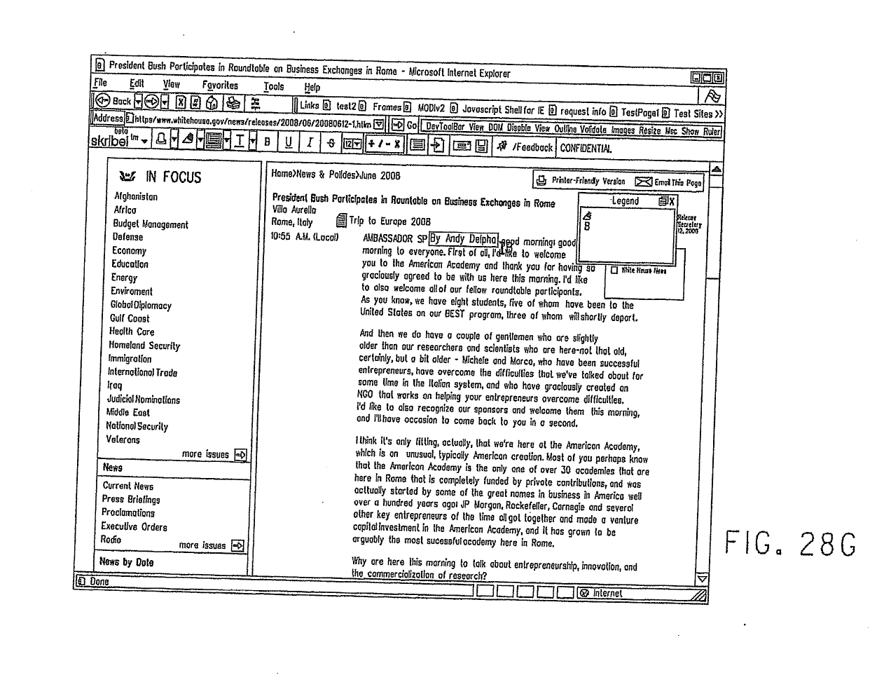

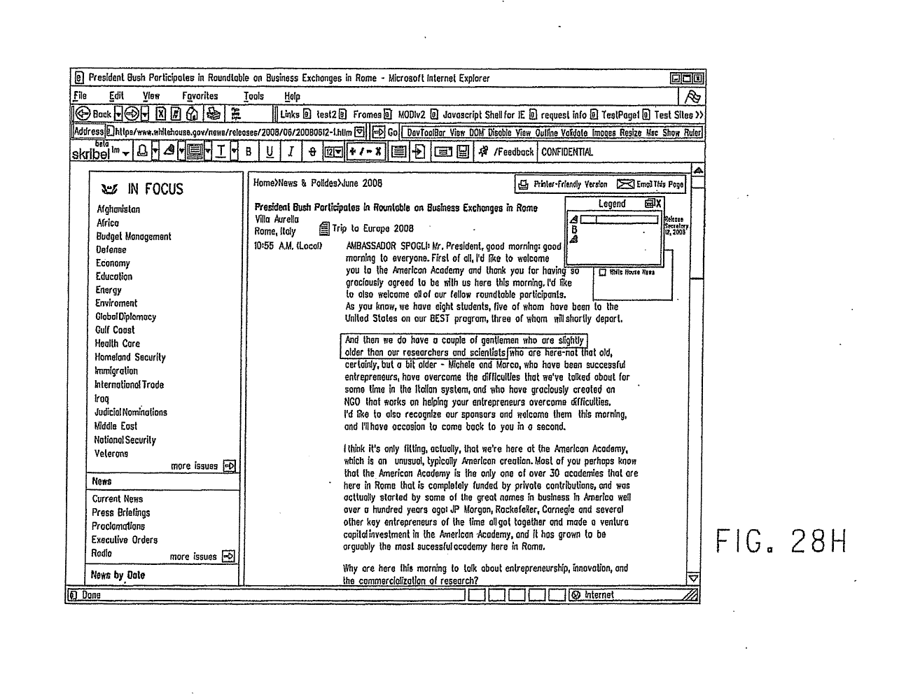

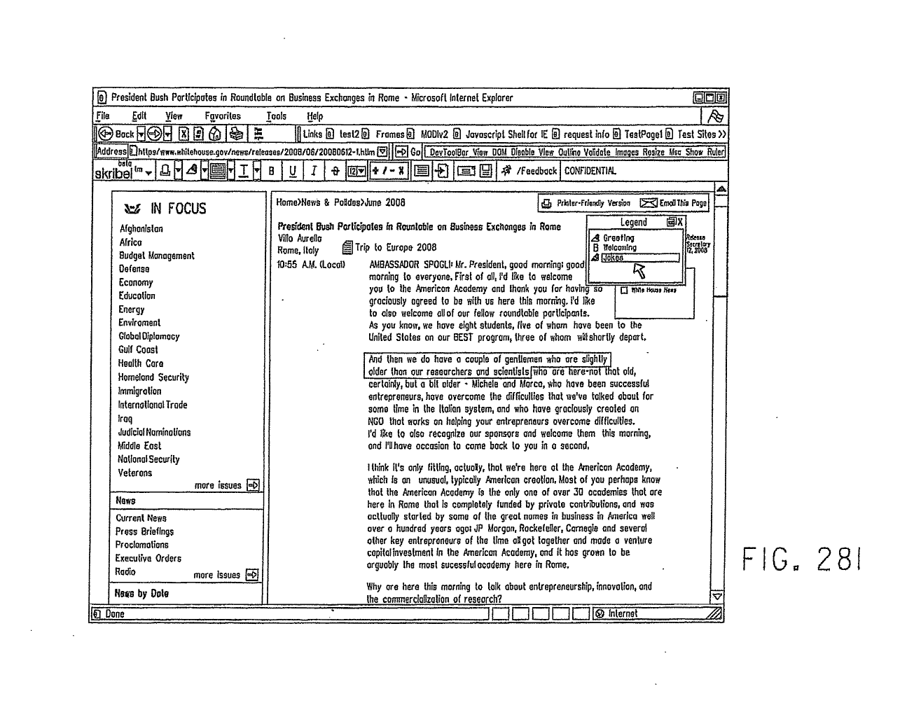

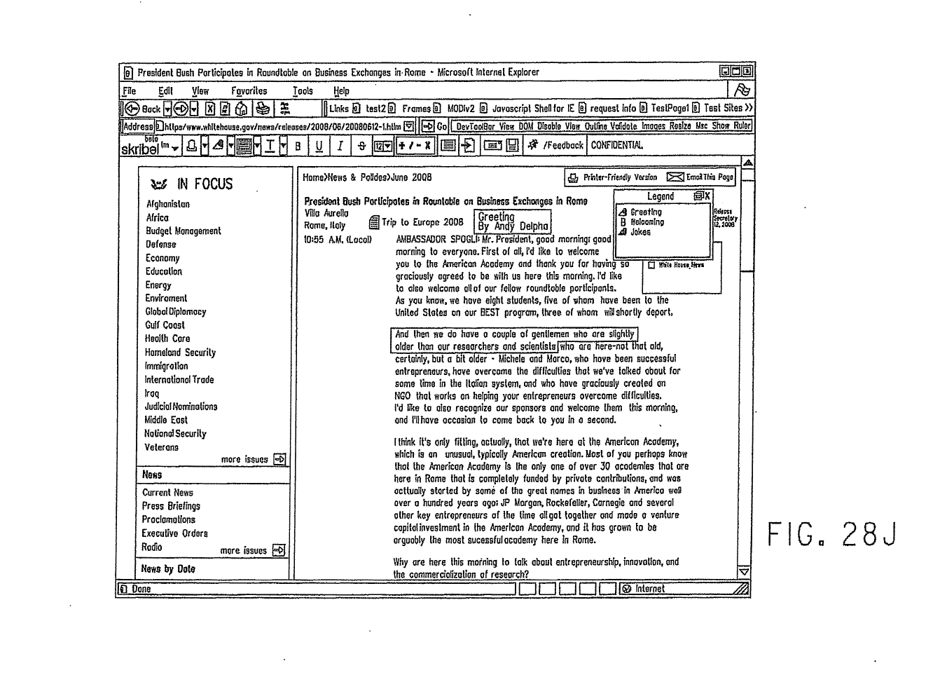

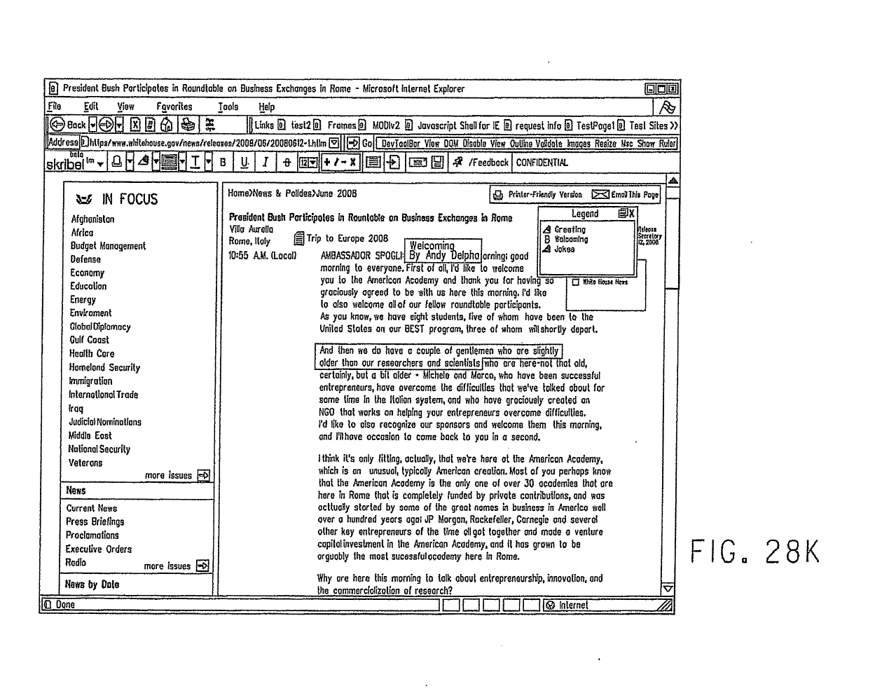

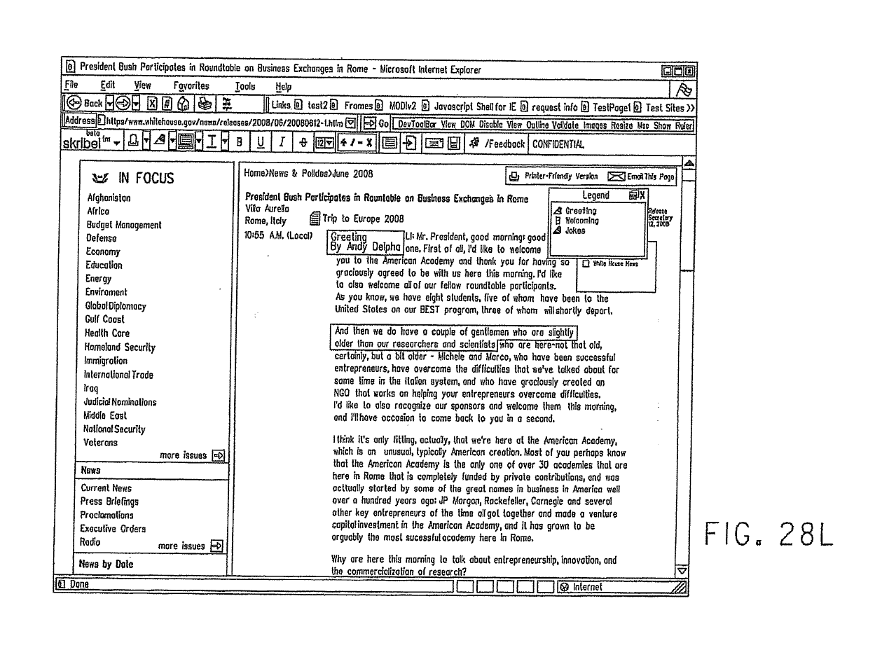

In embodiments, the system may employ a legend or key structure to organize and manage document annotations as shown in FIG. 28A-FIG. 28L. The system may enable the user of a document annotation system to assign a label or tag to a particular annotation type. For example, highlighted text may be deemed high-value information while underlined text may be deemed low-value information. These labels or tags may be referred as legend “entries”. FIG. 28A shows editing a legend entry for the red font color annotation type.

In embodiments, toolbar has a legend feature which may show each type of annotation currently on the page and may allow the user to enter a description as shown in FIG. 28A. The legend may show all the current annotation types in the page along with their current annotation entry. In embodiments, there may be many ways to annotate information. Each such way may be considered a distinct annotation type. Examples to annotate information include applying text style changes such as highlight, bold, italic, underline, strikethrough, font styling, and the like. For instance, highlighting may be done by changing background color or overlaying a semi-transparent colored object. The information may be annotated by adding a note. The note may be a sticky note, a marginalia, and the like.

In embodiments, other items such as a graphical star image, a side-bar or call-out line, and the like may be added. In embodiments, a hyperlink may be added to a location within or outside the same information. In embodiments, each annotation type may have its own unique set of properties, each of which may enable variations within the annotation type. For example, a highlight annotation type may have a color property, enabling color variations within this one annotation type. Similarly, bold text style may have different weights such that bolded text may have various thicknesses. For example, bold text style may be slightly bold, very bold, and the like.

In embodiments, a user may assign such legend entries to a particular variation of an annotation type based on a property of the type. For example, since color is a property of a highlight annotation, yellow highlighted text may be information deemed high-value by Susan while blue highlighted text may be information deemed high-value by John. This may enable color variations of the highlight and note annotations. The text color annotation type may utilize the color property for variations. Referring to FIG. 28I, yellow highlights may have a legend entry of “Greeting”, while red highlights may have a legend entry of “jokes”. In embodiments, the annotation types having a color property presented in the legend are color specific. For example, a green note may have a separate legend entry from a yellow note.

In embodiments, legend entries may be based on color and annotation type. However, in some cases, legend entries may be assigned to combinations of annotation types. For example, instead of only displaying and tracking that highlighted text is high-value information while underlined text is low-value information, a separate legend entry may be created or assigned for a combination of these two annotation types wherein text that is highlighted and underlined may be deemed medium-value information or, possibly, of unknown value. Similarly, legend entries may be assigned to combinations of annotation types and property-based variations of annotation types. For example, for a student reading a life sciences article, text that may be made bold and green may be relevant to a biology project and therefore be assigned a legend entry of “Biology” while text that is bold and blue may be relevant to a chemistry project and may be assigned an entry of “Chemistry”.

In embodiments, more than one legend entry may be assigned to a particular annotation type or property-based variation of an annotation type. In embodiments, the legend may be a floating window which may be moved around in the browser, minimized, hidden, deleted, and the like. It may show all the current annotation types in the page along with their current annotation entry.

In embodiments, the legend may be fixed in position or its position may be changed or set automatically, according to rules or by user input or preferences. The legend may consist of a set of editable text fields—one for each legend entry—with icons to the left of each legend entry field indicating the corresponding annotation type or property-based variation of an annotation type. In some embodiments, the legend may have alternate UI elements enabling entering, editing and removal of legend entries. In embodiments, the corresponding legend entry may be displayed floating above the annotation when the user places his/her mouse over the annotation in the page as shown in FIG. 28B, FIG. 28J, and FIG. 28K.

In embodiments, legend entry text may be displayed in connection with its corresponding annotations via alternate UI techniques or approaches. For example, mousing over an annotation may display the corresponding legend entry in a side panel displaying detailed information about that particular annotation. In embodiments, mousing over an annotation may display more than one legend entry where more than one legend entry may be applied to a particular annotation type or property-based variation of an annotation type.

In embodiments, the legend may be presented when a corresponding legend button is clicked in the Internet browser toolbar as shown in FIG. 28C.

In embodiments, the legend may appear in response to alternate user input or behavior. For example, the legend may appear if a user clicks a button appearing in an alternate toolbar such as a JavaScript toolbar. The toolbar may be loaded as part of a browser bookmark or bookmarklet or may be loaded automatically while visiting an annotated page. Alternatively, the legend may appear automatically when the first annotation is applied to a document.

In embodiments, the legend may be updated immediately to reflect a new annotation type on the page as the user uses a new type of annotation. If all annotations of a certain type are deleted from the page, the corresponding legend entry may automatically be removed from the legend window, although the text of the legend entry may be retained until the user leaves the page being annotated. So, if the user places that type of annotation on the page again, the legend entry may reappear with the text it had when it was deleted.

In embodiments, the legend may not be updated dynamically after each application or removal of an annotation type or property-based variation. In embodiments, the legend entry associated with a particular annotation type or property-based variation of an annotation type may not be retained when all annotations are removed from the page. In embodiments, the legend entries may be saved in the same annotation file, such as an annotation xml file, as the annotations themselves. So, they may be persisted and retrieved with the annotations, and thus are available when users view a saved/shared page.

In embodiments, the legend entries may be saved separately from the annotations or document. This may include saving in an alternate digital, virtual or physical location or data storage structure. In embodiments, the system may allow users to pre-define legend entries such that when they place an annotation, the corresponding legend entry may appear with the user's predefined legend entry text. The user may setup a standard annotating methodology. For example, red text annotations may be facts, yellow highlights may be an interesting point, and the like. These may be stored locally or centralized on the server. The system may allow users to define multiple sets of these default legend entries. The users may then have different defaults that are more appropriate to different projects they are working on. The users may have to choose the default set they want to use for a new page or a set of pages.

These default legend entry sets may be made available to groups of collaborators within the same organization, so that people working on the same project may easily share the same legend entry sets across their research.

In embodiments, the system may allow a user to pre-define legend schemes via a UI in an account settings area separate from any particular instance of a legend. In embodiments, the system may allow a user to save a particular instance of a legend scheme for later use with other pages or projects. In embodiments, the system may allow a user to save a particular instance of a legend scheme as the default legend scheme for later use with the same or other pages or projects. In embodiments, the system may allow a user to define legend schemes for a group of users working individually or collaboratively on the same or disparate pages or projects. In embodiments, the system may allow users to export the text of annotations based on the legend entries, either across a single document, or across multiple documents. These documents may be stored on the server side, local or any other repository. For instance, the user may retrieve all of the annotations with the legend entry “facts” into a word document.”

In embodiments, the documents from which annotations are exported may include, without limitation, a variety of document and data formats, including, but not limited to TXT; RTF; HTML; Portable Document Format (PDF); Open Document (ODF); Microsoft Word, Excel and PowerPoint; Office Open XML (OOXML), XML, and the like.

In embodiments, the system may allow export of annotations via a report generation UI or software module. In embodiments, the system may allow such export of annotations into a variety of document and data formats, including, but not limited to TXT; RTF; HTML; Portable Document Format (PDF); OpenDocument (ODF); Microsoft Word; Excel and PowerPoint; Office Open XML (OOXML), XML, and the like.

In embodiments, the system may allow users, to restrict search results with the requirement that the search must match the context/content of an annotation of a specific annotation type and/or legend entry.

In embodiments, search filtering may be employed while searching across documents, annotations or parts of documents, and the like. The documents or annotations may reside on a server-side, local or any other repository.

Various snapshots may be provided in the FIG. 28A-FIG. 28L that may explain the functionality of system to organize annotation and management tools. For example, FIG. 28A depicts a snapshot showing editing a legend entry for the red font color annotation type. FIG. 28B depicts an example of the legend entry showing when the mouse is placed over the annotation. FIG. 28C depicts a snapshot showing clicking a legend button on a toolbar to display annotation legend with no annotations. FIG. 28D depicts a snapshot showing placing a yellow highlight via modal selection. FIG. 28E depicts a snapshot showing the annotation legend showing an entry for yellow highlights after placing the yellow highlight. FIG. 28F depicts a snapshot showing placing a bold annotation via modal selection. FIG. 28G depicts the annotation legend showing an entry for bold annotations after applying bold annotation. FIG. 28H depicts a snapshot showing entering a legend entry for yellow highlights. FIG. 28I depicts a snapshot showing providing legend entries for the different types of annotations in the page. FIG. 28J depicts a snapshot showing legend entries appearing in mouse over context for each annotation. FIG. 28K depicts another snapshot showing legend entries appearing in mouse over context for each annotation. FIG. 28L depicts a snapshot showing annotations of the same type sharing the same legend entry.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless such arrangement is required to produce the effects intended by this disclosure, or unless explicitly stated or otherwise clear from the context.

Similarly, it will be appreciated that the various steps identified and described above may be varied, and that the order of steps may be adapted to particular applications of the techniques disclosed herein. Unless otherwise clear from the context, any and all of the steps may be skipped, taken out of order, performed in parallel, and so on. All such variations and modifications are intended to fall within the scope of this disclosure. As such, the depiction and/or description of an order for various steps should not be understood to require a particular order of execution for those steps, unless such order is required to produce the effects intended by this disclosure, or unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, an interpreted programming language such as JavaScript, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

The system and each of the methods disclosed herein may be implemented as a part a variety of user interfaces, ranging from hardware interfaces to software applications that include editing functionality; thus, interfaces may include keyboard-based interfaces, touch screens, stylus-based interfaces, wheel-based devices, mouse-based interfaces, cursor-based interfaces, voice-based interfaces, document readers, text-to-voice applications, voice-to-text applications, electronic book readers, scanners, and the like. Interfaces and applications may further include interfaces (such as browsers and application interfaces), programs, and applications on tablet computers, on e-book readers, such as the AMAZON® KINDLE®, on mobile phones and PDAs (e.g., IPHONE®, BLACKBERRY®, OR PALM® devices), and the like. All such interfaces are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

1-94. (canceled)

95. A non-transitory machine readable medium, the machine readable medium having program instructions stored thereon for determining an original address based upon a modified address, an original address being into an unmodified version of a tree-based structure and a modified address being into a modified version of the tree-based structure, when executing on a processor, performs the steps of:
taking an address of an item in a tree-based structure that has been at least once modified;
finding a target node corresponding to the item address in the at least once modified tree-based structure;
finding an ancestor of the target node in the at least once modified tree-based structure, the ancestor being a first ancestor of the target node in the unmodified tree-based structure;
determining in the at least once modified tree-based structure a text offset to the item from the start of the first node in the modified tree-based structure that is a part of the same node as the target node in the unmodified tree-based structure;
finding a first identifiable ancestor of the target node in the at least once modified tree-based structure that also exists in the unmodified tree-based structure and determining a path in the unmodified tree-based structure from it to the target node in the unmodified tree-based structure; and
determining an address of the item in the unmodified tree-based structure.

96. The medium of claim 95, wherein the address of the item is comprised of a node identifier, a path between nodes, and a text offset within a node.

97. The medium of claim 95, wherein the tree-based structure defines a document, modifications to the tree-based structure include application, removal or changing of annotations applied to the document, and the modified version of the tree-based structure is an annotated version of the document.

98. The medium of claim 95, further comprising, using the original address to allow modifications to the tree-based structure without any particular modification disturbing another modification.

99. A non-transitory machine readable medium, the machine readable medium having program instructions stored thereon for determining a modified address based upon an original address, an original address being into an unmodified version of a tree-based structure and a modified address being into a modified version of the tree-based structure, when executing on a processor, performs the steps of:
taking an address of an item in an unmodified tree-based structure;
finding in a modified tree-based structure the start of a first node that is a part of the same node as a target node in the unmodified tree-based structure;
determining a text offset to the item from the start of the target node in the modified tree-based structure;
finding in the modified tree-based structure a first identifiable node that is an ancestor of the target node and determining a path from the ancestor to the target node; and
determining an address of the item in the modified tree-based structure.

100. The medium of claim 99, wherein the address of the item is comprised of a node identifier, a path between nodes, and a text offset within a node.

110. The medium of claim 99, wherein the tree-based structure defines a document, modifications to the tree-based structure include at least one of application, removal and changing of annotations to the document, and the modified version of the tree-based structure is an annotated version of the document.

111. The medium of claim 99, further comprising, using the original address to allow modifications to the tree-based structure without any particular modification disturbing another modification.

112. The medium of claim 111, further comprising, also using the modified address in association with the original address to allow modifications to the tree-based structure without any particular modification disturbing another modification.

113. The medium of claim 112, further comprising, using the association of addresses to support handling of methods that involve modifications to the tree-based structure.

114. A non-transitory machine readable medium, the machine readable medium having program instructions stored thereon for maintaining a tree-based structure, when executing on a processor, performs the steps of:
taking a tree-based structure;
allowing a modification to the tree-based structure;
storing an address of the modification, the address corresponding to a tree-based structure without modifications; and
using the address to maintain a tree-based structure with modifications.

115. The medium of claim 114, wherein the address is used to allow the application, removal or change of the modification to the tree-based structure without disturbing another modification to the tree-based structure.

116. The medium of claim 114, wherein the tree-based structure is capable of defining a document and the modification to the tree-based structure is an annotation to the document.

117. The medium of claim 116, wherein the address is used to allow the application, removal or change of the annotation to the document without disturbing another annotation to the document.

118. The medium of claim 116, wherein the tree-based structure capable of defining a document is the document object model of a web document and the modification to the tree-based structure is an annotation to the web document.

119. The medium of claim 118, wherein the address is used to allow the application, removal or change of the annotation to the web document without disturbing another annotation to the web document.

120. The medium of claim 118, wherein maintaining the tree-based structure consists of maintaining a node in the tree-based structure.

121. The medium of claim 120, wherein maintaining the node includes addressing the modification to the node or connecting the annotation to an HTML or other element of the web document.

122. The medium of claim 95, further comprising, associating addresses of the item in the unmodified tree-based structure and modified tree-based structure, wherein each address comprises at least one of an identifier, a path array and a text offset.

123. The medium of claim 99, further comprising, associating addresses of the item in the unmodified tree-based structure and modified tree-based structure, wherein each address comprises at least one of an identifier, a path array and a text offset.

124. The medium of claim 97, wherein the document is a web document.

125. The medium of claim 110, wherein the document is a web document.

126. The medium of claim 97, wherein the address is used to allow the application, removal or change of the annotation to the document without disturbing another annotation to the document.

127. The medium of claim 110, wherein the address is used to allow the application, removal or change of the annotation to the document without disturbing another annotation to the document.

128. The medium of claim 121, wherein the addressing is to the entire node and the connecting is to an entire HTML or other element of the web document.
